(19) United States
(12) Patent Application Publication
(10) Pub. No.: US 2002/0068245 A1
(43) Pub. Date: Jun. 6, 2002

(54) Photothermographic material and heat development process

(76) Inventors: Yasuhiro Yoshioka, Minami Ashigara-shi (JP); Toyohisa Oya, Minami Ashigara-shi (JP); Sumito Yamada, Minami Ashigara-shi (JP)

Correspondence Address: BIRCH STEWART KOLASCH & BIRCH, PO BOX 747, FALLS CHURCH, VA, 22040-0747, US

(21) Appl. No.: 09/945,624

(22) Filed: Sep. 5, 2001

(30) Foreign Application Priority Data
Sep. 6, 2000 (JP) P.2000-270498
Nov. 17, 2000 (JP) P.2000-351524

(51) Int. Cl. G03C 1/498; G03C 1/34

(52) U.S. Cl. 430/350; 430/620; 430/614

(57) ABSTRACT

For achieving both advantages of high activity in heat development and superior image storability, the present invention provides a photothermographic material comprising a support having provided on one surface side thereof an image-forming layer comprising at least one kind of photosensitive silver halide, a photo-insensitive organic silver salt, a reducing agent for a silver ion and a binder having a glass transition temperature of 20° C. or higher, wherein the image-forming layer comprises a compound represented by Q¹—NHNH—Q², wherein Q¹ represents an aromatic group or a heterocyclic group bonding to—NHNH—Q² with a carbon atom, and Q² represents a carbamoyl group, an acyl group, an alkoxycarbonyl group, an aryloxycarbonyl group, a sulfonyl group or a sulfamoyl group, and a hydrogen bonding type compound, and a heat development process comprising plate heaters and pressing rollers between which the photothermographic material is carried through and developed to form an image superior in image storability without unevenness of photographic density.

### FIELD OF THE INVENTION

The present invention relates to a photothermographic material. Especially the invention relates to a high sensitivity and rapidly developable photothermographic material with both advantages of high activity in heat development and superior image storability.

Further, the invention relates to a heat development process for the photothermographic material. According to the invention, the photothermographic material having high activity in heat development can be heat-developed rapidly and with a high sensitivity, and moreover an image without unevenness of photographic density but with good storability can be obtained.

### BACKGROUND OF THE INVENTION

In recent years, reduction of waste solutions in processing has strongly been desired in the field of photographic films for medical diagnosis and in the field of photographic films for photomechanical process from the viewpoints of environmental protection and space saving. Accordingly, techniques regarding photothermographic materials have been needed for medical diagnosis films and for photomechanical process films which are able to be efficiently exposed with a laser image-setter or a laser imager and to form a clear black image of high resolution and sharpness. These photothermographic materials make it possible to provide customers with a simpler and environmentally benign heat development processing system without using any solution type processing chemicals.

The similar requirements exist in the field of general image-forming materials. However, the image for medical diagnosis use is especially characterized in that a blue black image is preferred from the viewpoint of facilitating medical diagnosis. Besides, a high image quality in sharpness and graininess is necessary, because fine details of the image are required for medical diagnosis. Currently, various hard copy systems utilizing pigments or dyes such as inkjet printers and apparatus for electrophotography are prevailing to be the general image-forming systems. However, there is no system satisfactory as a medical image-output system.

On the other hand, thermal image-forming systems utilizing an organic silver salt are described, for example, in U.S. Pat. Nos. 3,152,904 and 3,457,075, and D. Klosterboer, “Thermally Processed Silver Systems”, Imaging Processes and Materials compiled by J. Sturge, V. Walworth and A. Shepp, 8th edition, Neblette, Chapter 9, page 279 (1989). In particular, a photothermographic material generally has a photosensitive layer (an image forming layer) containing a photocatalyst (e.g., a silver halide) in a catalytically active quantity, a reducing agent, a reducible silver salt (e.g., an organic silver salt) and an agent for controlling the color tone of silver in case of need, having dispersed in a binder matrix. In a photothermographic material, a black silver image is formed by an oxidation-reduction reaction between a reducible silver salt (which functions as an oxidizing agent) and a reducing agent in heating at a high temperature (e.g., 80° C. or more) after image-wise exposure. The oxidation-reduction reaction is accelerated by the catalytic action of a latent image generated in a silver halide by the exposure. Therefore, a black silver image is formed in the exposed area. Disclosures are found in many literatures including U.S. Pat. No. 2,910,377 and JP-B-43-4924 (The term “JP-B” as used herein means an “examined published Japanese patent publication).

A photothermographic material needs no processing chemicals and does not release a much amount of waste materials. As a result, photothermographic materials show their spread in the market as being used in excellent systems of more importance these years because of less loading on the environment. In accordance with the above, the processing volume has so remarkably been increasing that further improvement in the processing volume becomes desired. For the improvement, it is necessary to accelerate the development speed. Therefore, it has been desired that a highly active reducing agent and a development accelerator have to be developed.

In a photothermographic material, however, the image storability turns worse when the activity for development increases, since elements necessary to form an image were left in the photosensitive material even after the heat development. For this reason, the greatest problem is still to manage both of activity in heat development and image storability.

Furthermore, in accordance with the spread of photothermographic materials in the market, the down-sizing of heat development apparatus is eagerly desired. This comes from the fact that space saving of heat development apparatus and installability of heat development apparatus in any place are desired. Also, the processing volume has so remarkably been increasing that further improvement of the processing capacity is desired. For the improvement, it is necessary to promote the down-sizing of heat development apparatus and to accelerate the development rate. Accordingly, product development of a photothermographic material which can respond to such a heat development apparatus has been desired.

In order to accelerate the development rate, it is conceivable that various kinds of development accelerators may be added. When these means are applied, unevenness of development occurs and there is a problem that it becomes difficult to manage both of the sensitivity and the maximum density.

Besides, in case of the photothermographic material, there is another problem that the image storability turns worse when the activity for development increases, since elements necessary to form an image are left in the photosensitive material even after the heat development. For this reason, the greatest problem is still to manage both of the activity in heat development and the image storability.

### SUMMARY OF THE INVENTION

In consideration of these problems in the related art, the invention has set the object to provide a high sensitivity and rapidly developable photothermographic material with both advantages of high activity in heat development and superior image storability.

Further, in consideration of these problems in the related art, another object of the invention is to provide a heat development process in which the photothermographic material having high activity in heat development can be heat-developed rapidly and with a high sensitivity to obtain an image without unevenness of photographic density but with good storability.

In the result of diligent investigations, the inventors have discovered the possibility of providing a photothermographic material exhibiting the objected effects by selecting and combining materials usable for an image-forming layer to achieve the invention.

Further, in the result of diligent investigations, the inventors have discovered that the objects can be accomplished by specifying materials to be used in the photothermographic material and by restricting the structure of heat development part which has the role of heat development, and have achieved the invention described hereinafter.

Namely, the invention provides a photothermographic material comprising a support having provided on one surface side thereof an image-forming layer comprising at least one kind of a photosensitive silver halide, a photo-insensitive organic silver salt, a reducing agent for a silver ion and a binder, wherein the image-forming layer comprises a compound represented by the following formula (D) and a hydrogen bonding type compound, and the glass transition temperature (hereinafter called as “Tg”) of the binder is 20° C. or higher,

Q¹—NHNH—Q² (D)

wherein Q¹ represents an aromatic group or a heterocyclic group bonding to —NHNH—Q² with a carbon atom, and Q² represents a carbamoyl group, an acyl group, an alkoxycarbonyl group, an aryloxycarbonyl group, a sulfonyl group or a sulfamoyl group.

In the photothermographic material of the invention, Q² is preferably a carbamoyl group.

Further, the invention provides a heat development process by means of a heat development apparatus comprising a heat development part for heat-developing a photothermographic material comprising a support having provided on one surface side thereof an image-forming layer comprising at least one kind of photosensitive silver halide, a photo-insensitive organic silver salt, a reducing agent for a silver ion and a binder, wherein the image-forming layer comprises a compound represented by the following formula (D) and a hydrogen bonding type compound, the heat development part comprises a heating means comprising plate heaters arranged in the form with a flat plane surface or a curved plane surface and a carrying means comprising a plurality of pressing rollers positioned in facing to and along the one surface of the plane-like plate heaters, and the photothermographic material is carried through between the pressing rollers and the plane-like plate heaters by means of the carrying means,

Q¹—NHNH—Q² (D)

wherein Q¹ represents an aromatic group or a heterocyclic group bonding to —NHNH—Q² with a carbon atom, and Q² represents a carbamoyl group, an acyl group, an alkoxycarbonyl group, an aryloxycarbonyl group, a sulfonyl group or a sulfamoyl group.

For a reducing agent in the photothermographic material of the invention or in the photothermographic material used in the heat development process of the invention, it is preferable to use a compound represented by the following formula (I):

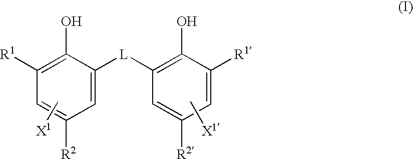

wherein R¹ and R^{1′} each independently represents an alkyl group, R² and R^{2′} each independently represents a hydrogen atom or a substituent replaceable on a benzene ring, X and X′ each independently represents a hydrogen atom or a substituent replaceable on a benzene ring, R¹ and X, R^{1′} and X′, R² and X, and R^{2′} and X′ may form a ring by bonding each other, L represents an —S— group or a —CHR³— group, and R³ represents a hydrogen atom or an alkyl group.

In the photothermographic material of the invention, among compounds represented by the formula (I), a compound in which R¹ and R^{1′} each independently represents a secondary or tertiary alkyl group, R² and R^{2′} each independently represents an alkyl group, R³ represents a hydrogen atom or an alkyl group and X and X′ both represent hydrogen atoms, and a compound in which R¹ and R^{1′} each independently represents a tertiary alkyl group, R² and R^{2′} each independently represents an alkyl group (preferably an alkyl group containing two or more carbon atoms) and R³ is a hydrogen atom or an alkyl group (preferably a hydrogen atom), are preferable.

In the photothermographic material used in the heat development process of the invention, among compounds represented by the formula (D), a compound in which Q² represents a carbamoyl group is preferred. Among compounds represented by the formula (I), a compound in which R¹ and R^{1′} each independently represents a secondary or tertiary alkyl group, R² and R^{2′} each independently represents an alkyl group, R³ represents a hydrogen atom or an alkyl group and X and X′ both represent hydrogen atoms; a compound in which R¹ and R^{1′} each independently represents a tertiary alkyl group, R² and R^{2′} each independently represents an alkyl group and R³ represents a hydrogen atom or an alkyl group; and a compound in which R¹ and R^{1′} each independently represents a tertiary alkyl group, R² and R^{2′} each independently represents an alkyl group containing two or more carbon atoms and R³ represents a hydrogen atom are preferred.

Also, for the photothermographic materials in the invention or the photothermographic material used in the heat development process of the invention, it is preferable to use a compound represented by the following formula (II) as the hydrogen bonding type compound,

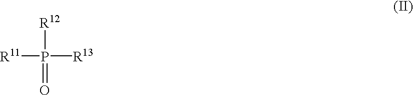

wherein R¹¹, R¹² and R¹³ each independently represents an alkyl group, an aryl group, an alkoxy group, an aryloxy group, an amino group or a heterocyclic group, which groups may be substituted or unsubstituted, and optional two among R¹¹, R¹² and R^{—}may form a ring by bonding each other.

It is preferable that the image-forming layer of the photothermographic materials in the invention is formed by comprising coating the image-forming layer coating solution comprising a binder in the form of an aqueous latex and drying thereof. Also, it is preferable that the average glass transition temperature of the binder in the image-forming layer is from 23° C. to 60° C.

Moreover, the photothermographic materials in the invention are heat-developable in a period in the rage from 5 seconds to 19 seconds.

An average glass transition temperature of the binder in the image-forming layer of the photothermographic material used in the heat development process of the invention is preferably 20° C. or more, and in particular preferably from 23° C. to 60° C. Further, it is preferable that the image-forming layer is formed by comprising coating the image-forming layer coating solution comprising the binder in the form of an aqueous latex and drying thereof.

In the heat development process of the invention, it is preferable that the heat development is performed in a period from 5 seconds to 20 seconds.

Besides, “from x to y” in the invention shows a range including x and y as the minimum and the maximum, respectively.

### BRIEF DESCRIPTION OF THE DRAWINGS

FIG. 1 to 15 will be indicated and explained hereinafter:

FIG. 1 is a schematic constitution view of the heat development part as the first mode;

FIG. 2 is a schematic view showing another mode of sheet-carrying means;

FIG. 3 is a schematic view showing the other mode of sheet-carrying means;

FIG. 4 is a schematic element view showing an arrangement of pressing rollers at the heat development part;

FIG. 5 is a schematic element view showing the other arrangement of pressing rollers at the heat development part;

FIG. 6 is a schematic element view showing the other mode of pressing rollers at the heat development part;

FIG. 7 is a schematic element view showing a mode of the sheet-carrying means;

FIG. 8 is a schematic constitution view of the heat development part as the second mode;

FIG. 9 is a schematic view showing a constitution for improving slipperiness between a plate heater and a sheet at the heat development part;

FIG. 10 is a schematic constitution view of a heat development apparatus;

FIG. 11 is a schematic element view of an exposure unit in the heat development apparatus indicated in FIG. 10;

FIG. 12 is a schematic constitution view of the heat development apparatus P1;

FIG. 13 is a schematic constitution view of the heat development apparatus P2;

FIG. 14 is a schematic constitution view of the heat development apparatus P3; and

FIG. 15 is a schematic constitution view of the heat development apparatus P4.

Codes will be explained hereinafter:

10 indicates a heat development apparatus;

12 indicates a supplying part;

14 indicates a centering part;

16 indicates an image exposure part;

18 indicates a heat development part;

22 indicates a loading part;

24 indicates a loading part;

26 indicates a sucker;

28 indicates a sucker;

30 indicates a charging roller pair;

32 indicates a charging roller pair;

34 indicates a carrying roller pair;

36 indicates a carrying roller pair;

38 indicates a carrying guide;

40 indicates a carrying guide;

42 indicates a carrying guide;

44 indicates a carrying roller pair;

46 indicates an exposure unit;

48 indicates a sub-scanning type carrying means;

50 indicates a light source;

52 indicates a recording and controlling unit;

54 indicates a polygon mirror;

56 indicates an fθ lens;

58 indicates a down-reflection mirror;

60 indicates a carrying roller pair;

62 indicates a carrying roller pair;

64 indicates a carrying roller;

66 indicates a carrying roller;

80 indicates a package;

100 indicates a magazine;

120 indicates a plate heater;

121 indicates a coating;

122 indicates a pressing roller;

122a indicates a pressing roller;

122b indicates a pressing roller;

122n indicates a pressing roller;

124 indicates a carrying path for a recording material;

125 indicates a heat-retaining cover;

126 indicates a charging roller pair;

128 indicates a discharging roller pair (a guiding roller);

132 indicates a dust-removing roller;

140 indicates a carrying roller pair;

142 indicates a guiding plate;

144 indicates a discharging roller pair;

146 indicates a tray;

201 indicates a suction unit;

202 indicates a deposit tray

205 indicates a belt;

206 indicates a drum;

207 indicates a drum type carrying unit;

208 indicates a holding claw type carrying unit;

209 indicates a belt;

209a indicates a holding claw;

218 indicates a carrying unit;

222 indicates a pressing roller;

224 indicates a detaching roller;

226 indicates a carrying belt;

228 indicates a driving roller;

240 indicates a belt-driving unit;

242 indicates a pressing roller;

244 indicates a bearing;

246 indicates a driving belt;

248 indicates a driving roller;

310 indicates a heat development apparatus;

318 indicates a heat development part;

320 indicates a plate heater;

322 indicates a pressing roller;

325 indicates a heat-retaining cover;

326 indicates a charging roller pair;

328 indicates a discharging roller pair (a guiding roller);

L indicates a light beam;

L′ indicates a distance from the edge part of plate heater to each of the pressing roller;

X indicates a recording position;

A indicates a sheet (a photothermographic material) to be heat-processed; and

a indicates an arrow mark showing the sub-scanning direction.

### DETAILED DESCRIPTION OF THE INVENTION

Detailed explanation regarding the photothermographic materials of the invention and the heat development process of the invention will be described hereinafter.

The photothermographic material of the invention comprises a support having provided on one surface side thereof an image-forming layer comprising at least one kind of a photosensitive silver halide, a photo-insensitive organic silver salt, a reducing agent for a silver ion and a binder. The photothermographic material is characterized in that the image-forming layer comprises a compound represented by the formula (D) and a hydrogen bonding type compound, and in that the Tg of the binder is 20° C. or higher. The photothermographic material of the invention to fulfil such conditions has both of high activity in heat development and superior image storability as well as advantages of high sensitivity and rapid developability.

The photothermographic material to be used in the heat development process of the invention comprises a support having provided on one surface side thereof an image-forming layer comprising at least one kind of a photosensitive silver halide, a photo-insensitive organic silver salt, a reducing agent for a silver ion and a binder. The photothermographic material comprises a compound represented by the formula (D) and a hydrogen bonding type compound, and is characterized by high activity in heat development, high sensitivity and rapid developablity. The heat development process of the invention heat-develops such a photothermographic material by means of a heat development apparatus having a specific structure. The heat development apparatus to be used in the invention comprises a heat development part comprising a heating means comprising plate heaters arranged in the form with a flat plane surface or a curved plane surface and a carrying means comprising a plurality of pressing rollers positioned in facing to and along the one surface of the plane-like plate heaters. In the heat development process of the invention, the photothermographic material is heat-developed by being carried through between the pressing rollers and the plane-like plate heaters by means of the carrying means. When heat development is conducted according to such a process, an image without unevenness of photographic density but with good storability can rapidly be formed.

Materials used in the photothermographic materials in the invention are explained in order in the following.

First, the compounds represented by the following formula (D) are explained.

Q¹—NHNH—Q² (D)

In the formula, Q¹ represents an aromatic group or a heterocyclic group bonding to —NHNH—Q² with a carbon atom, and Q² represents a carbamoyl group, an acyl group, an alkoxycarbonyl group, an aryloxycarbonyl group, a sulfonyl group or a sulfamoyl group.

For the aromatic group or the heterocyclic group represented by Q¹, an unsaturated 5- to 7-membered ring is preferable. Preferable examples include a benzene ring, a pyridine ring, a pyrazine ring, a pyrimidine ring, a pyridazine ring, a 1,2,4-triazine ring, a 1,3,5-triazine ring, a pyrrole ring, an imidazole ring, a pyrazole ring, a 1,2,3-triazole ring, a 1,2,4-triazole ring, a tetrazole ring, a 1,3,4-thiadiazole ring, a 1,2,4-thiadiazole ring, a 1,2,5-thiadiazole ring, a 1,3,4-oxadiazole ring, a 1,2,4-oxadiazole ring, a 1,2,5-oxadiazole ring, a thiazole ring, an oxazole ring, an isothiazole ring, an isoxazole ring and a thiophen ring. Furthermore, a condensed ring formed by condensation of these rings one another is also preferable.

These rings may have a substituent. In case of having two or more of substituents, those substituents may be the same or different. Examples of the substituents include, a halogen atom, an alkyl group, an aryl group, a carbonamido group, an alkylsulfonamido group, an arylsulfonamido group, an alkoxy group, an aryloxy group, an alkylthio group, an arylthio group, a carbamoyl group, a sulfamoyl group, a cyano group, an alkylsulfonyl group, an arylsulfonyl group, an alkoxycarbonyl group, an aryloxycarbonyl group and an acyl group. When these substituents are replaceable groups, they may have further substituents. As preferable examples of such substituents, a halogen atom, an alkyl group, an aryl group, a carbonamido group, an alkylsulfonamido group, an arylsulfonamido group, an alkoxy group, an aryloxy group, an alkylthio group, an arylthio group, an acyl group, an alkoxycarbonyl group, an aryloxycarbonyl group, a carbamoyl group, a cyano group, a sulfamoyl group, an alkylsulfonyl group, an arylsulfonyl group and an acyloxy group can be mentioned.

The carbamoyl group represented by Q² contains preferably from 1 to 50 carbon atoms, and more preferably from 6 to 40 carbon atoms. For example, unsubstituted carbamoyl, methylcarbamoyl, N-ethylcarbamoyl, N-propylcarbamoyl, N-sec-butylcarbamoyl, N-octylcarbamoyl, N-cyclohexylcarbamoyl, N-tert-butylcarbamoyl, N-dodecylcarbamoyl, N-(3-dodecyloxypropyl) carbamoyl, N-octadecylcarbamoyl, N-{3-(2,4-tert-pentylphenoxy)propyl}carbamoyl, N-(2-hexyldecyl)carbamoyl, N-phenylcarbamoyl, N-(4-dodecyloxyphenyl)carbamoyl, N-(2-chloro-5-dodecyloxycarbonylphenyl)carbamoyl, N-naphthylcarbamoyle, N-3-pyridylcarbamoyl and N-benzylcarbamoyl are mentioned.

The acyl group represented by Q² contains preferably from 1 to 50 carbon atoms, and more preferably from 6 to 40 carbon atoms. For example, formyl, acetyl, 2-methylpropanoyl, cyclohexylcarbonyl, octanoyl, 2-hexyldecanoyl, dodecanoyl, chloroacetyl, trifluoro-acetyl, benzoyl, 4-dodecyloxybenzoyl and 2-hydroxy methylbenzoyl are mentioned.

An alkoxycarbonyl group represented by Q² contains preferably from 2 to 50 carbon atoms, and more preferably from 6 to 40 carbon atoms. For example, methoxycarbonyl, ethoxycarbonyl, isobutyloxycarbonyl, cyclohexyloxycarbonyl, dodecyloxycarbonyl and benzyloxycarbonyl are mentioned.

The aryloxycarbonyl group represented by Q² contains preferably from 7 to 50 carbon atoms, and more preferably from 7 to 40 carbon atoms. For example, phenoxycarbonyl, 4-octyloxyphenoxycarbonyl, 2-hydroxymethylphenoxycarbonyl and 4-dodecyloxyphenoxycarbonyl are mentioned.

The sulfonyl group represented by Q² contains preferably from 1 to 50 carbon atoms, and more preferably from 6 to 40 carbon atoms. For example, methylsulfonyl, butylsulfonyl, octylsulfonyl, 2-hexadecylsulfonyl, 3-dodecyloxypropylsulfonyl, 2-octyloxy-5-tert-octylphenylsulfonyl and 4-dodecyloxyphenylsulfonyl are mentioned.

The sulfamoyl group represented by Q² contains preferably from 0 to 50 carbon atoms, and more preferably from 6 to 40 carbon atoms. For example, unsubstituted sulfamoyl, N-ethylsulfamoyl, N-(2-ethylhexyl)sulfamoyl, N-decylsulfamoyl, N-hexadecylsulfamoyl, N-{3-(2-ethylhexyloxy)propyl}sulfamoyl, N-(2-chloro-5-dodecyloxycarbonylphenyl)sulfamoyl and N-(2-tetradecyloxyphenyl)sulfamoyl are mentioned.

Furthermore, in a replaceable position, the group represented by Q² may have a group described as an example of a substituent for an unsaturated 5- to 7-membered ring represented by the Q¹. When the group represented by Q² may have two or more substituents, these substituents may be the same or different.

Secondly, the preferable range of compounds represented by the formula (D) is described. Unsaturated 5- to 6-membered rings are preferable as the Q¹. These rings include a benzene ring, a pyrimidine ring, a 1,2,3-triazole ring, a 1,2,4-triazole ring, a tetrazole ring, a 1,3,4-thiadiazole ring, a 1,2,4-thiadiazole ring, a 1,3,4-oxadiazole ring, a 1,2,4-oxadiazole ring, a thiazole ring, an oxazole ring, an isothiazole ring and an isoxazole ring. Furthermore, condensed rings formed by condensation of these rings with a benzene ring or an unsaturated heterocycle are more preferable. A carbamoyl group is preferable for the Q² and especially a carbamoyl group having a hydrogen atom on a nitrogen atom is preferable.

In the following, specific examples of compounds represented by the formula (D) are indicated. However, any compound used in the invention is not construed as being limited by these actual examples. Besides, in the structural formulas in this specification, (t) means an abbreviation of tertiary, (i) means an abbreviation of iso, and an alkyl group without any inscription means a group having a straight (normal) chain.

[chemical structure]

The compounds represented by the formula (D) can be synthesized according to methods described in JP-A-9-152702, JP-A-8-286340, JP-A-9-152700, JP-A-9-152701, JP-A-9-152703 and JP-A-9-152704 (The term “JP-A” as used herein means an “unexamined published Japanese patent application”).

The compounds represented by the formula (D) can be added to materials in any form of solution, powder, solid fine particle dispersion, emulsion or oil-protected dispersion. The dispersing of the solid fine particles is performed by means of a pulverization method known in public (for example, a ball mill, a vibration ball mill, a sand mill, a colloid mill, a jet mill or a roller mill). Dispersion aids may also be used in dispersing solid particles.

The compound represented by the formula (D) can be used in a constitution layer on the support of the photothermographic material, preferably in the image-forming layer or its adjacent layer, and more preferably in the image-forming layer.

The amount of use of a compound represented by the formula (D) is preferably in the range from 0.01 mol % to 100 mol % based on the reducing agent. The more preferable amount of use is in the range from 0.1 mol % to 50 mol %, the furthermore preferable amount of use is in the range from 0.5 mol % to 20 mol % and the most preferable amount of use is in the range from 1 mol % to 10 mol %.

Next, the hydrogen bonding type compounds used for the image-forming layer are explained.

“A hydrogen bonding type compound” in the invention means a non-reducible compound having a group capable to form a hydrogen bond with a compound having an OH group and/or an NH group. The groups capable to form a hydrogen bond with an OH group and/or an NH group include a phosphoryl group, a sulfoxide group, a carbonyl group, an amido group, an ester group, a urethane group, a ureido group, a tertiary amino group and a nitrogen-containing aromatic group. Preferable compounds among them are a compound having a phosphoryl group, a sulfoxide group, an amido group (provided that it has not an >N—H group but is blocked like an >N—R group (R is a substituent except H)), a urethane group (provided that it has not an >N—H group but is blocked like an >N—R group (R is a substituent except H)), and a ureido group (provided that it has not an >N—H group but is blocked like an >N—R group (R is a substituent except H)).

In the invention, the particularly preferable one as the hydrogen bonding type compound is a compound represented by the following formula (II).

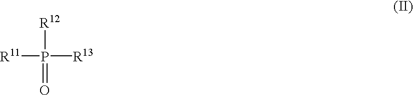

In the formula (II) R¹¹, R¹² and R¹³ each independently represents an alkyl group, an aryl group, an alkoxy group, an aryloxy group, an amino group or a heterocyclic group. These groups may be substituted or unsubstituted. Optional two among R¹¹, R¹² and R¹³ may form a ring by bonding each other.

For the substituent when R¹¹, R¹² and R¹³ have substituents, a halogen atom, an alkyl group, an aryl group, an alkoxy group, an amino group, an acyl group, an acylamino group, an alkylthio group, an arylthio group, a sulfonamido group, an acyloxy group, an oxycarbonyl group, a carbamoyl group, a sulfamoyl group, a sulfonyl group, and a phosphoryl group are mentioned. An alkyl group or an aryl group is preferable. Specific examples include, a methyl group, an ethyl group, an isopropyl group, a tert-butyl group, a tert-octyl group, a phenyl group, a 4-alkoxyphenyl group and a 4-acyloxyphenyl group.

Specific examples of the groups represented by R¹¹, R¹² or R¹³ include substituted or unsubstituted alkyl groups such as a methyl group, an ethyl group, a butyl group, an octyl group, a dodecyl group, an isopropyl group, a tert-butyl group, a tert-amyl group, a tert-octyl group, a cyclohexyl group, a 1-methylcyclohexyl group, a benzyl group, a phenetyl group and 2-phenoxypropyl group; substituted or unsubstituted aryl groups such as a phenyl group, a cresyl group, a xylyl group, a naphthyl group, a 4-tert-butylphenyl group, a 4-tert-octylphenyl group, a 4-anisidyl group and a 3,5-dichlorophenyl group; substituted or unsubstituted alkoxyl groups such as a methoxy group, an ethoxy group, a butoxy group, an octyloxy group, a 2-ethylhexyloxy group, a 3,5,5-trimethylhexyloxy group, a dodecyloxy group, a cyclohexyloxy group, a 4-methylcyclohexyloxy group and a benzyloxy group; substituted or unsubstituted aryloxy groups such as a phenoxy group, a cresyloxy group, an isopropylphenoxy group, a 4-tert-butylphenoxy group, a naphthoxy group and a biphenyloxy group; substituted or unsubstituted amino groups such as an amino group, a dimethylamino group, a diethylamino group, a dibutylamino group, a dioctylamino group, an N-methyl-N-hexylamino group, a dicyclohexylamino group, a diphenylamino group and an N-methyl-N-phenylamino group; and heterocyclic groups such as a 2-pyridyl group, 4-pyridyl group, 2-franyl group, 4-pyperidinyl group, 8-quinolyl group and 5-quinolyl group.

R¹¹, R¹² and R¹³ each is preferably an alkyl group, an aryl group, an alkoxy group or an aryloxy group. In consideration of the effects in the invention, it is preferable that one or more among R¹¹, R¹² and R¹³ are alkyl groups or aryl groups. It is more preferable that two or more among R¹¹, R¹² and R¹³ are alkyl groups or aryl groups. In the viewpoint of an advantage of purchasing at low price, it is preferable that R¹¹, R¹² and R¹³ are the same groups.

In the following, specific examples of the compound represented by the formula (II) are indicated. Any compound possible to be used in the invention is, however, not construed as being limited by these actual examples.

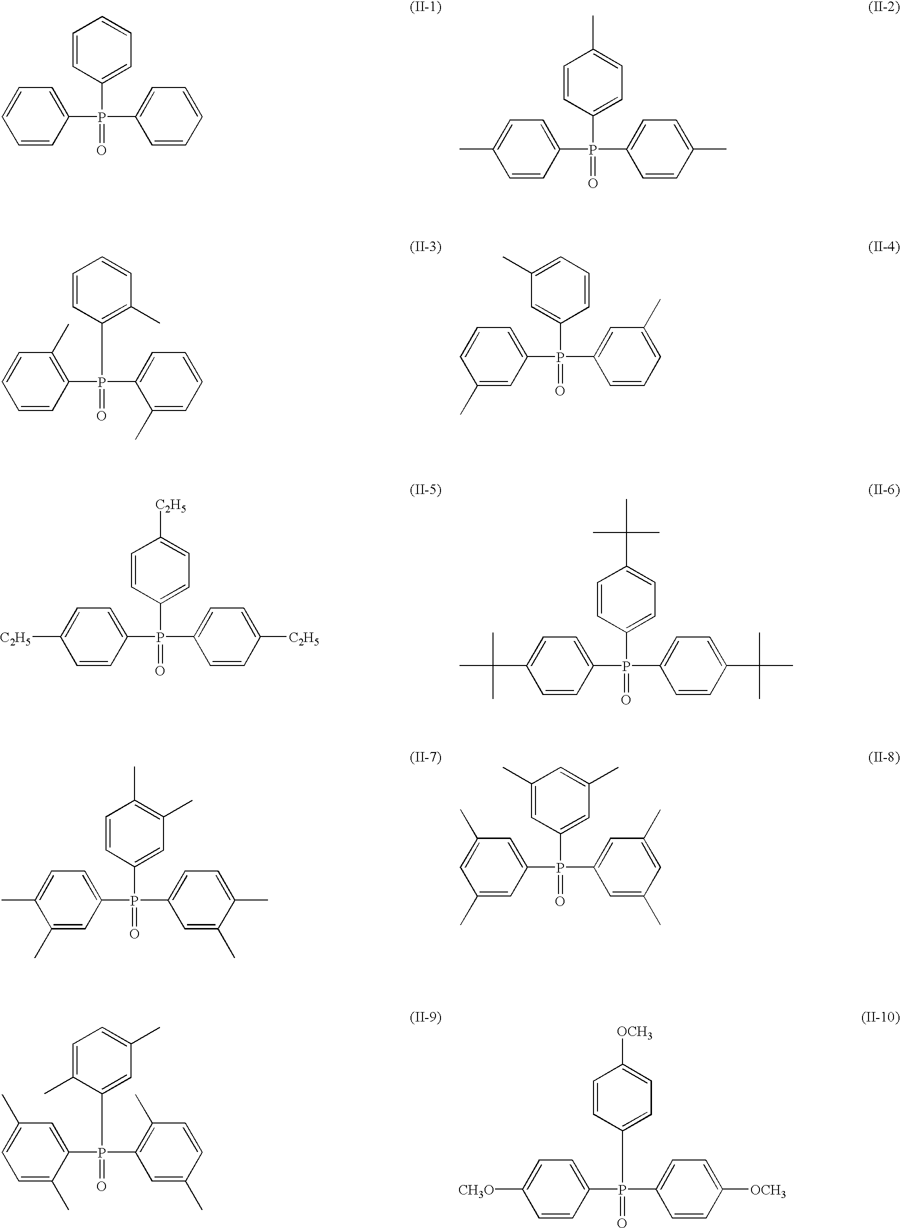

The hydrogen bonding type compound can be used in the photothermographic material by being incorporated in a coating solution in such a form as a solution, an emulsified dispersion or a solid fine particle dispersion. The hydrogen bonding type compound forms a hydrogen bonding type complex with a compound having a phenolic hydroxyl group or an amino group in the state of solution. In a certain combination of the reducing agent and the hydrogen bonding type compound, the complex can be separated in a crystalline state. It is particularly preferable for getting stable functions to use the crystalline powder separated in such a manner as the solid fine particle dispersion. Methods of forming the complex in dispersing a powder mixture of the reducing agent and the hydrogen bonding type compound with a sand grinder mill and the like by using an appropriate dispersing agent can also preferably be used.

The hydrogen bonding type compound can be used in a constitution layer on the support of the photothermographic material, preferably in the image-forming layer or its adjacent layer, and more preferably in the image-forming layer.

It is preferable that the hydrogen bonding type compound is used in the range from 1 mol % to 200 mol % based on the reducing agent. It is more preferable to use the hydrogen bonding type compound in the range from 10 mol % to 150 mol % and furthermore preferable from 30 mol % to 100 mol %.

In the invention, binders with the glass transition temperature (Tg) of 20° C. or more are used as the binder for the image-forming layer. In this specification, binders with the Tg of 20° C. or more are called as “high Tg binders”, and polymers with the Tg of 20° C. or more are called as “high Tg polymers” as the case may be. The Tg of the binders is preferably in the range from 20° C. to 80° C., and more preferably in the range from 23° C. to 60° C. When two or more kinds of polymers with different Tg's are used in blending, it is preferable that their average by weight is kept within the range mentioned in the above.

In the invention, the Tg shows a value calculated with the following equation.

1/Tg=Σ(Xi/Tgi)

In this case, it is assumed that the polymer is formed by copolymerization of n monomer components from i=1 to i=n. Xi is the weight ratio (ΣXi=1) of the i-th monomer. Tgi is the glass transition temperature (at an absolute temperature) of a homopolymer of the i-th monomer. Σ is the sum from i=1 to i=n. For the value (Tgi) of glass transition temperature of a homopolymer made from each monomer, values described in J. Brandrup, E. H. Immergut, Polymer Handbook, 3rd Edition, Willey-interscience, 1989, have been adopted.

For the polymers used in the invention, homopolymers or copolymers are preferably used independently or freely combined with groups of monomers shown below so as to get the Tg of 20° C. or more. There is no special restriction on usable monomer units, however, the monomer units possible to be polymerized by usual radical polymerization or ionic polymerization methods can be used preferably.

### Groups of Monomers

1) Olefin dienes

Ethylene, propylene, vinyl chloride, vinylidene chloride, 6-hydroxy-1-hexene, cyclopentadiene, 4-pentenoic acid, 8-methyl nonenoate, vinylsulfonic acid, trimethylvinyl silane, trimethoxyvinyl silane, 1,3-butadiene, isoprene, 1,3-pentadiene, 2-ethyl-1,3-butadiene, 2-n-propyl-1,3-butadiene, 2,3-dimethyl-1,3-butadiene, 2-methyl-1,3-pentadiene, 1-phenyl-1,3-butadiene, 1-α-naphthyl-1,3-butadiene, 1-β-naphthyl-1,3-butadiene, 2-chloro-1,3-butadiene, 1-bromo-1,3-butadiene, 1-chlorobutadiene, 2-fluoro-1,3-butadiene, 2,3-dichloro-1,3-butadiene, 1,1,2-trichloro-1,3-butadiene, 2-cyano-1,3-butadiene, 1,4-divinylcyclohexane and 1,2,5-trivinylcyclohexane.

2) α,β-unsaturated carbonic acids and their salts

Acrylic acid, methacrylic acid, itaconic acid, maleic acid, sodium acrylate, ammonium methacrylate and potassium itaconate.

3) Derivatives of α,β-unsaturated carboxylic acids

3a) Alkyl acrylates

Methyl acrylate, ethyl acrylate, n-propyl acrylate, isopropyl acrylate, n-butyl acrylate, isobutyl acrylate, sec-butyl acrylate, tert-butyl acrylate, amyl acrylate, n-hexyl acrylate, cyclohexyl acrylate, 2-ethylhexyl acrylate, n-octyl acrylate, tert-octyl acrylate, dodecyl acrylate, phenyl acrylate, benzyl acrylate, 2-chloroethyl acrylate, 2-bromoethyl acrylate, 4-chlorobutyl acrylate, 2-cyanoethyl acrylate, 2-acetoxyethyl acrylate, dimethylaminoethyl acrylate, methoxybenzyl acrylate, 2-chlorocyclohexyl acrylate, furfuryl acrylate, tetrahydrofurfuryl acrylate, 5-hydroxypentyl acrylate, 2,2-dimethyl-3-hydroxypropyl acrylate, 2-methoxyethyl acrylate, ω-methoxypolyethyleneglycol acrylate (the added molar number of polyoxyethylene: n=from 2 to 100), 3-methoxybutyl acrylate, 2-ethoxyethyl acrylate, 2-butoxyethyl acrylate, 2-(2-butoxyethoxy)ethyl acrylate, 1-bromo-2-methoxyethyl acrylate, 1,1-dichloro-2-ethoxyethyl acrylate and glycidyl acrylate.

3b) Alkyl methacrylates

Methyl methacrylate, ethyl methacrylate, n-propyl methacrylate, isopropyl methacrylate, n-butyl methacrylate, isobutyl methacrylate, sec-butyl methacrylate, tert-butyl methacrylate, amyl methacrylate, n-hexyl methacrylate, cyclohexyl methacrylate, 2-ethylhexyl methacrylate, n-octyl methacrylate, stearyl methacrylate, benzyl methacrylate, phenyl methacrylate, allyl methacrylate, furfuryl methacrylate, tetrahydrofurfuryl methacrylate, cresyl methacrylate, naphthyl methacrylate, 2-hydroxyethyl methacrylate, 4-hydroxybutyl methacrylate, triethyleneglycol monomethacrylate, dipropyleneglycol monomethacrylate, 2-methoxyethyl methacrylate, 3-methoxybutyl methacrylate, ω-methoxypolyethyleneglycol methacrylate (the added molar number of polyoxyethylene: n=from 2 to 100), polyethyleneglycol monomethacrylate (the added molar number of polyoxyethylene: n=from 2 to 100), polypropyleneglycol monomethacrylate (the added molar number of polyoxyethylene: n=from 2 to 100), 2-acetoxyethyl methacrylate, 2-ethoxyethyl methacrylate, 2-butoxyethyl methacrylate, 2-(2-butoxyethoxy)ethyl methacrylate, glycerin monomethacrylate, glycidyl methacrylate, 3-N,N-dimethylaminopropyl methacrylate, chloro-3-N,N,N-trimethylammoniopropyl methacrylate, 2-carboxyethyl methacrylate, 3-sulfopropyl methacrylate, 4-oxysulfobutyl methacrylate, 3-trimethoxysilyl propylmethacrylate, allyl methacrylate and 2-isocyanatoethyl methacrylate.

3c) Esters of unsaturated polyvalent carboxylic acids

Monobutyl maleate, dimethyl maleate, dibutyl maleate, monomethyl itaconate, dimethyl itaconate, dibutyl itaconate, butyl crotonate, hexyl crotonate, diethyl fumarate and dimethyl fumarate.

3d) Esters of polyfunctional alcohols

Ethyleneglycol diacrylate, ethyleneglycol dimethacrylate, diethyleneglycol diacrylate, diethyleneglycol dimethacrylate, triethyleneglycol diacrylate, triethyleneglycol dimethacrylate, 1,4-cyclohexane diacrylate, pentaerythritol tetramethacrylate, pentaerythritol triacrylate, trimethylolpropane triacrylate, trimethylolethane triacrylate, dipentaerythritol pentamethacrylate, pentaerythritol hexaacrylate, 1,2,4-cyclohexane tetramethacrylate and polypropyleneglycol dimethacrylate (the added molar number of polyoxypropylene: n=from 2 to 100).

3e) Amides of α,β-unsaturated carboxylic acids

Acrylamide, methacrylamide, N-methyl acrylamide, N-ethyl methacrylamide, N,N-dimethyl acrylamide, N-hydroxyethyl methacrylamide, N-tert-butyl acrylamide, N-tert-octyl methacrylamide, N-cyclohexyl acrylamide, N-hydroxymethyl acrylamide, N-phenyl acrylamide, N-(2-acetoacetoxyethyl) acrylamide, N-benzyl acrylamide, N-acryloyl morpholine, diacetone acrylamide, itacondiamide, N-methyl maleimide, 2-acrylamide-methylpropane sufonic acid, methylene bisacrylamide and dimethacryloyl piperazine.

4) Unsaturated nitriles

Acrylonitrile and methacrylonitrile.

5) Styrene and its derivatives

Styrene, vinyltoluene, ethylstyrene, p-tert-butylstyrene, p-vinylbenzoic acid, methyl p-vinylbenzoate, α-methylstyrene, p-chloromethylstyrene, vinylnaphthalene, p-methoxystyrene, p-hydroxymethylstyrene, p-acetoxystyrene, p-styrene sulfonic acid, sodium p-styrene sulfonate, potassium p-styrene sulfonate, p-aminomethylstyrene, p-divinylbenzene and 4-vinylbenzoic acid-2-acryloylethyl ester.

6) Vinyl ethers

Methylvinyl ether, butylvinyl ether, hexylvinyl ether and methoxyethylvinyl ether.

7) Vinyl esters

Vinyl acetate, vinyl propionate, vinyl lactate, vinyl isolactate, vinyl benzoate, vinyl salicylate, vinyl chloroacetate, vinyl methoxyacetate and vinyl phenylacetate.

8) Other polymerizable monomers

N-vinylimidazole, 4-vinylpyridine, N-vinylpyrrolidone, divinylsulfone, methylvinylketone, phenylvinylketone, methoxyethylvinylketone, 2-vinyloxazoline and 2-isopropenyloxazoline.

In the viewpoint of controlling properties of the polymer synthesized by copolymerization in combination of these monomers, one or more kinds of necessary monomers can optionally be selected for use. From the point of the smooth execution of polymerization, among monomers described in the above, derivatives of α,β-unsaturated carboxylic acids, vinyl esters, conjugate dienes and styrenes are preferably used. As a latex, it is preferable that the main component of the latex comprises a homopolymer or a copolymer such as acryl/methacryl resin, styrene resin, conjugate diene type resin, vinyl chloride resin, vinyl acetate resin, vinylidene chloride resin and polyolefin resin. Among these, a homopolymer or a copolymer having at least a kind of conjugate dienes (e.g. , isoprene and butadiene) as monomer components for the composition is particularly preferable. A SBR latex is the most preferable one among them.

In the invention, it is preferable that the high Tg binder in the image-forming layer is a polymer with an equilibrium moisture content of 2 wt % or less at 25° C. and 60% of relative humidity. The more preferable form is prepared so as to obtain an ionic conductivity of 2.5 mS/cm or less. For such a preparation method, a purification treatment method with a functional membrane for separation after synthesis of the polymer is mentioned.

“The equilibrium water content at 25° C. and 60% of relative humidity” can be expressed by using the weight W¹ of a polymer in an equilibrium of moisture conditioning under the atmosphere of 25° C. and 60% of relative humidity and the weight W⁰ of the polymer in the absolutely dry state, as shown in the following equation.

{(W¹−W⁰)/W⁰}×100(wt %)

Regarding the definition and the measurement method of moisture content, for example, Testing Methods of Polymer Materials, Polymer Engineering Course 14, compiled by the Society of Polymer Science of Japan, Chijin Shokan (Publishing) can be referred.

It is preferable that the equilibrium moisture content of a polymer as the binder at 25° C. and 60% of relative humidity is 2 wt % or less. The range from 0.01 wt % to 1.5 wt % is more preferable and the range from 0.02 wt % to 1 wt % is furthermore preferable.

Specific examples of the high Tg polymers preferably used in the invention are listed in the following Table 1. The invention is, however, not construed as being limited by these examples.

As far as no special notice is given, a numerical value indicating the composition ratio of each monomer means a percentage by weight, and the molecular weight means the number average molecular weight. In case of cross-linked particles using polyfunctional monomers, the description is omitted because the concept of molecular weight can not be applied on them.

TABLE 1

| | | Tg | Molecular |
|---|---|---|---|
| Number | Composition | (° C.) | weight |
| P-1 | Styrene (80)/butadiene (20) | 39 | Cross-linked |
| P-2 | Styrene (85)/butadiene (15) | 52 | Cross-linked |
| P-3 | Styrene (90)/butadiene (7)/- | 76 | Cross-linked |
| | acrylic acid (3) | | |
| P-4 | Styrene (70)/butyl | 63 | 126000 |
| | methacrylate (30) | | |
| P-5 | Styrene (65)/butyl | 63 | 102000 |
| | methacrylate (30)/acrylic | | |
| | acid (5) | | |
| P-6 | Styrene (75)/butadiene (15)/butyl | 37 | Cross-linked |
| | methacrylate (10) | | |
| P-7 | Styrene (80)/2-ethylhexyl | 66 | 98000 |
| | acrylate (15)/acrylic acid (5) | | |
| P-8 | Styrene (92)/butadiene (5)/- | 84 | Cross-linked |
| | acrylic acid (3) | | |
| P-9 | Methyl methacrylate (76)/2- | 55 | Cross-linked |
| | ethylhexyl acrylate (22)/- | | |
| | ethyleneglycol diacrylate (2) | | |
| P-10 | Methyl methacrylate (60)/methyl | 60 | 253000 |
| | acrylate (40) | | |
| P-11 | Styrene (80)/butadiene (12)/acryl- | 80 | Cross-linked |
| | ic acid (3)/divinylbenzene (5) | | |
| P-12 | tert-butyl acrylate (100) | 77 | 169000 |
| P-13 | Styrene (74)/butadiene (20)/- | 31 | Cross-linked |
| | acrylic acid (6) | | |
| P-14 | Styrene (71)/butadiene (26)/- | 24 | Cross-linked |
| | acrylic acid (3) | | |
| P-15 | Styrene (69.5)/butadiene (28.5)/- | 20.5 | Cross-linked |
| | acrylic acid (2) | | |
| P-16 | Styrene (70.5)/butadiene (26.5)/- | 23 | Cross-linked |
| | acrylic acid (3) | | |

These polymers may be used solely or in combination of two or more kinds according to necessity. A combination of a polymer having Tg of 20° C. or more and a polymer having Tg lower than 20° C. may also be used.

As a solvent (here, both of a solvent and a dispersion medium are called as a solvent for the simplicity) of a coating solution for the image-forming layer of the photothermographic material in the invention, aqueous solvents containing 30 wt % or more of water are preferable. As components in addition to water, organic solvents mixable with water such as methyl alcohol, ethyl alcohol, isopropyl alcohol, Methyl Cellosolve, Ethyl Cellosolve, dimethyl formamide and ethyl acetate may optionally be used. The water content of the solvent for the coating solution is preferably 50 wt % or more, and more preferably 70 wt % or more. Examples of preferable solvent compositions are mentioned as follows; in addition to water, water/methyl alcohol=90/10, water/methyl alcohol=70/30, water/methyl alcohol/ dimethyl formamide=80/15/5, water/methyl alcohol/Ethyl Cellosolve=85/10/5 and water/methyl alcohol/isopropyl alcohol=85/10/5 (numerical values show a wt %).

The high Tg polymers used in the invention are preferably used as a latex of the polymer when the image-forming layer is formed by coating the coating solution with such an aqueous solvent, then by drying.

The aqueous solvent mentioned here means water or a mixture of water and a water-mixable organic solvent in an amount of 70 wt % or less. As the organic solvents mixable with water, for example, an alcohol type solvent including methyl alcohol, ethyl alcohol and isopropyl alcohol, a Cellosolve type solvent including Methyl Cellosolve, Ethyl Cellosolve and Butyl Cellosolve, ethyl acetate and dimethyl formamide can be mentioned.

Details of the polymer latex are not specifically limited so far as it is applicable to the manufacture of photographic photosensitive materials. Usually for the polymer latex, “a polymer emulsion” in which a polymer solution with a solvent not mixable with water is emulsified and dispersed in an aqueous medimum in the presence of a surfactant and a protective colloid, and “a polymer latex” which is directly dispersed in an aqueous medium during synthesis of the polymer can be mentioned as examples.

In particular, manufacture methods of the latter latex are preferable for the invention because of the possibility of particle pulverization, the excellent stability of dispersion and the less quantity of a surfactant needed.

The high Tg polymer fine particle dispersion usable in the invention can be obtained by means of a usual polymerization reaction such as emulsion polymerization, dispersion polymerization or suspension polymerization. However, water is used as a medium in many cases of coating photographic photosensitive materials, and a water-insoluble substance such as the copolymer mentioned in the above is handled in a form of water-dispersion. Accordingly, from the viewpoint of preparing the coating solution, emulsion polymerization or dispersion polymerization is preferable, and it is particularly preferable to be synthesized by emulsion polymerization. In case of using the latex described in the above, usually fine particles having a particle diameter of 300 nm or less are used. Among them, fine particles having a particle diameter of 200 nm or less are preferable, and fine particles having a particle diameter of 150 nm or less are particularly preferable.

The emulsion polymerization is, for example, conducted as follows. Water or a mixed solvent of water and a water-mixable organic solvent (e.g., methanol, ethanol and acetone) is used as a dispersion medium. A 5 to 40 wt % monomer mixture based on the dispersion medium, and a 0.05 to 5 wt % polymerization initiator and a 0.1 to 20 wt % emulsifier respectively based on the monomers are mixed and polymerized at a temperature in the range from 30° C. to 100° C., preferably from 60° C. to 90° C., for 3 to 8 hours with stirring. The conditions of the dispersion medium, the monomer concentration, the initiator amount, the emulsifier amount, the reaction temperature and time, and the addition method for monomers are adequately set in consideration of the type of monomer and the objective particle diameter.

The initiators preferably used for the emulsion polymerization include inorganic peroxides such as potassium persulfate and ammonium persulfate, azonitrile compounds such as sodium azobiscyanovalerate, azoamidine compounds such as 2,2′-azobis(2-amidinopropane) dihydrochloride, cyclic azoamidine compounds such as 2,2′-azobis[2-(5-methyl-2-imidazoline-2-yl)propane] hydrochloride, and azoamide compounds such as 2,2′-azobis{2-methyl-N-[1,1′-bis(hydroxymethyl)-2-hydroxyethyl]propionamide}. Among them, potassium persulfate and ammonium persulfate are particularly preferable.

As the dispersing agents, any of anionic surfactants, nonionic surfactants, cationic surfactants or amphoteric surfactants can be used. Nonionic surfactants are preferable.

The high Tg latexes used in the invention can be synthesized without difficulty according to usual emulsion polymerization methods. The general methods of emulsion polymerization are described in detail in Synthetic Resin Emulsion compiled by Taira Okuda and Hiroshi Inagaki, Kobunshi Kankokai (Polymer Publishing), (1978), Application of Synthetic Latex compiled by Takaaki Sugimura, Yasuo Kataoka, Soichi Suzuki and Keiji Kasahara, Kobunshi Kankokai (Polymer Publishing), (1993), and Soichi Muroi, Chemistry of Synthetic Latex, Kobunshi Kankokai (Polymer Publishing), (1970).

To the image-forming layer of the photothermographic material of the invention or for use in the invention, hydrophilic polymers including gelatin, polyvinyl alcohol, methyl cellulose, hydroxypropyl cellulose and carboxymethyl cellulose may be added according to necessity. The addition amount of these hydrophilic polymers is preferably 30 wt % or less of the total binder amount in the image-forming layer, and more preferably 20 wt % or less.

The total binder amount in the image-forming layer is preferably in the range from 0.2 g/m² to 30 g/m², and more preferably from 1 g/m² to 15 g/m². The weight ratio of the total binder/organic silver salt is preferably in the range from 1/10 to 10/1, and more preferably from 1/5 to 4/1. The weight ratio of the total binder/silver halide is preferably in the range from 400 to 5, and more preferably from 200 to 10.

Photo-insensitive organic silver salts usable in the invention are relatively stable against light, but they are such silver salts as to form a silver image when heated at 80° C. or more in the presence of a photocatalyst exposed to light (e.g., a latent image in the photosensitive silver halide and the like) and the reducing agent. The organic silver salt may be an arbitrary organic substance containing a source able to reduce a silver ion. Such photo-insensitive organic silver salts are described in JP-A-10-62899, paragraphs [0048] to [0049], EP-A-0803764, page 18 line 24 to page 19 line 37, and EP-A-0962812. Silver salts of organic acids are preferable, and silver salts of long-chain aliphatic carboxylic acids (containing from 10 to 30 carbon atoms, preferably from 15 to 28 carbon atoms) are particularly preferable. Preferable examples of the organic silver salts include silver behenate, silver arachidate, silver stearate, silver oleate, silver laurate, silver capronate, silver myristate, silver palmitate, and their mixture. In the invention, among these organic silver salts, it is preferable to use the organic silver salts having the silver behenate content ratio of 75 mol % or more.

The shape of the organic silver salts usable in the invention is not particularly restricted, but may be acicular, rod-shaped, tabular or scaly.

In the invention, it is preferable to use scaly organic silver salts. The scaly organic silver salt is defined in this specification as follows. The organic silver salt is observed by means of an electronic microscope, and the shape of the organic silver salt grain is approximated to a rectangular parallelepiped. When the sides of the rectangular parallelepiped are taken as a, b and c in the order from the shortest (c may be equal to b), x is calculated from the shorter numeric values, a and b, as follows.

x=b/a

Thus, x is obtained as to about 200 grains by the above equation, and when the average value is taken as x (average), those satisfying the relationship, x (average)≧1.5, are regarded as scaly grains. The range, 30≧x (average)≧1.5, is preferable and the range, 20≧x (average)≧2.0, is more preferable. In this connection, acicular grains satisfy the relation, 1.5>x (average)≧1.

In a scaly grain, a can be regarded as a thickness of a tabular grain having a plane with the b and c sides as the main plane. The average of a is preferably in the range from 0.01 μm to 0.23 μm, and more preferably from 0.1 μm to 0.20 μm. The average of c/b is preferably in the range from 1 to 6, more preferably from 1.05 to 4, furthermore preferably from 1.1 to 3, and particularly preferably from 1.1 to 2.

It is preferable that the grain size distribution of the organic silver salt is monodispersion. Monodispersion means that the values in terms of percentage obtained by dividing the standard deviations of the respective lengths of short axis and long axis by the respective lengths of short axis and long axis respectively are preferably 100% or less, more preferably 80% or less, and furthermore preferably 50% or less. The shape of the organic silver salt can be obtained from transmission electron microscopic images of the organic silver salt dispersion. Another method of measuring monodispersity is to obtain the standard deviation of the volume weighted average diameter of organic silver salt grains. The value (variation coefficient) in terms of percentage obtained by dividing the standard deviation by the volume weighted average diameter is preferably 100% or less, more preferably 80% or less, and furthermore preferably 50% or less. This can be determined, for example, from the grain size (volume weighted average diameter) obtained by irradiating the organic silver salt grains dispersed in a liquid with laser beams and finding the autocorrelation function to the time variation of fluctuation of scattered light.

For manufacture methods and dispersion methods of the organic silver salts used in the invention, methods known in public can be applied. For example, the above-described JP-A-10-62899, EP-A-0803763 and EP-A-962812 can be referred.

Because of increase of fog and remarkable lowering of sensitivity when a photosensitive silver salt coexists during dispersing the organic silver salt, it is more preferable that any photosensitive silver salt is not included substantially during dispersing. In the invention, the amount of the photosensitive silver salt in an aqueous dispersion to be dispersed is 0.1 mol % or less per 1 mol of the organic silver salt in the dispersion, and addition of the photosensitive silver salt is not positively conducted.

In the invention, it is possible to manufacture the photothermographic material by mixing an aqueous dispersion of the organic silver salt and an aqueous dispersion of the photosensitive silver salt. The mixing ratio of the photosensitive silver salt to the organic silver salt can be selected according to the object. The ratio of the photosensitive silver salt to the organic silver salt is preferably in the range from 1 mol % to 30 mol %, more preferably from 3 mol % to 20 mol %, and particularly preferably from 5 mol % to 15 mol %. In case of mixing, it is a method preferably used for adjusting photographic properties that an aqueous dispersion of two or more kinds of organic silver salts and an aqueous dispersion of two or more kinds of photosensitive silver salts are mixed.

The organic silver salts can be used in any amount desired. The amount of silver as coated is preferably in the range from 0.1 g/m² to 5 g/m², and more preferably from 1 g/m² to 3 g/m²

The halogen composition of photosensitive silver halides used in the invention is not particularly limited. Silver chloride, silver chlorobromide, silver bromide, silver bromoiodide and silver chlorobromoiodide can be used. The distribution of halogen composition in a grain may be uniform, stepwise or continuously changed. Silver halide grains having the core/shell structure can preferably be used. For the structure, a twofold to fivefold structure is preferable. Core/shell grains having a twofold to fourfold structure are more preferable. A technique of localizing silver bromide on the gain surface of silver chloride or silver chlorobromide can also preferably be used.

Formation methods of photosensitive silver halides are well known in this field of art. For example, methods described in Research Disclosure No. 17029, June 1978 and U.S. Pat. No. 3,700,458 can be used. Specifically, it is preferable to use a method in which silver-supplying compounds and halogen-supplying compounds are added into a solution containing gelatin or other polymers to prepare the photosensitive silver halides, and then the photosensitive silver halides obtained are mixed with the organic silver salts. Methods described in JP-A-11-119374, paragraphs [0217] to [0224] and methods disclosed in Japanese Patent Application No. Hei. 11-98708 and Japanese Patent Application No. Hei. 11-84182 are also preferable.

The grain size of the photosensitive silver halide is preferably small for the purpose of suppressing the white turbidity after image formation to a low degree. Specifically, the grain size of 0.20 μm or less is preferable. The grain size in the range from 0.01 μm to 0.15 μm is more preferable, and from 0.02 μm to 0.12 μm is furthermore preferable. The grain size mentioned here means the diameter of a converted circle image having area equivalent to the projection area of a silver halide grain (projection area of the main plane in case of a tabular grain).

The shape of a silver halide grain may be a cube, an octahedron, a tabular grain, a spherical grain, a rod-shaped grain or a pebble-like grain. In the invention, cubic grains are particularly preferable. Silver halide grains with rounded corners can also be used preferably. The face index of an outer surface of a photosensitive silver halide grain (Miller index) is not particularly limited, however, the higher ratio of {100} faces exhibiting a high efficiency of spectral sensitization when spectral sensitizing dyes have adsorbed is preferable. The ratio is preferably 50% or more, more preferably 65% or more, and furthermore preferably 80% or more. The ratio of Miller index {100} faces can be obtained by a method of utilizing adsorption dependency between {111} faces and {100} faces in sensitizing dye adsorption described in T. Tani; J. Imaging Sci., 29, 165 (1985).

In the invention, it is preferable to use silver halide grains in the presence of a hexacyano metal complex on the outermost surface. The hexacyano metal complexes include [Fe(CN)₆]⁴⁻, [Fe(CN)₆]³⁻, [Ru(CN)₆]⁴⁻, [Os(CN)₆]⁴⁻, [Co(CN)₆]³⁻, [Rh(CN)₆]³⁻, [Ir(CN) ₆]³⁻, [Cr(CN)₆]³⁻, and [Re(CN)₆]³⁻. In the invention, hexacyano Fe complexes are preferably used.

A counter cation of the hexacyano metal complex is not important because the hexacyano metal complex exists in an ionic form in an aqueous solution. However, it is preferable to use alkali metal ions such as a sodium ion, a potassium ion, a rubidium ion, a cesium ion and a lithium ion, an ammonium ion, and an alkylammonium ion (e.g., tetramethylammonium ion, tetraethylammonium ion, tetrapropylammonium ion and tetra (n-butyl) ammonium ion), which are easily mixable with water and suitable for precipitation operation of a silver halide emulsion.

The hexacyano metal complex can be added as a mixture with water, a mixed medium of water and an adequate organic solvent mixable with water (e.g., alcohols, ethers, glycols, ketones, esters, and amides) or gelatin.

The addition amount of the hexacyano metal complex is preferably in the range from 1×10⁻⁵ mol to 1×10⁻² mol, and more preferably from 1×10⁻⁴ mol to 1×10⁻³ mol.

In order to make the hexacyano metal complex localized on the outermost surface of a silver halide grain, the hexacyano metal complex is directly added after finishing the addition of an aqueous silver nitrate solution used for the grain formation, before finishing the preparation process prior to the chemical sensitization process in which calcogen sensitization including sulfur sensitization, selenium sensitization and tellurium sensitization, and precious metal sensitization including gold sensitization are performed, during the washing process, during the dispersion process or before the chemical sensitization process. To inhibit the growth of a silver halide fine grain, the hexacyano metal complex is preferably added as soon as possible after grain formation, and preferably before finishing the preparation process.

Further, the addition of the hexacyano metal complex may be started after the addition of 96 wt % of the total amount of silver nitrate being added for grain formation, preferably started after the addition of 98 wt %, and particularly preferably started after the addition of 99 wt %.

When these hexacyano metal complexes are added after the addition of an aqueous solution of silver nitrate immediately before the completion of grain formation, the molecules of the hexacyano metal complexes can adsorb on the outermost surface of a silver halide grain and most of them form a slightly soluble salt with a silver ion on the grain surface. The silver salt of hexacyano Fe (II) is a more slightly soluble salt than AgI, so that it can prevent redissolving caused by fine grains and it becomes possible to manufacture silver halide grains having a small grain size.

The photosensitive silver halide grains may contain a metal or a metal complex belonging to the groups 8 to 10 in the periodic table (showing the groups 1 to 18). As a central metal in the metal complex belonging to the groups 8 to 10 in the periodic table, the preferable one is rhodium, ruthenium or iridium. These metal complexes may be used as one kind, or two or more kinds of complexes having the same metal or different metals simultaneously. The preferable content ratio is in the range from 1×10⁻⁹ mol to 1×10⁻³ mol. These heavy metals and their complexes, and addition methods of them are described in JP-A-7-225449, JP-A-11-65021, paragraphs [0018] to [0024], and JP-A-11-119374, paragraphs [0227] to [0240].

Besides, metal atoms (e.g., [Fe(CN)₆]⁴⁻) possible to be incorporated in the silver halide grains used in the invention, desalting methods of the silver halide emulsion and chemical sensitization methods are described in JP-A-11-84574, paragraphs [0046] to [0050], JP-A-11-65021, paragraphs [0025] to [0031], and JP-A-11-119374, paragraphs [0242] to [0250].

Various kinds of gelatin can be used for the gelatin contained in the photosensitive silver halide emulsion used in the invention. In order to maintain an excellent dispersion state of the photosensitive silver halide emulsion in the coating dispersion containing organic silver salts, it is preferable to use low molecular weight gelatin in the molecular weight range from 500 to 60,000. The low molecular weight gelatin may be used in the grain formation stage or during dispersing after the desalting treatment. It is preferable to use the low molecular weight gelatin during dispersing after the desalting treatment.

Sensitizing dyes can be used in the invention. As the sensitizing dye, it is possible with advantages to select a dye spectrally sensitizing a silver halide grain in the desired wavelength region and having a spectral sensitivity suitable to the spectral characteristics of a light source for exposure when the dye has adsorbed on a silver halide grain. Concerning the sensitizing dyes and their addition methods, the followings can be referred: paragraphs [0103] to [0109] of JP-A-11-65021, compounds represented by the formula (II) of JP-A-10-186572, compounds represented by the formula (I) and paragraph [0106] of JP-A-11-119374, U.S. Pat. No. 5,510,236, dyes described in Example 5 of U.S. Pat. No. 3,871,887, JP-A-2-96131, dyes disclosed in JP-A-59-48753, page 19 line 38 to page 20 line 35 of EP-A-0803764, Japanese Patent Application No. 2000-86865, and Japanese Patent Application No. 2000-102560. Such sensitizing dyes may be used as one kind or in combination of two or more kinds. In the invention, the time of adding the sensitizing dye into the silver halide emulsion is preferably in the period after the desalting process and before coating, and more preferably in the period after the desalting process and before the start of chemical ripening.

The addition amount of the sensitizing dye in the invention can be a desired amount fitted to the levels of fog and sensitivity. The addition amount of the sensitizing dye is preferably in the range from 10⁻⁶ mol to 1 mol per 1 mol of silver halides in the image-forming layer, and more preferably from 10⁻⁴ mol to 10⁻¹ mol.

In the invention, a supersensitizer can be used for improving the spectral sensitization efficiency. For the supersensitizers used in the invention, compounds described in EP-A-587,338, U.S. Pat. No. 3,877,943, U.S. Pat. No. 4,873,184, JP-A-5-341432, JP-A-11-109547, and JP-A-10-111543 are mentioned.

It is preferable that the photosensitive silver halide grains in the invention are chemically sensitized by a sulfur sensitization method, a selenium sensitization method or a tellurium sensitization method. For the compounds preferably used in the sulfur sensitization method, the selenium sensitization method or the tellurium sensitization method, compounds known in public, for example, compounds described in JP-A-7-128768 can be used. Particularly in the invention, the tellurium sensitization is preferable, and compounds described in the references described in paragraph [0030] of JP-A-11-65021, and compounds represented by the formulae (II), (III) and (IV) of JP-A-5-313284 are more preferable.

In the invention, the chemical sensitization is possibly performed in any period after grain formation and before coating. The possible periods are after desalting, (1) before spectral sensitization, (2) simultaneously with spectral sensitization, (3) after spectral sensitization, and (4) immediately before coating. It is particularly preferable that the chemical sensitization is performed after the spectral sensitization.

The use amount of sulfur, selenium or tellurium sensitizers in the invention may vary according to the silver halide grains used and the conditions of chemical ripening. The use amount of the chemical sensitizers is approximately in the range from 10⁻⁸ mol to 10⁻² mol, and preferably from 10⁻⁷ mol to 10⁻³ mol, per Mol of silver halide. The conditions of chemical sensitization in the invention are not particularly restricted. Approximately, pH of from 5 to 8, pAg of from 6 to 11, and temperature of from 40° C. to 95° C. are used.

To the silver halide emulsion used in the invention, thiosulfonic acid compounds may be added according to methods described in EP-A-293917.

The photosensitive silver halide emulsion in the photothermographic material used in the invention may be one kind, or two or more kinds (e.g., of different average grain sizes, different halogen compositions, different crystal habits and different conditions of chemical sensitization) used together. The gradation can be adjusted by using plural kinds of photosensitive silver halide emulsions having different levels of sensitivity. For techniques concerning the above, techniques described in JP-A-57-119341, JP-A-53-106125, JP-A-47-3929, JP-A-48-55730, JP-A-46-5187, JP-A-50-73627, and JP-A-57-150841 are mentioned. It is preferable that the difference of sensitivity of 0.2logE or more is given to each emulsion.

The addition amount of the photosensitive silver halides is preferably in the range from 0.03 g/m² to 0.6 g/m² as indicated in a coated silver amount per 1 m² of the photothermographic material, more preferably in the range from 0.05 g/m² to 0.4 g/m², and the most preferably in the range from 0.1 g/m² to 0.4 g/m². Per 1 mol of the organic silver salt, the amount of the photosensitive silver halides is preferably in the range from 0.01 mol to 0.5 mol, and more preferably from 0.02 mol to 0.3 mol.

Mixing methods and mixing conditions of the photosensitive silver halides and the organic silver salts respectively and separately prepared include a method in which the photosensitive silver halides and the organic silver salts respectively finished in preparation are mixed together by means of a high speed mixer, a ball mill, a sand mill, a colloid mill, a vibration mill, a homogenizer and the like, or a method in which the organic silver salt dispersion is prepared by mixing the photosensitive silver halides finished in preparation at a certain time during preparation of the organic silver salts, but are not particularly restricted so far as the effects of the invention are sufficiently revealed. It is a preferable method for adjusting photographic properties that two or more kinds of organic silver salt aqueous dispersions and two or more kinds of photosensitive silver halide aqueous dispersions are mixed in a mixing process.

The preferable addition time of the silver halide into the image-forming layer coating solution is from 180 minutes before coating to immediately before coating, and preferably from 60 minutes before coating to 10 seconds before coating. The mixing methods and mixing conditions are not particularly restricted so far as the effects of the invention are sufficiently revealed. For specific mixing methods, a method of mixing in a tank which has an average staying time calculated from the addition flow rate and the feeding rate to a coating die adjusted to be the desired time, and a method using a static mixer described in N. Harnby, M. F. Edwards and A. W. Nienow, Liquid Mixing Techniques, translated by Koji Takahashi, Nikkan Kogyo Newspaper, (1989), Chapter 8 are mentioned.

The photothermographic material in the invention comprises a reducing agent for a silver ion. The reducing agent for a silver ion may be an arbitrary substance (preferably an organic substance) which reduces a silver ion to metal silver. Such reducing agents are described in JP-A-11-65021, paragraphs [0043] to [0045], and EP-A-0803764, page 7 line 34 to page 18 line 12.

For the reducing agents in the invention, it is preferable to use reducing agents of bisphenols. Particularly, the use of compounds represented by the following formula (I) is preferable.

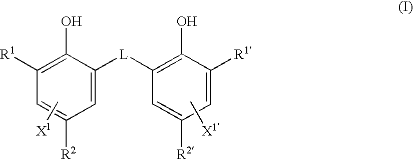

In the formula (I), R¹ and R^{1′} each independently represents an alkyl group. R² and R^{2′} each independently represents a hydrogen atom or a substituent replaceable on a benzene ring. X and X′ each independently represents a hydrogen atom or a substituent replaceable on a benzene ring. R¹ and X, R^{1′} and X′, R² and X, and R^{2′} and X′ may form a ring by bonding each other. L represents an —S— group or a —CHR³— group, and R³ represents a hydrogen atom or an alkyl group.

In the formula (I), R¹ and R^{1′} each independently represents an alkyl group being substituted or unsubstituted and of a straight chain, a branched chain or a ring type. The alkyl group preferably contains from 1 to 20 carbon atoms. The substituents of the alkyl group are not particularly restricted, but preferably an aryl group, a hydroxyl group, an alkoxy group, an aryloxy group, an alkylthio group, an arylthio group, an acylamino group, a sulfonamido group, a sulfonyl group, a phosphoryl group, an acyl group, a carbamoyl group, an ester group, and a halogen atom.

R¹ and R^{1′} each is more preferably a secondary or tertiary alkyl group containing from 3 to 15 carbon atoms, and specifically an isopropyl group, an isobutyl group, a tert-butyl group, a tert-amyl group, a tert-octyl group, a cyclohexyl group, a cyclopentyl group, a 1-methylcyclohexyl group, or a 1-methylcyclopropyl group. The alkyl groups containing from 4 to 12 carbon atoms are further preferable. Among them, a tert-butyl group, a tert-amyl group and a 1-methylcyclohexyl group are particularly preferable, and a tert-butyl group is the most preferable one.

R² and R^{2′} each independently represents a hydrogen atom or a substituent replaceable on a benzene ring. X and X′ each independently represents a hydrogen atom or a substituent replaceable on a benzene ring. As the substituents replaceable on a benzene ring, an alkyl group, an aryl group, a halogen atom, an alkoxy group and an acylamino group are preferable.

R² and R^{2′} each is preferably an alkyl group containing from 1 to 20 carbon atoms, and specifically a methyl group, an ethyl group, a propyl group, a butyl group, an isopropyl group, a tert-butyl group, a tert-amyl group, a cyclohexyl group, a 1-methylcyclohexyl group, a benzyl group, a methoxymethyl group, or an ethoxymethyl group. A methyl group, an ethyl group, a propyl group, an isopropyl group, and a tert-butyl group are more preferable.

X and X′ each is preferably a hydrogen atom, a halogen atom or an alkyl group, and particularly preferably a hydrogen atom.

R¹ and X, R^{1′} and X′, R² and X, and R^{2′} and X′ may form a ring by bonding each other. The ring is preferably a 5- to 7-membered ring, and more preferably a saturated 6-membered ring.

L represents a —S— group or a —CHR³— group. L is preferably a —CHR³— group.

R³ is a hydrogen atom or an alkyl group. The alkyl group represented by R³ may be a straight chain, a branched chain or a ring type, and may be substituted. The alkyl group represented by R³ preferably contains from 1 to 20 carbon atoms, and more preferably from 1 to 15 carbon atoms. Specific examples of unsubstituted alkyl groups include a methyl group, an ethyl group, a propyl group, a butyl group, a heptyl group, an undecyl group, an isopropyl group, a 1-ethylpentyl group and a 2,4,4-trimethylpentyl group. The substituents for the alkyl group include a halogen atom, an alkoxy group, an alkylthio group, an aryloxy group, an arylthio group, an acylamino group, a sulfonamido group, a sulfonyl group, a phosphoryl group, an oxycarbonyl group, a carbamoyl group, and a sulfamoyl group. Preferable ones for R³ are a hydrogen atom, a methyl group, an ethyl group, a propyl group, an isopropyl group, and a 2,4,4-trimethylpentyl group. The particularly preferable ones for R³ are a hydrogen atom, a methyl group, an ethyl group, and a propyl group.

When R³ is a hydrogen atom, R² and R^{2′} each is preferably an alkyl group containing from 2 to 5 carbon atoms, more preferably an ethyl group and a propyl group, and an ethyl group is the most preferable one.

When R³ is a primary or secondary alkyl group containing from 1 to 8 carbon atoms, R² and R^{2′} each is preferably a methyl group. For the primary or secondary alkyl group containing from 1 to 8 carbon atoms obtainable by R³, a methyl group, an ethyl group, a propyl group, and an isopropyl group are more preferable, and a methyl group, an ethyl group, and a propyl group are further preferable.

Particularly preferable compounds among compounds represented by the formula (I) include compounds in which R¹ and R^{1′} each independently is a secondary or tertiary alkyl group, R² and R^{2′} each independently is an alkyl group, R³ is a hydrogen atom or an alkyl group, and X and X′ both are a hydrogen atom; compounds in which R¹ and R^{1′} are a tertiary alkyl group, R² and R^{2′} are an alkyl group, and R³ is a hydrogen atom or an alkyl group; and above all, compounds in which R¹ and R^{1′} are a tertiary alkyl group, R² and R^{2′} are an alkyl group containing two or more carbon atoms, and R³ is a hydrogen atom.

Specific examples of compounds represented by the formula (I) are shown below. However, compounds usable in the invention are not construed as being limited by these examples.

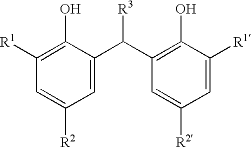

| | R¹ | R^{1′} | R² | R^{2′} | R³ |
|---|---|---|---|---|---|
| I-1 | CH₃ | CH₃ | CH₃ | CH₃ | H |
| I-2 | CH₃ | CH₃ | CH₃ | CH₃ | CH₃ |
| I-3 | CH₃ | CH₃ | CH₃ | CH₃ | C₃H₇ |
| I-4 | CH₃ | CH₃ | CH₃ | CH₃ | i-C₃H₇ |
| I-5 | CH₃ | CH₃ | CH₃ | CH₃ | CH(C₂H₅)C₄H₉ |
| I-6 | CH₃ | CH₃ | CH₃ | CH₃ | CH₂CH(CH₃)CH₂C(CH₃)₃ |
| I-7 | CH₃ | CH₃ | C₂H₅ | C₂H₅ | H |
| I-8 | CH₃ | CH₃ | C₂H₅ | C₂H₅ | i-C₃H₇ |
| I-9 | C₂H₅ | C₂H₅ | CH₃ | CH₃ | H |
| I-10 | C₂H₅ | C₂H₅ | CH₃ | CH₃ | i-C₃H₇ |
| I-11 | t-C₄H₉ | t-C₄H₉ | CH₃ | CH₃ | H |
| I-12 | t-C₄H₉ | t-C₄H₉ | CH₃ | CH₃ | CH₃ |
| I-13 | t-C₄H₉ | t-C₄H₉ | CH₃ | CH₃ | C₂H₅ |
| I-14 | t-C₄H₉ | t-C₄H₉ | CH₃ | CH₃ | n-C₃H₇ |
| I-15 | t-C₄H₉ | t-C₄H₉ | CH₃ | CH₃ | n-C₄H₉ |
| I-16 | t-C₄H₉ | t-C₄H₉ | CH₃ | CH₃ | n-C₇H₁₅ |
| I-17 | t-C₄H₉ | t-C₄H₉ | CH₃ | CH₃ | n-C₁₁H₂₃ |
| I-18 | t-C₄H₉ | t-C₄H₉ | CH₃ | CH₃ | i-C₃H₇ |
| I-19 | t-C₄H₉ | t-C₄H₉ | CH₃ | CH₃ | CH(C₂H₅)C₄H₉ |
| I-20 | t-C₄H₉ | t-C₄H₉ | CH₃ | CH₃ | CH₂CH(CH₃)₂ |
| I-21 | t-C₄H₉ | t-C₄H₉ | CH₃ | CH₃ | CH₂CH(CH₃)CH₂C(CH₃)₃ |
| I-22 | t-C₄H₉ | t-C₄H₉ | CH₃ | CH₃ | CH₂OCH₃ |
| I-23 | t-C₄H₉ | t-C₄H₉ | CH₃ | CH₃ | CH₂CH₂OCH₃ |
| I-24 | t-C₄H₉ | t-C₄H₉ | CH₃ | CH₃ | CH₂CH₂OC₄H₉ |
| I-25 | t-C₄H₉ | t-C₄H₉ | CH₃ | CH₃ | CH₂CH₂SC₁₂H₂₅ |
| I-26 | t-C₄H₉ | t-C₄H₉ | C₂H₅ | C₂H₅ | H |
| I-27 | t-C₄H₉ | t-C₄H₉ | C₂H₅ | C₂H₅ | CH₃ |
| I-28 | t-C₄H₉ | t-C₄H₉ | C₂H₅ | C₂H₅ | n-C₃H₇ |
| I-29 | t-C₄H₉ | t-C₄H₉ | C₂H₅ | C₂H₅ | i-C₃H₇ |
| I-30 | t-C₄H₉ | t-C₄H₉ | C₂H₅ | C₂H₅ | CH₂CH₂OCH₃ |
| I-31 | t-C₄H₉ | t-C₄H₉ | n-C₃H₇ | n-C₃H₇ | H |
| I-32 | t-C₄H₉ | t-C₄H₉ | n-C₃H₇ | n-C₃H₇ | CH₃ |
| I-33 | t-C₄H₉ | t-C₄H₉ | n-C₃H₇ | n-C₃H₇ | n-C₃H₇ |
| I-34 | t-C₄H₉ | t-C₄H₉ | n-C₄H₉ | n-C₄H₉ | H |
| I-35 | t-C₄H₉ | t-C₄H₉ | n-C₄H₉ | n-C₄H₉ | CH₃ |
| I-36 | t-C₅H₁₁ | t-C₅H₁₁ | CH₃ | CH₃ | H |
| I-37 | t-C₅H₁₁ | t-C₅H₁₁ | CH₃ | CH₃ | CH₃ |
| I-38 | t-C₅H₁₁ | t-C₅H₁₁ | C₂H₅ | C₂H₅ | H |
| I-39 | t-C₅H₁₁ | t-C₅H₁₁ | C₂H₅ | C₂H₅ | CH₃ |
| I-40 | i-C₃H₇ | i-C₃H₇ | CH₃ | CH₃ | H |
| I-41 | i-C₃H₇ | i-C₃H₇ | CH₃ | CH₃ | n-C₃H₇ |
| I-42 | i-C₃H₇ | i-C₃H₇ | C₂H₅ | C₂H₅ | H |
| I-43 | i-C₃H₇ | i-C₃H₇ | C₂H₅ | C₂H₅ | n-C₃H₇ |
| I-44 | i-C₃H₇ | i-C₃H₇ | i-C₃H₇ | i-C₃H₇ | H |
| I-45 | i-C₃H₇ | i-C₃H₇ | i-C₃H₇ | i-C₃H₇ | CH₃ |
| I-46 | t-C₄H₉ | CH₃ | CH₃ | CH₃ | H |
| I-47 | t-C₄H₉ | CH₃ | CH₃ | CH₃ | CH₃ |
| I-48 | t-C₄H₉ | CH₃ | CH₃ | CH₃ | n-C₃H₇ |
| I-49 | t-C₄H₉ | CH₃ | t-C₄H₉ | CH₃ | CH₃ |
| I-50 | i-C₃H₇ | CH₃ | CH₃ | CH₃ | CH₃ |

| | | | |
|---|---|---|---|
| I-51 | 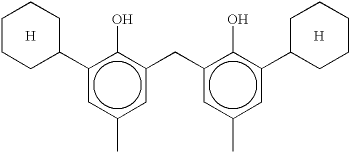 | I-52 | 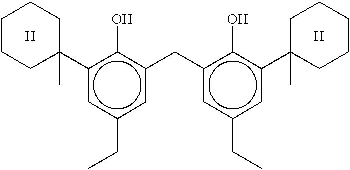 |
| I-53 | 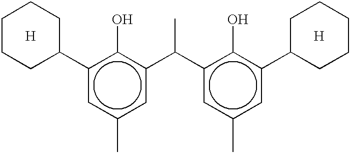 | I-54 | 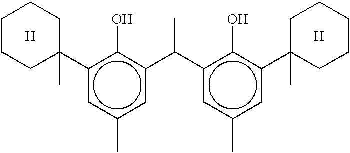 |
| I-55 | 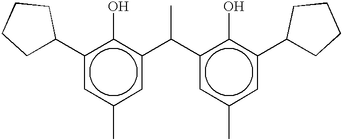 | I-56 | 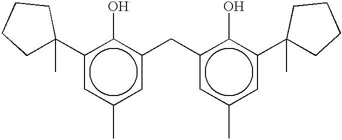 |
| I-57 | 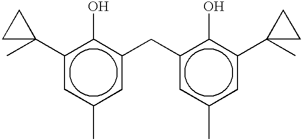 | I-58 | 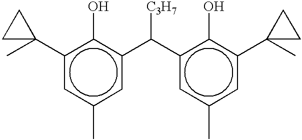 |
| I-59 | 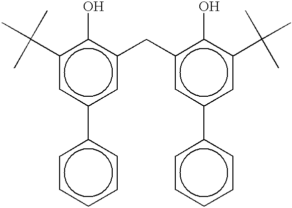 | I-60 | 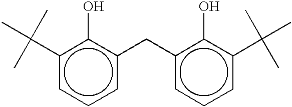 |
| I-61 | 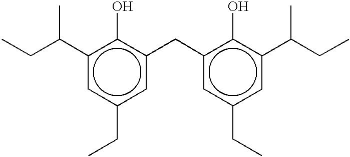 | I-62 | 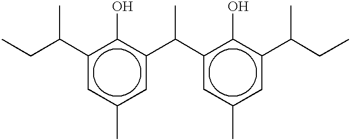 |
| I-63 | 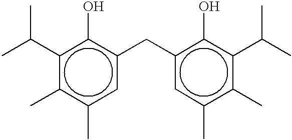 | I-64 | 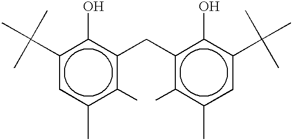 |
| I-65 | 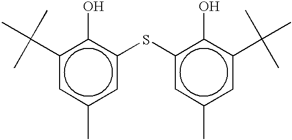 | I-66 | 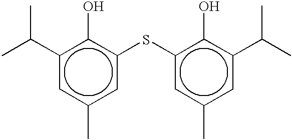 |
| I-67 | 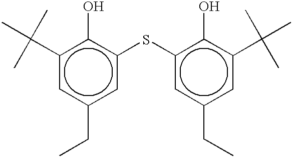 | I-68 | 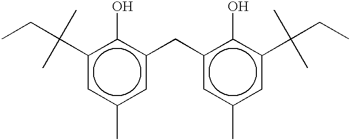 |
| I-69 | 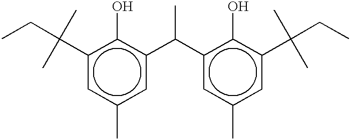 | I-70 | 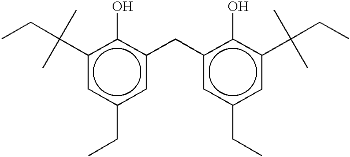 |
| I-71 | 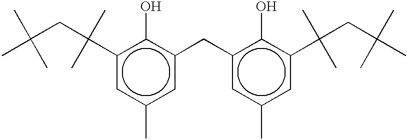 | I-72 | 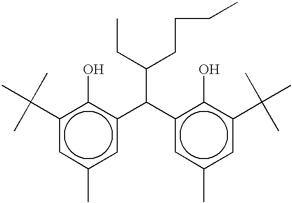 |
| I-73 | 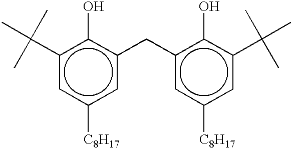 | I-74 | 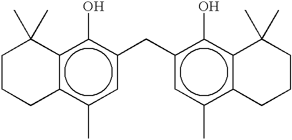 |
| I-75 | 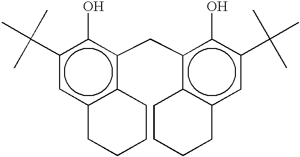 | I-76 | 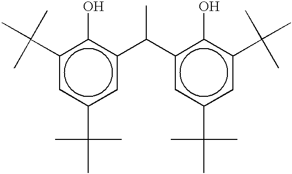 |
| I-77 | 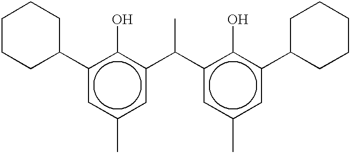 | I-78 | 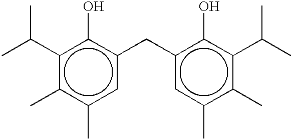 |
| I-79 | 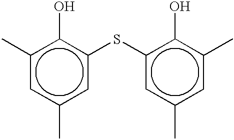 | I-80 | 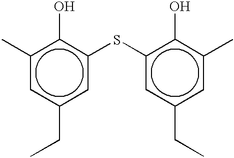 |

In the invention, the addition amount of the reducing agent is preferably in the range from 0.01 g/m² to 5.0 g/m², and more preferably from 0.1 g/m² to 3.0 g/m². It is preferable that the reducing agent is contained in an amount of 5 to 50 mol % per 1 mol of silver on the surface having the image-forming layer, and it is more preferable that the reducing agent is contained in an amount of 10 to 40 mol %. The reducing agent is preferably contained in the image-forming layer.

The reducing agent can be incorporated into the photothermographic material by being contained in the coating solution by any method in a solution form, an emulsified dispersion form, and a solid fine particle dispersion form.

As emulsified dispersion methods well-known, methods in which an emulsified dispersion is mechanically prepared by dissolving the reducing agent with oil such as dibutyl phthalate, tricresyl phosphate, glyceryl triacetate or diethyl phthalate and with an auxiliary solvent such as ethyl acetate or cyclohexanone are mentioned.

For the solid fine particle dispersion method, methods of preparing the solid dispersion by dispersing powder of the reducing agent into an appropriate solvent such as water by means of a ball mill, a colloid mill, a vibration ball mill, a sand mill, a jet mill, a roller mill or an ultrasound wave means are mentioned. In those cases, protective colloids (e.g., polyvinyl alcohol) and surfactants (e.g., anionic surfactants such as sodium triisopropylnaphthalene sulfonate (mixture of those having three different positions substituted by an isopropyl group)) may be used. To an aqueous dispersion, antiseptic agents (e.g., sodium benzoisothiazolinone) can be added.

To the image-forming layer, cross-linking agents for making cross-links and surfactants to improve coating conditions may be added.

For antifoggants, stabilizers and stabilizer precursors usable in the invention, compounds described in JP-A-10-62899, paragraph [0070], and EP-A-0803764, page 20 line 57 to page 21 line 7 are mentioned. The antifoggants preferably used in the invention are organic halides. For these antifoggants, compounds described in JP-A-11-65021, paragraphs [0111] to [0112] are mentioned. Organic halogen compounds represented by the formula (P) in Japanese Patent Application No. Hei. 11-87297, and organic polyhalogen compounds represented by the formula (II) in JP-A-10-339934 are particularly preferred.

The preferable polyhalogen compounds in the invention are concretely explained in the following. The preferable polyhalogen compounds are compounds represented by the following formula (III).

Q—(Y)ₙ—C(Z¹)(Z²)X (III)

In the formula (III), Q is an alkyl group, an aryl group or a heterocyclic group, which may have substituents, Y represents a divalent linking group, n represents 0 or 1, Z¹ and Z² each represents a halogen atom, and X represents a hydrogen atom or an electron-attractive group.

The alkyl groups represented by Q in the formula (III) are straight chain, branched chain or cyclic alkyl groups preferably containing from 1 to 20 carbon atoms, more preferably containing from 1 to 12 carbon atoms, and particularly preferably containing from 1 to 6 carbon atoms. Examples of the alkyl groups include a methyl, ethyl, allyl, n-propyl, iso-propyl, sec-butyl, iso-butyl, tert-butyl, sec-pentyl, iso-pentyl, tert-pentyl, tert-octyl, and 1-methylcyclohexyl group. Tert-alkyl groups are preferable.

The alkyl groups represented by Q may have substituents. Any substituent can be used so far as the substituent gives no harmful influence to photographic properties. Examples of the substituents include a halogen atom (a fluorine atom, a chlorine atom, a bromine atom or an iodine atom), an alkyl group, an alkenyl group, an aryl group, a heterocyclic group (including an N-substituted heterocyclic group having nitrogen, e.g., a morpholino group), an alkoxycarbonyl group, an aryloxycarbonyl group, a carbamoyl group, an imino group, an imino group substituted at the N atom, a thiocarbonyl group, a carbazoyl group, a cyano group, a thiocarbamoyl group, an alkoxy group, an aryloxy group, a heterocyclic oxy group, an acyloxy group, (an alkoxy or aryloxy) carbonyloxy group, a sulfonyloxy group, an acylamido group, a sulfonamido group, a ureido group, a thioureido group, an imido group, (an alkoxy or aryloxy) carbonylamino group, a sulfamoylamino group, a semicarbazide group, a thiosemicarbazide group, (an alkyl or an aryl) sulfonylureido group, a nitro group, (an alkyl or an aryl) sulfonyl group, a sulfamoyl group, a group having phosphoneamide or phosphoric acid ester, a silyl group, a carboxyl group or its salt, a sulfo group or its salt, a phosphoric acid group, a hydroxy group, and quaternary ammonium group. These substituents may further be sustituted by these substituents.

The aryl groups represented by Q in the formula (III) are aryl groups of a single ring or a condensed ring preferably containing from 6 to 20 carbon atoms, more preferably containing from 6 to 16 carbon atoms, and particularly preferably containing from 6 to 10 carbon atoms. A phenyl group and a naphthyl group are preferred.

The aryl groups represented by Q may have substituents. Any substituent can be used so far as the substituent gives no harmful influence to photographic properties. For example, the similar substituents to the above-mentioned substituents for the alkyl groups can be indicated. Particularly preferable one is the case that Q is a phenyl group substituted by an electron-attractive group in which Hammett's σₚ has a positive value. The electron-attractive group σp value is preferably in the range from 0.2 to 2.0, and more preferably from 0.4 to 1.0. Specific examples of these substituents include a cyano group, an alkoxycarbonyl group, an aryloxycarbonyl group, a carbamoyl group, a sulfamoyl group, an alkylsulfonyl group, an arylsulfonyl group, an alkylphosphoryl group, a sulfoxido group, an acyl group, a heterocyclic group, a halogen atom, a halogenated alkyl group, and a phosphoryl group. More preferable electron-attractive groups are a carbamoyl group, an alkoxycarbonyl group, an alkylsulfonyl group, and an alkylphosphoryl group. The most preferable one is a carbamoyl group above all.

For heterocyclic groups represented by Q in the formula (III), it is preferable that the heterocyclic group is a saturated or unsaturated single ring or a condensed ring of from 5 to 7 members which include one or more hetero atoms selected from the group comprising a nitrogen atom, an oxygen atom and a sulfur atom. Examples of heyerocyclic rings include preferably, pyridine, quinoline, isoquinoline, pyrimidine, pyrazine, pyridazine, phthalazine, triazine, furan, thiophene, pyrrol, oxazole, benzoxazole, thiazole, benzothiazole, imidazole, benzoimidazole, thiadiazole, and triazole. More preferably, pyridine, quinoline, pyrimidine, thiadiazole, and benzothiazole are mentioned. Particulary preferable ones are pyridine, quinoline and pyrimidine.

A heterocyclic group represented by Q may have a substituent. For example, the similar substituents to the substituents of an alkyl group represented by Q can be indicated.

Particularly preferable groups for Q are phenyl groups substituted by the above-mentioned electron-attractive group in which Hammett's σₚ has a positive value.

As substituents of Q, Q may have a ballast group usable in a photographic material to reduce diffusion, a group to be adsorbed by a silver salt, or a group to be water-soluble. Q may polymerize one another to form a polymer. The substituents may bond one another to form a bis type, a tris type or a tetrakis type.

In the formula (III), Y represents a divalent linking group. Preferable ones are —SO₂—, —SO— and —CO—, and particularly preferable one is —SO₂—.

In the formula (III) , n represents 0 or 1, and preferably 1.

Z¹ and Z² each independently represents a halogen atom (e.g., fluorine, chlorine, bromine and iodine). The most preferable case is that Z¹ and Z² both are bromine atoms.

X represents a hydrogen atom or an electron-attractive group. The electron-attractive group represented by X is a substituent in which Hammett's substituent constant σₚ can take a positive value. Specifically, a cyano group, an alkoxycarbonyl group, an aryloxycarbonyl group, a carbamoyl group, a sulfamoyl group, an alkylsulfonyl group, an arylsulfonyl group, a halogen atom, an acyl group, and a heterocyclic group are mentioned. Preferable one is a hydrogen atom and a halogen atom. The most preferable one is a bromine atom.

For the polyhalogen compounds in the formula (III), compounds described in U.S. Pat. No. 3,874,946, U.S. Pat. No. 4,756,999, U.S. Pat. No. 5,340,712, U.S. Pat. No. 5,369,000, U.S. Pat. No. 5,464,737, JP-A-50-137126, JP-A-50-89020, JP-A-50-119624, JP-A-59-57234, JP-A-7-2781, JP-A-7-5621, JP-A-9-160164, JP-A-10-197988, JP-A-9-244177, JP-A-9-244178, JP-A-9-160167, JP-A-9-319022, JP-A-9-258367, JP-A-9-265150, JP-A-9-319022, JP-A-10-197989, JP-A-11-242304, Japanese Patent Application No. Hei. 10-181459, Japanese Patent Application No. Hei. 10-292864, Japanese Patent Application No. Hei. 11-90095, Japanese Patent Application No. Hei. 11-89773, and Japanese Patent Application No. Hei. 11-205330 are mentioned.

Specific examples of the polyhalogen compounds represented by the formula (III) are shown in the following. Compounds usable in the invention is, however, not construed as being limited by the examples.

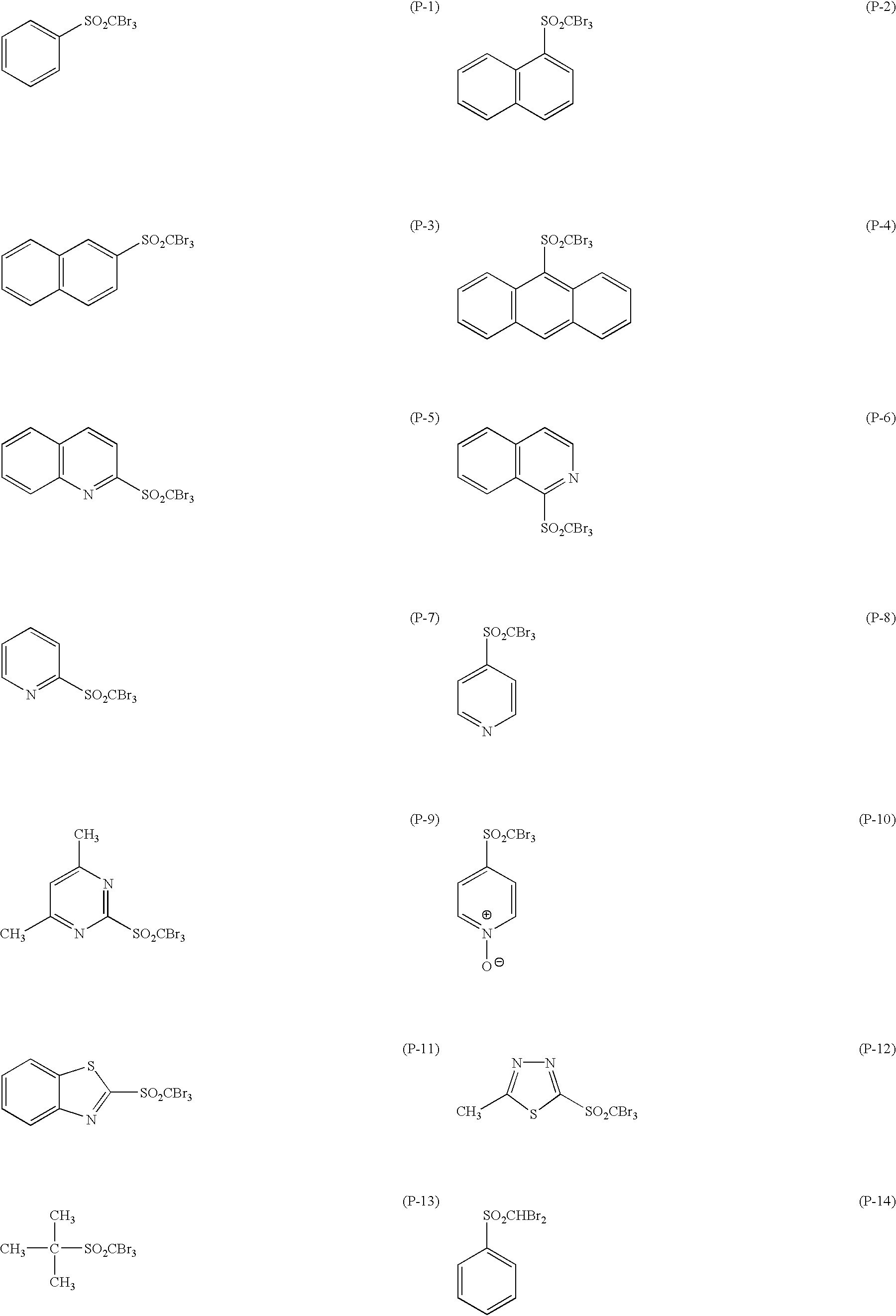

The polyhalogen compounds represented by the formula (III) can be used as one kind solely or two or more kinds simultaneously.

The compounds represented by the formula (III) are preferably used in the range from 10⁻⁴ Mol to 1 mol per 1 mol of the photo-insensitive silver salt in the image-forming layer, more preferably from 10⁻³ mol to 0.8 mol, and further preferably from 5×10⁻³ mol to 0.5 mol.

In the invention, for the method of incorporating the antifoggants into the photothermographic material, methods described in the incorporation method of the above-described reducing agents can be referred. Also, the organic polyhalogen compounds are preferably added as a solid fine particle dispersion.

As other antifoggants, mercury (II) salts described in JP-A-11-65021, paragraph [0113]; benzoic acids described in JP-A-11-65021, paragraph [0114]; salicylic acid derivatives represented by the formula (Z) in Japanese Patent Application No. Hei. 11-87297; formalin scavenger compounds represented by the formula (S) in Japanese Patent Application No. Hei. 11-23995; triazine compounds related to claim 9 in JP-A-11-352624; compounds represented by the formula (III) in JP-A-6-11791; and 4-hydoxy-6-methyl-1,3,3a,7-tetrazaindene are mentioned.

The photothermographic material in the invention may contain an azolium salt for the purpose of inhibiting fog. For azolium salts, compounds represented by the formula (XI) in JP-A-59-193447, compounds described in JP-B-55-12581, and compounds represented by the formula (II) in JP-A-60-153039 are mentioned. The azolium salts may be added in any part of the photothermographic material. Regarding the layers to be added, layers on the surface having the image-forming layer are preferable, and layers containing the organic silver salt is more preferable to be added with the azolium salts. The time to add the azolium salts may be in any process for preparing a coating solution. In case of adding the azolium salts to the layer containing the organic silver salt, the azolium salts may be added in any process from preparation of the organic silver salt to preparation of a coating solution. The azolium salts are preferably added at a time after preparation of the organic silver salt and immediately before coating. The addition of the azolium salts may be performed in any method using powder, a solution or a fine particle dispersion. The azolium salts may also be added as a solution mixed with other additives such as sensitizing dyes, reducing agents and agents for controlling the tone. In the invention, the addition amount of the azolium salts may be optional, preferably in the range from 1×10⁻⁶ mol to 2 mol per 1 mol of silver, and more preferably in the range from 1×10⁻³ mol to 0.5 mol.

In the invention, for the purposes of controlling development by inhibiting or accelerating development, of improving spectral sensitization efficiency and of improving storability after and before development, mercapto compounds, disulfide compounds and thione compounds can be incorporated. Compounds described in JP-A-10-62899, paragraphs [0067] to [0069], compounds represented by the formula (I) and specific examples in paragraphs [0033] to [0052] in JP-A-10-186572, compounds described in EP-A-0803764, page 20 line 35 to 56, and compounds described in Japanese Patent Application No. Hei. 11-273670, can be used. Among them, mrecapto-substituted heteroaromatic compounds are preferable.

In the photothermographic material in the invention, agents for controlling the tone are preferably added. The agents for controlling the tone are described in JP-A-10-62899, paragraphs [0054] to [0055], EP-A-0803764, page 21 line 23 to 48, and JP-A-2000-35631. Preferable compounds are phthalazinones (phthalazinone, phthalazinone derivatives or metal salts; e.g., 4-(1-naphthyl)phthalazinone, 6-chlorophthalazinone, 5,7-dimethoxyphthalazinone and 2,3-dihydro-1,4-phthalazinedione); combinations of phthalazinones and phthalic acids (e.g., phthalic acid, 4-methylphthalic acid, 4-nitrophthalic acid and tetrachlorophthalic anhydride); phthalazines (phthalazine, phthalazine derivatives or metal salts; e.g., 4-(1-naphthyl)phthalazine, 6-isopropylphthalazine, 6-tert-butylphthalazine, 6-chlorophthalazine, 5,7-dimethoxyphthalazine and 2,3-dihydrophthalazine); and combinations of phthalazines and phthalic acids. Combinations of phthalazines and phthalic acids are particularly preferred.

Plasticizers and lubricants usable in the image-forming layer are described in JP-A-11-65021, paragraph [0117]. Regarding ultra-high contrast enhancers, their addition methods and their addition amounts to form a ultra-high contrast image, descriptions in JP-A-11-65021, paragraph [0118] and JP-A-11-223898, paragraphs [0136] to [0193], compounds represented by the formula (H), the formulae (1) to (3), and the formulae (A) and (B) in Japanese Patent Application No. Hei. 11-87297, and compounds represented by the formulae (III) to (V) in Japanese Patent Application No. Hei. 11-91652 are referred. Ultra-high contrast enhancers are described in JP-A-11-65021, paragraph [0102] and JP-A-11-223898, paragraphs [0194] to [0195].

When formic acids and their salts are used as a strong fogging substance, the fogging substances may be contained on the surface side having the image-forming layer containing photosensitive silver halide preferably in an amount of 5 mmol or less and more preferably in an amount of 1 mmol or less, per 1 mol of silver.

When the ultra-high contrast enhancers are used in the photothermographic material in the invention, it is preferable to use acids formed by hydration of phosphorus pentoxide or their salts in combination. For the acids formed by hydration of phosphorus pentoxide or their salts, meta-phosphoric acid (salt), pyro-phosphoric acid (salt), ortho-phosphoric acid (salt), triphosphoric acid (salt), tetraphosphoric acid (salt), and hexameta-phosphoric acid (salt) can be mentioned. Particularly preferable acids formed by hydration of phosphorus pentoxide or their salts are ortho-phosphoric acid (salt) and hexameta-phosphoric acid (salt). Specific examples of the salts include sodium ortho-phosphate, sodium dihydrogen ortho-phosphate, sodium hexameta-phosphate and ammonium hexameta-phosphate.

The use amount of acids formed by hydration of phosphorus pentoxide or their salts (coating amount per 1 m² of the photothermographic material) may be a desired amount according to the properties of senstivity, fog and so forth, preferably in the range from 0.1 mg/m² to 500 mg/m², and more preferably from 0.5 mg/m² to 100 mg/².

The photothermographic material in the invention may have a surface protective layer for the purpose of preventing adhesion to the image-forming layer. The surface protective layer may be a single layer or a plurality of layers. Surface protective layers are described in JP-A-11-65021, paragraphs [0119] to [0120].

For the binder in the surface protective layer, gelatin is preferable, and polyvinyl alcohol (PVA) is also preferably used. For gelatin, inert gelatin (e.g., Nitta Gelatin 750) and phthalated gelatin (e.g., Nitta Gelatin 801) can be used. For PVA, PVA-105 as a completely saponified substance, PVA-205 as a partially saponified substance, PVA-335, and MP-203 as a modified polyvinyl alcohol (all above-mentioned are trade names of products manufactured by Kuraray Co., Ltd.) are mentioned. The coating amount (per 1 m² of the support) of polyvinyl alcohol for the protective layer (per one layer) is preferably in the range from 0.3 g/m² to 4.0 g/m², and more preferably from 0.3 g/m² to 2.0 g/m².

When the photothermographic material in the invention is applied for the printing use where dimensional change becomes a specific problem, it is preferable to use the polymer latex in the surface protective layer and the back layer. Regarding such polymer latexes, descriptions are found in Synthetic Resin Emulsion, compiled by Taira Okuda and Hiroshi Inagaki, Kobunshi Kankokai (Polymer Publishing), (1978), Application of Synthesized Latex, compiled by Takaaki Sugimura, Yasuo Kataoka, Soichi Suzuki and Keiji Kasahara, Kobunshi Kankokai (Polymer Publishing), (1993), and Soichi Muroi, Chemistry of Synthesized Latex, Kobunshi Kankokai (Polymer Publishing), (1970). Specific examples of the polymer latexes include latexes of methyl methacrylate (33.5 wt %)/ethyl acrylate (50 wt %)/methacrylic acid (16.5 wt %) copolymer, latexes of methyl methacrylate (47.5 wt %)/butadiene (47.5 wt %)/itaconic acid (5 wt %) copolymer, latexes of ethyl acrylate/methacrylic acid copolymer, latexes of methyl methacrylate (58.9 wt %)/2-ethylhexyl acrylate (25.4 wt %)/styrene (8.6 wt %)/2-hydroxyethyl metacrylate (5.1 wt %)/acrylic acid (2.0 wt %) copolymer, and latexes of methyl methacrylate (64.0 wt %)/styrene (9.0 wt %)/butyl acrylate (20.0 wt %)/2-hydroxyethyl metacrylate (5.0 wt %)/acrylic acid (2.0 wt %) copolymer. Further, to the binder for the surface protective layer, combinations of polymer latexes described in Japanese Patent Application No. Hei. 11-6872, techniques described in Japanese Patent Application No. Hei. 11-143058, paragraphs [0021] to [0025], techniques described in Japanese Patent Application No. Hei. 11-6872, paragraphs [0027] to [0028], and techniques described in JP-A-2000-19678, paragraphs [0023] to [0041] may be applied. The ratio of polymer latexes in the surface protective layer is preferably in the range from 10 wt % to 90 wt % of the total binders, and particularly preferably in the range from 20 wt % to 80 wt %.

The total binder (including water-soluble polymers and latex polymers) coating amount (per 1 m² of the support) of the surface protective layer (per one layer) is preferably in the range from 0.3 g/m² to 5.0 g/m², and particularly preferably from 0.3 g/m² to 2.0 g/m².

The preparation temperature of the image-forming layer coating solution is preferably in the range from 30° C. to 65° C., more preferably from 35° C. to lower than 60° C., and further preferably from 35° C. to 55° C. It is preferred that the temperature of the image-forming layer coating solution immediately after the addition of the polymer latex is maintained in the range from 30° C. to 65° C. It is also preferred that the reducing agent and the organic silver salt have been mixed before the addition of the polymer latex.

The image-forming layer is formed with one or more layers on the support. In case of being formed with one layer, the layer comprises the organic silver salt, the photosensitive silver halide, the reducing agent and the binder, and includes additional materials desired such as an agent for controlling the tone, a covering aid and other auxiliary agents according to necessity. In case of being formed with two or more layers, the first image-forming layer (which is usually a layer adjacent to the support) comprises the organic silver salt and the photosensitive silver halide, and the second image-forming layer or both layers must include some of other components. The constitution of a multi-color photosensitive heat-developable photographic material may comprise a combination of these two layers for each color. All the components may be included in one layer as described in U.S. Pat. No. 4,708,928. In case of a multi-dye multi-color photosensitive heat-developable photographic material, each emulsion layer is generally maintained as being separated one another by using a functional or non-functional barrier layer between one photosensitive layer and another as described in U.S. Pat. No. 4,460,681.

From the viewpoint of color tone improvement, prevention of interference fringe pattern caused by an exposure with laser light and prevention of irradiation, various kinds of dyes and pigments (e.g., C. I. Pigment Blue 60, C. I. Pigment Blue 64, and C. I. Pigment Blue 15:6) can be used in the image-forming layer (photosensitive layer). Concerning these materials, detailed description are found in International Patent Laid-Open No. WO98/36322, JP-A-10-268465, and JP-A-11-338098.

In the photothermographic material in the invention, an anti-halation layer can be formed on the side far away from a light source with respect to the image-forming layer.

Generally, a photothermographic material has photo-insensitive layers in addition to photosensitive layers. The photo-insensitive layers can be classified according to their positions as follows; (1) a protective layer formed on a photosensitive layer (on the side far away from the support), (2) an intermediate layer formed between plural photosensitive layers or between a photosensitive layer and a protective layer, (3) an undercoat layer formed between a photosensitive layer and a support, and (4) a back layer formed on the opposite side of a photosensitive layer. A filter layer is formed in the photothermographic material as a layer classified in (1) or (2). The anti-halation layer is formed in the photothermographic material as a layer classified in (3) or (4).

Regarding anti-halation layers, descriptions are found in JP-A-11-65021, paragraphs [0123] to [0124], JP-A-11-223898, JP-A-9-230531, JP-A-10-36695, JP-A-10-104779, JP-A-11-231457, JP-A-11-352625, and JP-A-11-352626.

The anti-halation layer contains an anti-halation dye having absorption in the wavelength region of exposure light. In case that the exposure wavelength is in an infrared region, a dye absorbing infrared light is suitably used, wherein a dye having no absorption in the visible wavelength region is preferable.

When anti-halation is conducted by using a dye having absorption in the visible wavelength region, it is preferred that color of the dye does not remain substantially after image-formation. Any means for dye to be decolored by heat in heat development is preferably used. It is particularly preferable that a heat decoloring dye and a base precursor are added in the photo-insensitive layer to be functional as an anti-halation layer. These techniques are described in JP-A-11-231457.

The addition amount of the decoloring dye is determined according to the way of using the dye. Generally, the decoloring dyes are used in such an amount that the optical density (absorbance) measured at the objected wavelength exceeds 0.1. The optical density is preferably in the range from 0.2 to 2. The use amount of the decoloring dyes for obtaining such an optical density is generally in the range from 0.001 g/m² to 1 g/m².

By decoloration of dyes in such a way, the optical density after heat development can be lowered to 0.1 or less. Two or more kinds of decoloring dyes may be used in thermodecoloration type recording materials or in the photothermographic materials. In the similar way, two or more kinds of base precursors may be used.

In thermodecoloration using such decoloring dyes and the base precursors, from the viewpoint of the thermodecoloration property, it is preferable simultaneously to use substances (e.g., diphenylsulfone, and 4-chlorophenyl(phenyl)sulfone), which decrease a melting point by 3° C. or more when mixed with the base precursors, as described in JP-A-11-352626.

In the invention, a coloring agent having the absorption maximum at the wavelength of 300 to 450 nm can be added for the purposes of improving the silver color tone and the image change with time. Such coloring agents are described in JP-A-62-210458, JP-A-63-104046, JP-A-63-103235, JP-A-63-208846, JP-A-63-306436, JP-A-63-314535, JP-A-01-61745, and Japanese Patent Application No. Hei. 11-276751.

Such coloring agents are usually added in an amount within the range from 0.1 mg/m² to 1 g/m². As a layer to be added, the back layer provided on the opposite side of the image-forming layer is preferable.

The photothermographic materials in the invention are preferably so called one-sided photosensitive materials comprising at least one layer of the image-forming layer containing a silver halide emulsion on one surface side of the support and the back layer on the opposite surface side.

In the invention, it is preferred to add a matting agent for improving the transportability. Matting agents are described in JP-A-11-65021, paragraphs [0126] to [0127]. The coating amount of the matting agents per 1 m² of the photothermographic material is preferably in the range from 1 mg/m² to 400 mg/m², and more preferably from 5 mg/m² to 300 mg/m².

The matting degree of the image-forming surface may be any degree so far as no star dust-like defect occurs. The Bekk second is preferably in the range from 30 seconds to 2000 seconds, and particularly preferably in the range from 40 seconds to 1500 seconds. The Bekk second can easily be obtained according to the Japanese Industrial Standards (JIS) P8119, “Testing Method of Smoothness of Paper and Paperboard with Bekk's Tester” and TAPPI Standard Method T479.

In the invention, the Bekk second as a matting degree for the back layer is preferably in the range from 10 seconds to 1200 seconds, more preferably from 20 seconds to 800 seconds, and further preferably from 40 seconds to 500 seconds.

In the invention, the matting agents are preferably contained in the outermost surface layer, in a layer being functional as the outermost surface layer and in a layer close to the outer surface, of the photothermographic material, and also preferably contained in a layer being functional as the protective layer.

Back layers applicable to the invention are described in JP-A-11-65021, paragraphs [0128] to [0130].

In the photothermographic materials of the invention, a film surface pH before heat development is preferably 6.0 or less, and more preferably 5.5 or less. The lower limit is not particularly restricted but approximately 3. For adjusting the film surface pH, it is preferred from the viewpoint of lowering the film surface pH to use organic acids such as phthalic acid derivatives, non-volatile acids such as sulfuric acid and volatile bases such as ammonia. Particularly, ammonia is preferable for achieving the low film surface pH, because ammonia is apt to be volatilized and can be removed before the coating process or heat development. Measurement methods of the film surface pH are described in Japanese Patent Application No. Hei. 11-87297, paragraph [0123].

Hardening agents may be used in each of the image-forming layer, the protective layer and the back layer. Examples of hardening agents are described in T. H. James, The Theory of the Photographic Process, 4th edition, Macmillan Publishing Co., Inc., (1977), page 77 to page 87. In addition to compounds such as chrome alum, a sodium salt of 2,4-dichloro-6-hydroxy-s-triazine, N,N-ethylenebis(vinylsulfonacetamide) and N,N-propylenebis(vinylsulfonacetamide), poly-valent metal ions described in the above-mentioned book, page 78, polyisocyanates described in U.S. Pat. No. 4,281,060 and JP-A-6-208193, epoxy compounds described in U.S. Pat. No. 4,791,042, and vinylsulfone type compounds described in JP-A-62-89048 are preferably used.

The hardening agents are added as a solution. The time to add the hardening agent solution into the protective layer coating solution is from 180 minutes before coating to immediately before coating, preferably from 60 minutes before coating to 10 seconds before coating. However, there is not particularly restricted on the mixing process and the mixing conditions so far as the effects of the invention are sufficiently revealed. As specific mixing methods, a method of mixing in a tank in which an average staying time calculated from the addition flow rate and the feeding flow rate to a coater is adjusted to be a desired time, and a method using a static mixer described in N. Harnby, M. F. Edwards and A. W. Nienow, Techniques of Mixing Liquids, translated by Koji Takahashi, Nikkan Kogyo Newspaper, (1989), Chapter 8 are mentioned.

Surfactants usable in the invention are described in JP-A-11-65021, paragraph [0132], solvents are described in ibid., paragraph [0133], supports are described in ibid., paragraph [0134], antistatic or conductive layers are described in ibid., paragraph [0135]., methods for obtaining an color image are described in ibid., paragraph [0136], and lubricants are described in JP-A-11-84573, paragraphs [0061] to [0064] and Japanese Patent Application No. Hei. 11-106881, paragraphs [0049] to [0062].

For a transparent support, it is preferable to use polyester and particularly preferable to use polyethylene terephthalate, which are heat-treated in the temperature range from 130° C. to 185° C. in order to relax the residual internal stress in the biaxial stretch and to eliminate the stress of heat contraction generated in heat development. In case of photothermographic materials for the medical use, the transparent support may be colored with blue dyes (e.g., Dye-1 described in JP-A-8-240877) or not colored. To the support, it is preferable to apply undercoating techniques using water-soluble polyester described in JP-A-11-84574, styrene/butadiene copolymers described in JP-A-10-186565, and vinyliene chloride copolymers described in Japanese Patent Application No. Hei. 11-106881, paragraphs [0063] to [0080]. To the antistatic layer or the undercoating, techniques described in JP-A-56-143430, JP-A-56-143431, JP-A-58-62646, JP-A-56-120519, JP-A-11-84573, paragraphs [0040] to [0051], U.S. Pat. No. 5,575,957, and JP-A-11-223898, paragraphs [0078] to [0084] can be applied.

The photothermographic materials are preferably a momo-sheet type (a type able to form an image on a photothermographic material without using another sheet such as an image-recording material).

To the photothermographic materials, anti-oxydants, stabilizing agents, plasticizers, ultraviolet absorbing agents or covering aids may further be added. These various additives are added to either of the photosensitive layers or the photo-insensitive layers. Concerning those matters, International Patent Laid-Open No. WO98/36322, EP-A-803764, JP-A-10-186567 and JP-A-10-18568 can be referred.

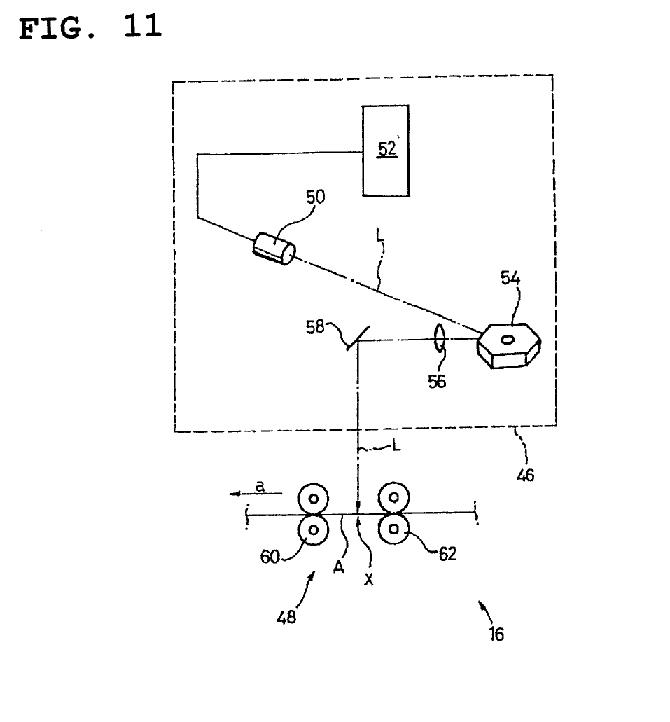

The photothermographic materials in the invention may be coated by any method. Specifically, various coating operations such as extrusion coating, slide coating, curtain coating, dip coating, knife coating, flow coating, and extrusion coating with a kind of hopper described in U.S. Pat. No. 2,681,294 are used. Extrusion coating or slide coating described in Stephen F. Kistler and Peter M. Schweizer, Liquid Film Coating, Chapman & Hall, (1997), page 399 to page 536 is preferably used, and slide coating is particularly preferably used. Examples of the shape of a slide coater used for slide coating are found in the above-described book, page 427, FIG. 11b.1. In compliance with the request, two or more layers can simultaneously be coated by methods described in the above-described book, page 399 to page 536, U.S. Pat. No. 2,761,791 and British Patent 837095.

The organic silver salt containing layer coating solution in the invention is preferably a so-called thixotropic fluid. Thixotropy means a behavior that viscosity decreases as shearing force increases. Any instrument may be used for viscosity measurement. RFS Fluid Spectrometer manufactured by Rheometrics Far East Co. is preferably used and measured at 25° C. For the organic silver salt containing layer coating solution in the invention, the viscosity at the shearing velocity of 0.1 S⁻¹ is preferably in the range from 400 mPa·s to 100,000 mPa·s, and more preferably from 500 mPa·s to 20,000 mPa·s. Besides, the viscosity at the shearing velocity of 1000 S⁻¹ is preferably in the range from 1 mPa·s to 200 mPa·s, and more preferably from 5 mPa·s to 80 mpa·s.

Various systems exhibiting thixotropy are known and described in Lecture, Rheology, compiled by Kobunshi Kankokai (Polymer Publishing), and Muroi and Morino, Polymer Latex, Kobunshi Kankokai (Polymer Publishing). It is necessary for a fluid to contain a large amount of solid fine particles for exhibiting thixotropy. For enhancing thixotropy, it is effective that viscosity-increasing linear high molecules are contained, and that the solid fine particles contained are anisotropically shaped to have a large aspect ratio. The use of alkali thickners or surfactants is also effective.

For the techniques usable for the photothermographic material in the invention, techniques described in the following references are mentioned: EP-A-803764, EP-A-883022, International Patent Laid-Open No. WO98/36322, JP-A-56-62648, JP-A-58-62644, JP-A-9-281637, JP-A-9-297367, JP-A-9-304869, JP-A-9-311405, JP-A-9-329865, JP-A-10-10669, JP-A-10-62899, JP-A-10-69023, JP-A-10-186568, JP-A-10-90823, JP-A-10-171063, JP-A-10-186565, JP-A-10-186567, from JP-A-10-186569 to JP-A-10-186572, JP-A-10-197974, JP-A-10-197982, JP-A-10-197983, from JP-A-10-197985 to JP-A-10-197987, JP-A-10-207001, JP-A-10-207004, JP-A-10-221807, JP-A-10-282601, JP-A-10-288823, JP-A-10-288824, JP-A-10-307365, JP-A-10-312038, JP-A-10-339934, JP-A-11-7100, JP-A-11-15105, JP-A-11-24200, JP-A-11-24201, JP-A-11-30832, JP-A-11-84574, JP-A-11-65021, JP-A-11-109547, JP-A-11-125880, JP-A-11-129629, from JP-A-11-133536 to JP-A-11-133539, JP-A-11-133542, JP-A-11-133543, JP-A-11-223898, and JP-A-11-352627.

The heat development apparatus to be used in the invention will be explained in detail hereinafter.

In the invention, a plate heater system is used as a heat development system of the heat development apparatus. The heat development apparatus by means of the plate heater system is a heat development apparatus characterized by obtaining a visible image by making the photothermographic material having formed a latent image touched to a heating means in a heat development part. The heat development apparatus is characterized in that the heating means comprises plate heaters and a plurality of pressing rollers positioned in facing to and along the one surface of the plate heaters, and the photothermographic material is carried through to be heat-developed between the pressing rollers and the plate heaters.

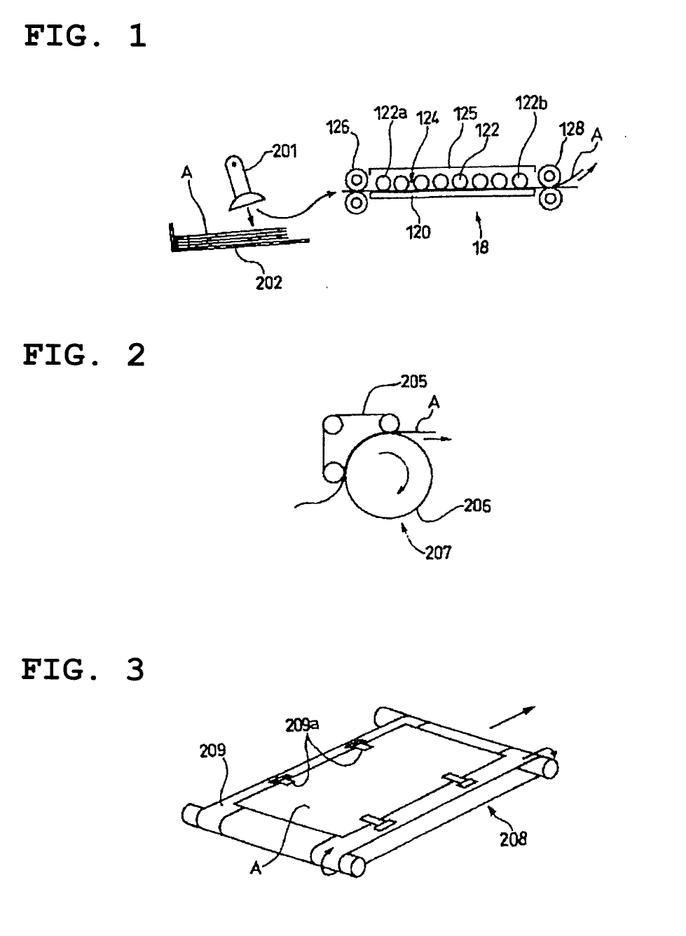

Detailed explanation will hereinafter be done based on the drawings attached. FIG. 1 is a schematic constitution view showing mainly the heat development part 18 of the heat development apparatus to be used in the invention. The heat development part 18 heats the photothermographic material (called as a sheet A). As the constitution, the heat development part comprises a plate heater 120 which is a heating body heated at a temperature needed to treat the sheet A, a carrying means 126 which moves (slides) the sheet A relatively to the plate heater 120 while the sheet A is kept as being contacted with the surface of plate heater 120 and a pressing roller 122 which is a pressing means to press the backside of sheet A contacting with the plate heater 120 for transferring heat from the plate heater 120 to the sheet A.

The plate heater 120 is a plate-like heating component inside of which a heating body such as a Nichrome wire has been arranged in a plane form, and is maintained at a development temperature for the sheet A. Besides, the constitution of plate heater may be such that the material of surface contacting with the sheet A is simply a heat conductor with a rubber heater installed on the backside or with a hot air blow or a lamp for heating.

The sheet A in a deposit tray 202 is sucked by a suction unit 201, and then guided to the heat development part 18 with the aid of a charging roller pair 126 driven by a driving unit (not indicated in drawings). Then, the sheet A passes (slides) between the pressing roller 122 and the plate heater 120 owing to a carry driven by the roller pair 126 to be heat-treated. The sheet A accomplished with the heat treatment is discharged with the aid of a guiding roller 128. In order to avoid scratches and the like as possible, it is preferable that a surface having a function which needs a heat treatment is not selected as the surface of sheet A to be contacted with the plate heater 120. In case of a sheet for an important observation, it is also preferable that the surface for observation is not selected as the surface to be contacted with the plate heater 120.

A plurality of pressing roller 122 are provided in a given pitch over the total length in the carrying direction of the plate heater 120 in contact or in a space equal to the thickness of the sheet A or less with the one surface of the plate heater 120 to form a sheet carrying path 124 between these pressing rollers 122 and the plate heater 120. By making the space of the sheet carrying path 124 be narrowed equal to the thickness of the sheet A or less, the situation that the sheet A is smoothly inserted is realized and it becomes possible to prevent folding of the sheet A. On the both ends of the sheet carrying path 124, a charging roller pair 126 and a discharging roller pair 128 are provided as a sheet carrying means.

For the pressing roller 122, a metal roller, a resin roller, a rubber roller and the like can be utilized. The heat conductivity of the pressing roller 122 is suitably in the range from 0.1 to 200 W/m/° C. Further, it is preferable that a heat-retaining cover 125 is provided in the side of the pressing roller 122 and in the opposite position to the plate heater 120.

Furthermore, when the top edge of the sheet A runs against the pressing roller 122 during being carried, the sheet A stops a moment. In case that each pressing roller 122 is apart in an equal pitch, the same part of sheet A stops at each pressing roller 122 and the part is pressed to the plate heater in a long time. As a result, a stripe-like development unevenness extending in the direction of width of the sheet A occurs. Therefore, it is preferable to set a pitch for each pressing roller 122 unequal.

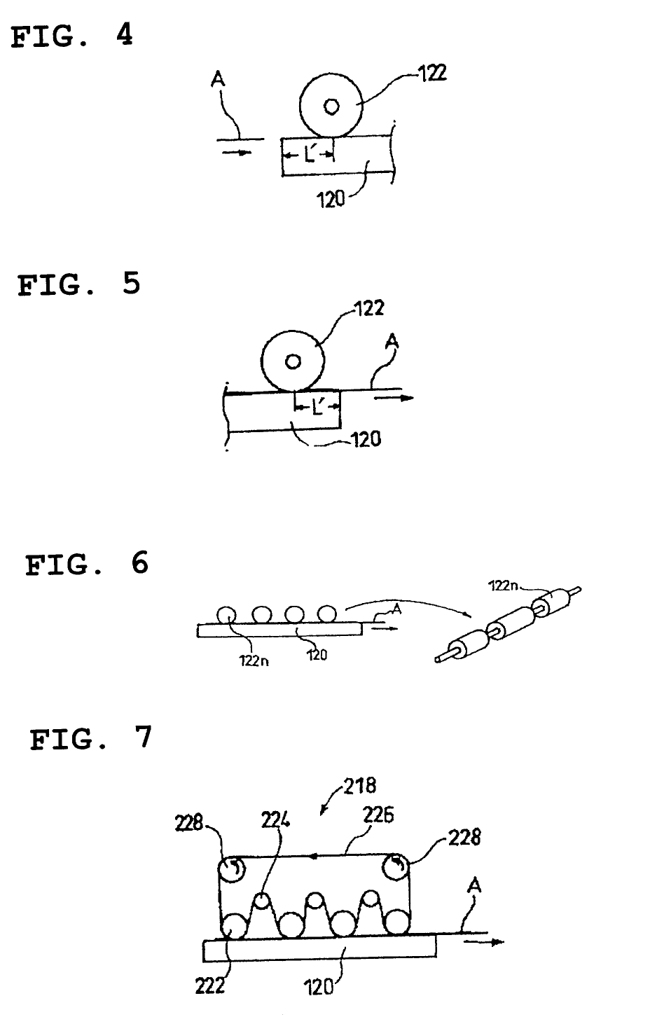

As a carrying means for the sheet A, here is used the charging roller pair 126 arranged closely to the pressing roller 122 at the most up-streamed and immediately before the plate heater 120. As such a carrying means, the guiding roller 128 may have a driving power. Further, as another mode of carrying means for the sheet A, FIG. 2 shows a carrying unit 207 which carries the sheet A by holding it between a belt 205 and a drum 206. This drum type carrying unit 207 is arranged in the position of the charging roller pair 126 to guide the sheet A between the pressing roller 122 and the plate heater 120 and then to pass it. As the other mode of carrying means for the sheet A, FIG. 3 shows a holding claw type carrying unit 208 which carries the sheet A by holding claws 209a capable of catching the both ends of sheet A disposed on a belt 209 which is rotationally driven. This holding claw type carrying unit 208 can be arranged in the same position as that of the drum type carrying unit 207 to heat-treat the sheet A. However, any type of unit that can guide and carry the sheet A to the heat development part may be used without being limited by the above examples.

Furthermore, as a mode of carrying means for the sheet A in the heat development part, FIG. 7 shows a carrying unit 218. The constitution includes a carrying belt 226 tensionally charged on a driving roller 228, charged on the pressing roller 222, and further charged on a detaching roller 224. Then, the sheet A is put between the plate heater 120 and a carrying belt 226 at the position of the pressing roller 222 and carried by the driving force of the carrying belt 226. In this case, the carrying belt has a higher friction coefficient for the sheet A than the friction coefficient that the surface of plate heater 120 has for the sheet A, so that the sheet A can be firmly carried. In this constitution, the charging roller pair 126 and the discharging roller pair 128 are arranged in the same manner as in the heat development part 18 shown in FIG. 1. The detaching roller 224 avoids that the pressing power distribution in the sheet A fails to be uniform when the carrying belt 226 touches the whole surface of sheet A. By this effect, the detaching roller 224 can inhibit the unevenness of heating.

Now, the heat development part 18 shown in FIG. 1 is again described. It is necessary to inhibit the sheet-folding through realizing the state where the sheet A is smoothly inserted by making the roller pressure sure between the pressing roller 122 and the plate heater 120 regarding the positional relation between the plate heater 120 and both of a pressing roller 122a (at the most up-streamed side) and 122b (at the most down-streamed side) of a plurality of pressing rollers 122. Therefore, each of the pressing roller 122a and 122b is positioned closely to the each corresponding edge part of the plate heater 120. Desirably as shown in FIG. 4 and FIG. 5, it is preferable that the position arrangement is performed so as to make a distance L′ from the edge part of the plate heater 120 to each of the pressing roller 122a and 122b in the range of 0<L′<5 mm approximately. In addition, the shape of the pressing roller 122 is cylindrical as desired in general. As shown in FIG. 6, it can be a skewer type pressing roller 122n in which a cylinder part is cut off in the axial direction.

In the heat development part shown in FIG. 1, the pressing roller 122 is constituted as a pressing means only to press the backside of contacting surface of the sheet A with the plate heater 120. In this case, to this pressing roller 122, it is also possible to apply a constitution as a means for carrying the sheet A in addition to the means for pressing the sheet A. For such a constitution, a rotational driving unit (not indicated in the drawing) is connected to each pressing roller 122 in the heat development part 18. For this driving method, a gear-driving, a chain-driving and a belt-driving can be applied by setting a sprocket for each pressing roller 122. Also, even a constitution to drive only one pressing roller 122 is possible. Further, in consideration of cost and space of apparatus, it is possible to make a constitution to drive all the pressing rollers 122 by one driving source. And in case of giving a carrying function in addition to a pressing function to the pressing roller 122, it is preferable that the surface of pressing roller 122 has a higher friction coefficient for the sheet A than the friction coefficient of the surface of plate heater 120 for the sheet A. Further, in order to press the sheet A firmly, it is desirable that the rotation precision (deviation) of the pressing roller 122 does not exceed a half of the thickness of sheet A. On the same reason, the pressing pressure of the pressing roller 122 is desirably in the range from 0.1 to 20 kg/m.

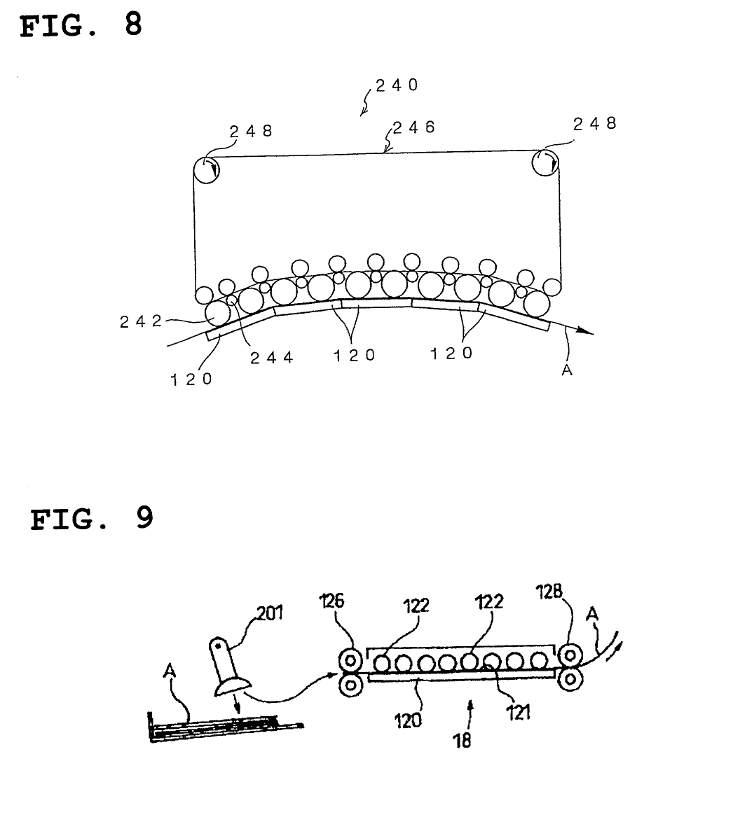

FIG. 8 shows the second mode of the heat development part adopting a belt-driving unit 240 for a pressing roller 242. The constitution of this heat development part comprises driving the pressing roller 242 pressing the plate heater 120 by pressing a driving belt 246 tensionally charged on a driving roller 248 to the pressing roller 242, and further giving the pressing roller 242 a carrying force for the sheet A in response to the rotation of the driving belt 246, while the contact of one pressing roller to another is inhibited by arranging a bearing 244 between one pressing roller 242 and another. The plate heater 120 may be divided and arranged in a form of arch as shown. In the mode described in the above, the plate heater 120 in a form of plate is used as a heating body. However, various types can be suited to such a heating body as far as they can supply heat effectively to the sheet A. For example, there are a self-heat emitting type such as a ceramic heater, a laminated type consisting of a heater and a heat-conductive material such as a rubber heater, an indirect type which heats a heat-conductive material by a convection heat transfer with a hot air blow and a radiation type which heats a heat-conductive material with irradiation from a halogen lamp heater.

For the heat distribution of the plate heater 120 as a heating body, it is preferable that an temperature slope is provided so that the temperatures of the both ends become higher than those of other parts for compensating the temperature decrease of the both ends due to radiation of heat. And a highly heat-conductive body such as a metal with a high heat-conductivity is good for the heat-conductive material in order to enhance the heat transfer to the sheet A. The heat conductivity of a heat-conductive material in practical use is desirably in the range from 1 to 400 w/m/° C., and more desirably from 10 to 400 w/m/° C. For preventing the temperature lowering of the heating body when the sheet A is heat-treated, particularly in frequent processing, it is necessary to enlarge the amount of heat supply of the heating body. For example, in consideration of a processing capacity for approximately 150 sheets of a half-size (35.6 cm×43.2 cm) to be heat-treated in 60 minutes, the amount of heat supply is desirably in the range from 1 to 20 kw/m²/° C., and more desirably from 5 to 20 kw/m²/° C. It is preferable that the heat capacity of the heating body is distributed in the carrying direction of the sheet A in consideration of a heat efficiency. Generally, the heat exchange with the sheet A becomes larger at the sheet-entrance part of the heating body, since the sheet A naturally at a lower temperature than the heating temperature is carried in. Accordingly, it is effective for inhibiting the temperature fluctuation of the heating body that the heat capacity in the side of sheet-entrance is made larger.

It is preferable that the plate heaters are divided into two to six steps and the temperature of the top part is lowered by approximately 1° C. to 10° C. Such a method is described in JP-A-54-30032. The method makes it possible to remove moisture and organic solvents contained in the photothermographic material out of the system and to inhibit change of the support shape caused by rapid heating of the photothermographic material.

Such a plate heater has smaller temperature fluctuation, so that the quality of heat treatment is improved.

FIG. 9 shows a heat development part 18 having other constitution to improve slipperiness between the plate heater 120 and the sheet A. For the constitution, a coating 121 with a low friction coefficient is coated on the surface of the plate heater 120 contacting with the sheet A. Here are the same codes provided for elements having the same function as those in FIG. 1, therefore, explanation is skipped. By using the coating 121 like this, the sheet A slides smoothly to be carried by even a smaller pressing power of the pressing roller 122 and results in less scratches in proportion to smaller pressing power.

This coating 121 fulfils conditions such as a low friction coefficient with the sheet A, less scratch occurrence in the sheet A and less frictional wear of the surface coated with the coating 121. The coated surface has preferably a high surface hardness and flatness. The adaptable surface hardness is preferably HV (0.025) 300 or more, more preferably 400 or more, and further preferably 500 or more. Besides, the surface roughness is preferably Ra 1.0 μm or less, more preferably 0.6 μm or less, and further preferably 0.3 μm or less. Specific examples of coating include electrolytic plating such as nickel plating, chrome plating and hard chrome plating, chemical plating such as non-electrolytic nickel plating, non-electrolytic nickel+fluorine resin impregnation, anodic oxidation treatment, anodic oxidation treatment+fluorine resin impregnation, fused spraying of a ceramic or titanium oxide, or these further impregnated with fluorine resin, and vacuum plating of a material such as DLC (diamond-like carbon), titanium nitride, chromium nitride, titanium chromium nitride or titanium carbon nitride.

In order to carry the sheet A, it is preferable that the friction coefficient between the sheet A and the surface of plate heater 120 is smaller than the friction coefficient between the sheet A and the pressing roller 122. In case that the surface of plate heater 120 is coated, the friction coefficient K between the sheet A and the coated surface is preferably in the range of 0.05<K<0.7. When both of the sheet A and the coating of plate heater 120 are flat, there is the impossibility of carrying caused from sticking between the sheet A and the coating surface. By selecting the values of surface roughness of the coating surface and the sheet A as those in the range not overlapped each other, the constitution can be formed so as to avoid the increase of resistance caused from adsorbed state of vacuum originated in overlapping of uneven forms on the surfaces. From the same reason, the ratio of contact between the sheet A surface and the coating surface is preferably in the range from 0 to 0.8.

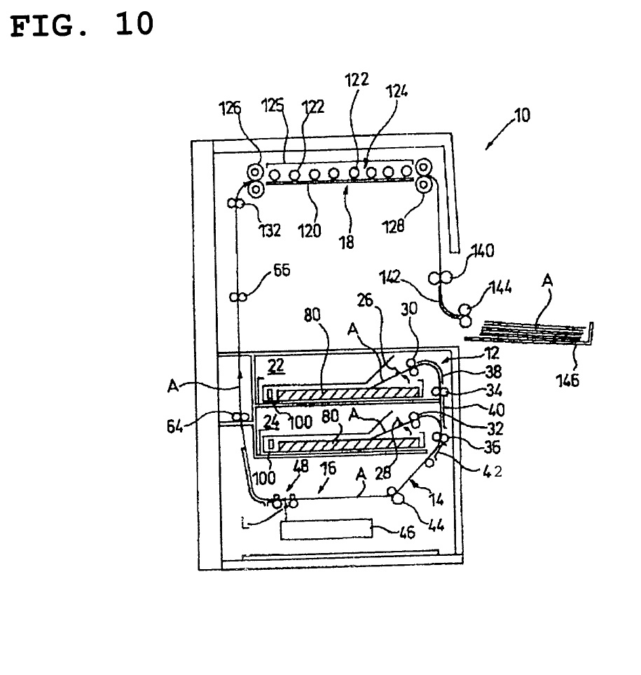

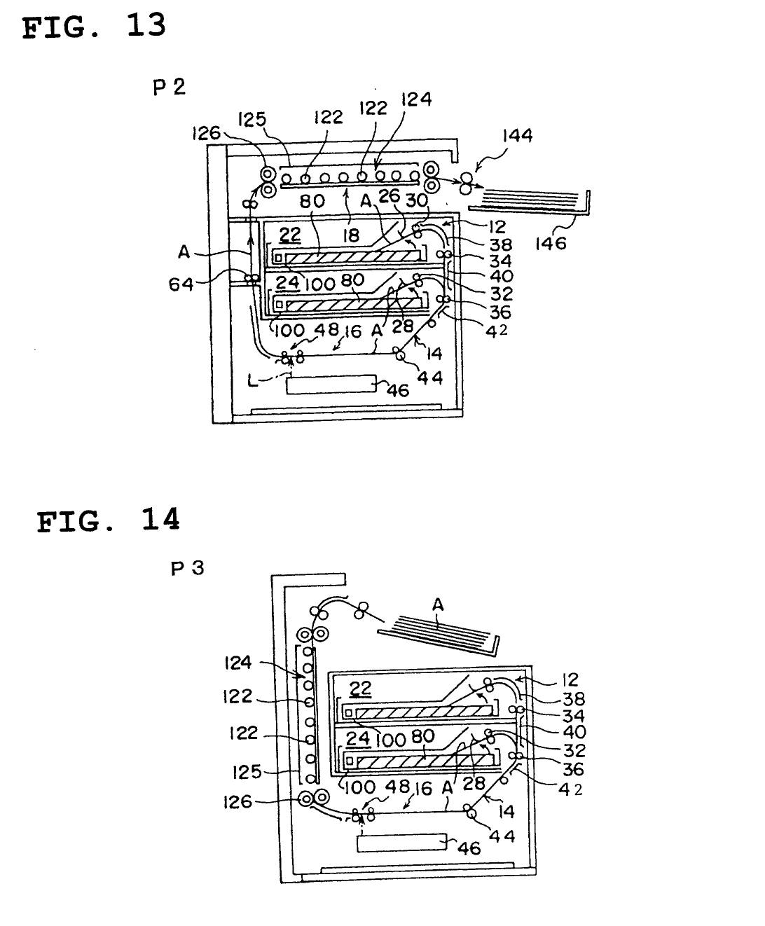

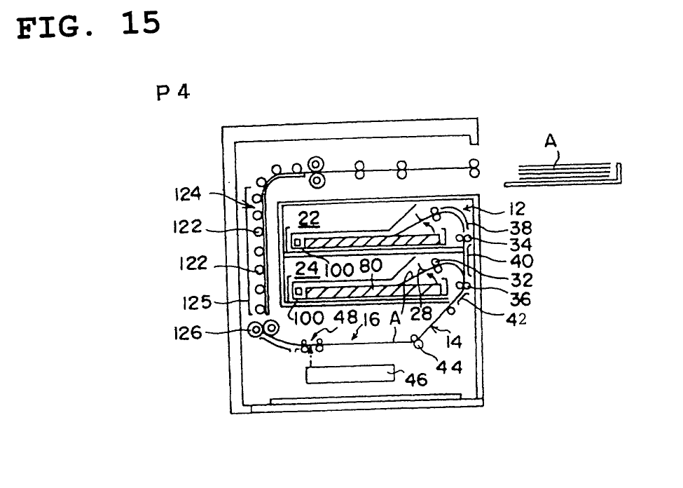

FIG. 10, FIG. 13, FIG. 14 and FIG. 15 indicate schematic constitution views showing examples of heat development apparatus employable in the invention. These heat development apparatus are equipped with a heat treatment part. In the following, explanation will be done by taking the heat development apparatus in FIG. 10 as an example. The heat development apparatus 10 in FIG. 10 is, in the order of the carrying path for the photothermographic material (sheet A), constituted with a recording material supply part 12, a centering part 14, an image exposure part 16 and the heat development part 18 as the main constitution elements.

The recording material supply part 12 is a part to take the sheet A out one by one and to supply it to the centering part 14 which is located in the down-stream in the direction of carrying the sheet A. The constitution of the recording material supply part 12 comprises loading parts 22 and 24, a recording material supply means having suckers 26 and 28 disposed in each loading part described in the above, charging roller pairs 30 and 32, carrying roller pairs 34 and 36, and carrying guides 38, 40 and 42.

The loading parts 22 and 24 are part-positions for loading a magazine 100 which has stored the sheet A at a given position. In the example indicated by the drawing, there are two loading parts 22 and 24, for both of which the magazine 100 storing different sizes of the sheet A (e.g., a half-size for CT and MRI and B4-size for FCR (Fuji Computed Radiography)) is normally loaded. A recording material supplying means arranged at each loading part 22 and 24 carries the sheet A by adsorbing and holding the sheet A with suckers 26 and 28 and by carrying the suckers 26 and 28 with a known carrying means such as a link mechanism, and supplies the sheet A to the charging roller pair 30 or to the charging roller pair 32 arranged at each loading part 22 and 24 respectively.

The photothermographic material is a recording material which records an image (imagewise exposed) by means of a light beam such as at least one laser beam, and then heat-developed to result in coloration. The photothermographic materials are processed into a form of sheet and finished in an accumulated body (a bundle) of a given units, normally one hundred sheets, and then packed with a bag and a band to be a package 80.

The sheet A in the loading part 22 is supplied to the charging roller pair 30 and carried by the carrying roller pair 34 and 36, while guided with the carrying guide 38, 40 and 42, to the centering part 14 in the down-stream. On the other hand, the sheet A in the loading part 24 is supplied to the charging roller pair 32 and carried by the carrying roller pair 36, while guided with the carrying guide 40 and 42, to the centering part 14 in the down-stream.

The centering part 14 is a part which makes positioning of the sheet A to the main scanning direction in the image exposure part 16 in the down-stream by positioning the sheet A in the direction crossing at right angles with the carrying direction (hereinafter called as the width direction), namely by making the so-called side-registration, and carries the sheet A by a carrying roller pair 44 to the image exposure part 16 in the down-stream. A method for side-registration in the centering part 14 is not particularly limited. Various known methods are illustrated; for example, a method using a registration board which makes positioning by contacting one edge of the sheet A in the width direction and a pressing and moving means such as a roller which presses and moves the sheet A in the width direction to make the edge contact the registration board, and a method using the foregoing registration board and a guiding plate movable in the width direction according to the size of sheet A in order to regulate the carrying direction of the sheet A in the width direction to contact with the registration board. The sheet A carried to the centering part 14 is positioned in the direction crossing at right angles with the carrying direction as described in the above, and then carried by the carrying roller pair 44 to the image exposure part 16 in the down-stream.

The image exposure part 16 is a part which imagewise exposes the sheet A to light by means of a light beam scanning exposure. The constitution of the image exposure part 16 comprises an exposure unit 46 and a sub-scanning carrying means 48. As shown in FIG. 11, the exposure unit 46 is a light beam scanning unit known in public. The exposure unit 46 deflects a light beam L which is modulated in response to the recording image in the main scanning direction (the width direction of the sheet A) and makes the light incident into a given recording position X. The constitution of the exposure unit 46 comprises a light source 50 which radiates a light beam of a narrow wave length region corresponding to the spectral sensitivity characteristics of the sheet A, a recording and controlling unit 52 which drives the light source 50, a poligon mirror 54 which is a light deflector, an fθ lens 56 and a down-reflection mirror 58. Further, in addition to the above, various parts arranged in the known light beam scanning unit, such as a collimator lens shaping the light beam L radiated from the light source, a beam expander, an optical system correcting a face distortion, and a mirror for adjusting the light path are arranged in the exposure unit 46 according to necessity.

In response to the recording image, the recording and controlling unit 52 drives the light source 50 in pulse width modulation to radiate the light beam L modulated in pulse width in response to the recording image. The light beam L radiated from the light source 50 is deflected by the polygon mirror 54 into the main scanning direction, adjusted by the fθ lens 56 to focus on the recording position X, and changed by the down-reflection mirror 58 for a light path to incident on the recording position X. Besides, the example shown in the drawing is a unit for monochromatic image recording where the exposure unit 46 has only one light source 50. However, in case of applying for color image recording, for example, an exposure unit having three kinds of light sources which radiate light beams each corresponding to the spectral sensitivity characteristics, R (red), G (green) and B (blue) of a color photosensitive material is used.

On the other hand, the sub-scanning carrying means 48 has a pair of carrying roller pair 60 and 62 arranged so as to put the recording portion X (scanning line) therebetween and carries the sheet A in the sub-scanning direction (the direction of an arrow mark a in FIG. 11) crossing at right angles with the main scanning direction while holding the sheet A in the recording position X by means of the carrying roller pairs 60 and 62. At this point, since the light beam L modulated in response to the recording image is deflected in the main scanning direction as described in the above, the sheet A is two-dimensionally scanning-exposed to light beam to record a latent image.

In the example illustrated in the drawing, the constitution is based on pulse width modulation by directly modulating the light source 50. However, in addition to the above, the invention is possible to be applied to a unit for pulse number modulation as well as a unit of indirect modulation using an external modulator such as AOM (Acousto-optical modulator) so long as it is a unit for pulse width modulation. Further, the image recording may be conducted by means of analog intensity modulation.

The sheet A carried to the image exposure part 16 is exposed by a laser light or the like in a manner of light beam scanning to form a latent image on the sheet A, and then carried to the heat development part 18 by carrying rollers 64 and 66 or the like. On the occasion, dusts on the surface and the back surface of the sheet A are removed by a dust-removing roller 132.

For the heat development part 18 of heat development apparatus to be used in the invention, it is preferable to use the heat development part in the first or second mode described in the above. The heat development part 18 is constituted as described in the above. Further, it is preferable that the sheet A is preheated at a temperature not higher than the development temperature before the sheet A reaches the heat development part 18. Owing to such a procedure, unevenness of development can further be reduced. As shown in FIG. 10, it is preferable that the dust-removing roller 132 having adhesive property is arranged immediately before the heat development part 18 to remove dust on the sheet A which is to be supplied to the heat development part 18. According to such a manner, the unevenness of development caused by dusts can be prevented. Then, the sheet A discharged from the heat development part 18 is carried by a carrying roller pair 140 to a guide plate 142 to be guided, and delivered to a tray 146 from a discharging roller pair 144.

The temperature of heat development in the invention is preferably from 80° C. to 250° C., and more preferably from 100° C. to 140° C. The development time is preferably from 5 seconds to 20 seconds, and more preferably from 8 seconds to 15 seconds.

The photothermographic materials in the invention may be exposed by any method. Laser beams are preferably used as a light source for exposure. For the laser light sources used in the invention, a gas laser (Ar⁺, or He—Ne), a YAG laser, a dye laser, and a semiconductor laser are preferable. A semiconductor laser and second harmonic generating element can also be used. A gas laser or a semiconductor laser radiating red to infra red light is preferred.

As a laser imager having an exposure part and a heat development part for the medical use, Fuji Medical Dry Laser Imager FM-DP L can be mentioned. Descriptions regarding FM-DP L are found in Fuji Medical Review No. 8, page 39 to 55. It goes without saying that those techniques are applicable to the laser imager for the photothermographic materials in the invention. The photothermographic materials can also be applied as a photothermographic material for the laser imager in “AD network” proposed by Fuji Medical System as a network system adapted to the DICOM Standards.

The photothermographic materials in the invention form a black-and-white image made of a silver image. Therefore, the photothermographic materials are preferably used as photothermographic materials for the medical diagnosis, photothermographic materials for the industrial photography, photothermographic materials for the printing use, and photothermographic materials for the COM use.

It is preferable that the invention is used as a heat development process for photothermographic materials forming a black-and-white image made of a silver image in the medical diagnosis use, for photothermographic materials in the industrial photography use, for photothermographic materials in the printing use, and for photothermographic materials in the COM use.

The features of the invention are further concretely explained in the following examples. The materials, the amount of use, the ratio, the content of treatment, the steps of procedure and so forth may properly be changed as far as they do not deviate from the object of the invention. Therefore, the domain of the invention should not be construed as being limited by the examples described below.

### EXAMPLE 1

### Preparation of Undercoated Support

### Preparation of PET Support

PET having an intrinsic viscosity IV=0.66 (measured at 25° C. in phenol/tetrachloroethane=6/4 (by weight)) was obtained according to an ordinary preparation method by using terephthalic acid and ethylene glycol. After the obtained PET is pelletized, the pellets were dried at 130° C. for 4 hours, melted at 300° C., extruded from a T-type die, and rapidly quenched, thereby an unstretched film having a film thickness after heat fixation to become 175 μm in thickness was made.

This film was stretched up to 3.3 times in the machine direction with rollers having different peripheral velocities, then up to 4.5 times in the transverse direction by means of a tenter. The temperatures at that time were 110° C. and 130° C. respectively. Subsequently, the film was subjected to heat fixation at 240° C. for 20 seconds, then to relaxation by 4% in the transverse direction at the same temperature. The chuck part of the tenter was then slit off, and the both edges of the film were subjected to knurl processing. The film was rolled at 4 kg/cm² to obtain a roll of film having a thickness of 175 μm.

### Corona Discharge Surface Treatment

Both surfaces of the support were treated at a room temperature at the web handling velocity of 20 m/min with a solid state corona processor, Model 6KVA manufactured by Pillar Co. From the values of electric current and voltage read at that time, it was found that the treatment of 0.375 kV-A-min/m² was applied to the support. The treatment frequency was 9.6 kHz and the gap clearance between the electrode and the dielectric roll was 1.6 mm.

### Preparation of Undercoated Support

1. Preparation of Coating Solution for Undercoat Layer
Prescription 1 (undercoat layer on the image-forming layer
side)

| | | |
|---|---|---|
| Pesresin A-515GB (30 wt % solution) | 234 | g |
| manufactured by Takamatsu Yushi Co., Ltd. | | |
| Polyethylene glycol monononylphenyl ether | 21.5 | g |
| (average number of ethylene oxide = 8.5, | | |
| 10 wt % solution) | | |
| Fine particles of polymer (MP-1000, | 0.91 | g |
| average particle size: 0.4 μm, manufactured by | | |
| Soken Kagaku Co., Ltd.) | | |
| Distilled water | 744 | ml |

Prescription 2 (first layer on the back surface side)

| | | |
|---|---|---|
| Styrene/butadiene copolymer latex | 158 | g |
| (solid content: 40 wt %, weight ratio of | | |
| styrene/butadiene = 68/32) | | |
| Sodium 2,4-dichloro-6-hydroxy-s-triazine | 20 | g |
| (8 wt % aqueous solution) | | |
| Sodium laurylbenzenesulfonate | 10 | ml |
| (1 wt % aqueous solution) | | |
| Distilled water | 854 | ml |

Prescription 3 (second layer on the back surface side)

| | | |
|---|---|---|
| SnO₂/SbO (9/1 weight ratio, average particle | 84 | g |
| size: 0.038 μm, 17 wt % dispersion) | | |
| Gelatin (10 wt % aqueous solution) | 89.2 | g |
| Metrose TC-5 manufactured by Shin-Etsu | 8.6 | g |
| Chemical Co., Ltd. (2 wt % aqueous solution) | | |
| MP-1000 manufactured by Soken Kagaku Co., Ltd. | 0.01 | g |
| Sodium dodecylbenzenesulfonate | 10 | ml |
| (1 wt % aqueous solution) | | |
| NaOH (1 wt %) | 6 | ml |
| Proxel (manufactured by ICI Co., Ltd.) | 1 | ml |
| Distilled water | 805 | ml |

### Preparation of Undercoated Support

After giving the corona discharge treatment on each of both surfaces of the above-prepared biaxially stretched polyethylene terephthalate support of 175 μm in thickness, the undercoating solution described in Prescription 1 was coated on the one surface (the surface with an image-forming layer) by means of a wire-bar in a wet coating amount of 6.6 ml/m² (per one surface) and dried at 180° C. for 5 minutes. Then, the undercoating solution described in Prescription 2 was coated on the opposite surface (the back surface) by means of a wire-bar in a wet coating amount of 5.7 ml/m² and dried at 180° C. for 5 minutes. Further, the undercoating solution described in Prescription 3 was coated on the surface (the back surface) by means of a wire-bar in a wet coating amount of 7.7 ml/m² and dried at 180° C. for 6 minutes. Thus, the undercoated support was prepared.

### Preparation of Back Surface Coating Solution

### Preparation of Solid Fine Particle Dispersion (a) of Base Precursor

64 g of Base Precursor Compound 11 shown below, 28 g of diphenylsulfone and 10 g of surfactant Demol N manufactured by Kao Corporation were mixed with 220 ml of distilled water. The mixed solution was dispersed by using beads with a sand-mill (¼ Gallon sand grinder mill manufactured by Imex Co., Ltd.). Solid Fine Particle Dispersion (a) of the base precursor having an average particle diameter of 0.2 μm was thus obtained.

### Preparation of Solid Fine Particle Dispersion of Dye

9.6 g of Cyanine Dye Compound 13 shown below and 5.8 g of sodium p-dodecylbenzenesulfonate were mixed with 305 ml of distilled water. The mixed solution was dispersed by using beads with a sand-mill (¼ Gallon sand grinder mill manufactured by Imex Co., Ltd.), thereby the solid fine particle dispersion of the dye having an average particle diameter of 0.2 μm was obtained.

### Preparation of Anti-Halation Layer Coating Solution

17 g of gelatin, 9.6 g of polyacrylamide, 70 g of the solid fine particle dispersion (a) of the base precursor, 56 g of the solid fine particle dispersion of the dye, 1.5 g of monodispersed fine particles of polymethyl methacrylate (average particle size: 8.0 μm, standard deviation: 0.4), 0.03 g of benzoisothiazolinone, 2.2 g of sodium polyethylenesulfonate, 0.2 g of Blue Dye Compound 14 shown below, 3.9 g of Yellow Dye Compound 15 shown below and 844 ml of water were mixed. Thus, the anti-halation layer coating solution was prepared.

### Preparation of Back Surface Protective Layer Coating Solution

In a reaction vessel maintained at 40° C., a coating solution of the protective layer for the back surface was prepared by mixing 50 g of gelatin, 0.2 g of sodium polystyrenesulfonate, 2.4 g of N,N-ethylenebis(vinyl sulfone acetamide), 1 g of sodium tert-octylphenoxyethoxyethanesulfonate, 30 mg of benzoisothiazolinone, 37 mg of a potassium salt of N-perfluorooctylsulfonyl-N-propylalanine, 0.15 g of polyethyleneglycol mono (N-perfluorooctylsulfonyl-N-propyl-2-aminoethyl) ether (average degree of polymerization of ethylene oxide: 15), 32 mg of C₈F₁₇SO₃K, 64 mg of C₈F₁₇SO₂N (C₃H₇) (CH₂CH₂O)₄ (CH₂)₄SO₃Na, 8.8 g of a copolymer of aclylic acid/ethylacrylate (weight ratio of copolymerization: 5/95), 0.6 g of aerosol OT (American Cyanamide Co.), 1.8 g of a liquid paraffin emulsion as liquid paraffin and 950 ml of water.

### Preparation of Silver Halide Emulsion 1

To 1,421 ml of distilled water, 3.1 ml of 1 wt % potassium bromide solution was added, then, 3.5 ml of sulfuric acid in the concentration of 0.5 mol/l and 31.7 g of phthalated gelatin were added. This mixed solution was stirred and maintained at 34° C. in a reaction vessel made of stainless steel. Solution A containing 22.22 g of silver nitrate diluted with distilled water to 95.4 ml and Solution B containing 15.9 g of potassium bromide diluted with distilled water to 97.4 ml in volume were totally added at a constant flow rate during 45 seconds to the above solution. Then, 10 ml of 3.5 wt % aqueous solution of hydrogen peroxide was added, and further 10.8 ml of 10 wt % benzimidazole aqueous solution was added. Furthermore, Solution C containing 51.86 g of silver nitrate diluted with distilled water to 317.5 ml and Solution D containing 45.8 g of potassium bromide diluted with distilled water to 400 ml in volume were prepared. Solution C was totally added at a constant flow rate during 20 minutes. Solution D was added according to a controlled double jet method in keeping pAg at 8.1. Ten minutes after the start of addition of Solution C and Solution D, the total of a hexachloroiridate (III) potassium salt in an amount of 1×10⁻⁴ mol per 1 mol of silver was added. Also, five seconds after the finish of addition of Solution C, the total of an aqueous solution of potassium hexacyanoferrate (II) in an amount of 3×10⁻⁴ mol per 1 mol of silver was added. When the pH was adjusted to 3.8 with sulfuric acid in the concentration of 0.5 mol/l, stirring was stopped to perform precipitation/desalting/washing processes. With sodium hydroxide in the concentration of 1 mol/l, the pH was adjusted to 5.9, thereby a dispersion of silver halide at pAg 8.0 was made.

To the silver halide dispersion stirred and maintained at 38° C., 5 ml of a 0.34 wt % methanol solution of 1,2-benzoisothiazoline-3-one was added. After 40 minutes, a methanol solution of Spectral Sensitizing Dye A in an amount of 1×10⁻³ mol per 1 mol of silver was added to the silver halide dispersion, the temperature of which was elevated up to 47° C. after a minute. Twenty minutes after the temperature elevation, a methanol solution of sodium benzenethiosulfonate in an amount of 7.6×10⁻⁵ mol per 1 mol of silver was added. Further after 5 minutes, a methanol solution of Tellurium Sensitizer B in an amount of 1.9×10⁻⁴ mol per 1 mol of silver was added to the silver halide dispersion which was then subjected to ripening for 91 minutes. Then, 1.3 ml of a methanol solution of 0.8 wt % N,N′-dihydroxy-N″-diethylmelamine was added. After 4 minutes, a methanol solution of 5-methyl-2-mercaptobenzimidazol in an amount of 3.7×10⁻³ mol per 1 mol of silver and a methanol solution of 1-phenyl-2-heptyl-5-mercapto-1,3,4-triazol in an amount of 4.9×10⁻³ mol per 1 mol of silver were added. Thus, Silver Halide Emulsion 1 was prepared.

The grains in the prepared silver halide emulsion were pure silver bromide grains having an average equivalent-sphere diameter of 0.046 μm and an equivalent-sphere diameter variation coefficient of 20%. The grain size and others were brought from the average of 1,000 grains measured by means of an electron microscope. The {100} face ratio in these grains was 80% according to the Kubelka-Munk method.

### Preparation of Silver Halide Emulsion 2

Silver Halide Emulsion 2 was prepared in the same manner as that in Silver Halide Emulsion 1 except that the temperature of solution at the grain formation was changed from 34° C. to 49° C., the addition time of Solution C was 30 minutes and potassium hexacyanoferrate (II) was eliminated. The precipitation/desalting/washing/dispersion processes were performed in the similar manner to those for Silver Halide Emulsion 1. Furthermore, the spectral sensitization, the chemical sensitization, and the addition of 5-methyl-2-mercaptobinzimidazol and 1-phenyl-2-heptyl-5-mercapto-1,3,4-triazol were conducted in the similar manner to the emulsion 1 to obtain Silver Halide Emulsion 2, except that the changes were done in an amount of addition of Spectral Sensitizing Dye A to 7.5×10⁻⁴ mol per 1 mol of silver, of Tellurium Sensitizer B to 1.1×10⁻⁴ mol per 1 mol of silver and of 1-phenyl-2-heptyl-5-mercapto-1,3,4-triazol to 3.3×10⁻³ mol per 1 mol, of silver. The grains in Silver Halide Emulsion 2 were cubic grains of pure silver bromide having an average equivalent-sphere diameter of 0.080 μm and an equivalent-sphere diameter variation coefficient of 20%.

### Preparation of Silver Halide Emulsion 3

Silver Halide Emulsion 3 was prepared in the same manner as that in Silver Halide Emulsion 1, except that the temperature of solution at the grain formation was hanged from 34° C. to 27° C. The precipitation/desalting/washing/dispersion processes were performed in the similar manner to those for Silver Halide Emulsion 1. Silver Halide Emulsion 3 was obtained in the similar manner to the emulsion 1, except that the changes were done in an addition amount of Spectral Sensitizing Dye A as a solid dispersion (a gelatin aqueous solution) to 6×10⁻³ mol per 1 mol of silver and of Tellurium Sensitizer B to 5.2×10⁻⁴ mol per 1 mol of silver. The emulsion grains in Silver Halide Emulsion 3 were cubic grains of pure silver bromide having an average equivalent-sphere diameter of 0.038 μm and an equivalent-sphere diameter variation coefficient of 20%.

### Preparation of Mixed Emulsion A for Coating Solution

70 wt % of Silver Halide Emulsion 1, 15 wt % of Silver Halide Emulsion 2 and 15 wt % of Silver Halide Emulsion 3 were dissolved together to make a dispersion to which 1 wt % aqueous solution of benzothiazolium iodide in amount of 7×10⁻³ mol per 1 mol of silver was added.

### Preparation of Fatty Acid Silver Salt Dispersion

87.6 kg of behenic acid (manufactured by Henkel Co., trade name: Edenor C22-85R), 423 l of distilled water, 49.2 l of aqueous solution containing NaOH in the concentration of 5 mol/l and 120 l of tert-butanol were mixed, and the mixture was allowed to react at 75° C. for 1 hour, thereby a sodium behenate solution was obtained. Apart from the sodium behenate solution, 206.2 l of an aqueous solution containing 40.4 kg of silver nitrate (pH 4.0) was prepared and maintained at 10° C. A reaction vessel charged with 635 l of distilled water and 30 l of tert-butanol was maintained at 30° C. with stirring. The total amount of the sodium behenate solution and the total amount of the silver nitrate aqueous solution were added to the content in the reaction vessel at a constant flow rate during 93 minutes 15 seconds and during 90 minutes respectively. At that time, the silver nitrate aqueous solution was solely added during 11 minutes since the start of addition of the silver nitrate aqueous solution. After that, the addition of the sodium behenate solution was started. During 14 minutes 15 seconds after the finish of addition of the silver nitrate aqueous solution, the sodium behenate solution was solely added. The temperature within the reaction vessel was set at 30° C. so as to maintain the solution temperature constant by means of an external temperature control. Also the piping of the addition system of the sodium behenate solution was warmed with a steam-trace and the degree of opening for steam was adjusted to get 75° C. of the solution temperature at the outlet of the addition nozzle tip. The piping of the addition system of the aqueous silver nitrate solution was heat-controlled by circulating cold water in the outer pipe of a double-walled tube. The positions where the sodium behenate solution and the aqueous silver nitrate solution were added were arranged symmetrically in relation to the stirring axle in the center, and the height of the position was adjusted so as not to touch the reaction solution.

After the addition of the sodium behenate solution was finished, the reaction solution was held at a temperature as it was for 20 minutes with stirring, then cooled down to 25° C. The solid content was separated by a centrifuge filtration, then, washed with water until the electrical conductivity of the filtrate reached 45 μS/cm. Thus, a fatty acid silver salt was made. The obtained solid content was stored as a wet cake without drying.

The shape of the obtained silver behenate grains was evaluated with an electron microphotograph. The obtained silver behenate grains were scaly crystals having average values of a=0.14 μm, b=0.4 μm and c=0.6 μm, an average aspect ratio of 5.2, an average equivalent-sphere diameter of 0.52 μm and an average equivalent-sphere diameter variation coefficient of 15%. (a, b and c were provided by this specification).

7.4 g of polyvinyl alcohol (trade name: PVA-217) and water were added to the wet cake in an amount corresponding to 100 g of dried solid content. After the whole weight of the mixture was adjusted to 385 g, the mixture was preliminarily dispersed with a homomixer.

Then, the preliminarily dispersed starting dispersion was processed three times with a dispersing machine (manufactured by Microfluidex International Corp., trade name: Microfluidizer M-110S-EH equipped with G10Z interaction chamber) under the pressure adjusted to 1,750 kg/cm². Thus, the silver behenate dispersion was obtained. The dispersion temperature was set at 18° C. by adjusting the temperature of coolant. The cooling operation was performed by using coil type heat exchangers installed respectively before and after the interaction chamber.

### Preparation of 25 wt % Dispersion of Reducing Agent

16 kg of water was added to 10 kg of a compound represented by the formula (I) in Table 2 and 10 kg of 20 wt % aqueous solution of modified polyvinyl alcohol (Poval MP203, manufactured by Kuraray Co., Ltd.), then thoroughly mixed to make a slurry. The slurry was fed by means of a diaphragm pump into a horizontal type sand mill (UVM-2, manufactured by Imex Co., Ltd.) filled with zirconia beads having an average diameter of 0.5 mm, and dispersed for 3 hours 30 minutes. Then, 0.2 g of a sodium salt of benzoisothiazolinone and water were added to the above dispersion so as to make the concentration of the reducing agent 25 wt %, thereby the dispersion of the reducing agent was obtained. The particles of the reducing agent included in the reducing agent dispersion thus obtained had a median particle diameter of 0.42 μm and a maximum particle diameter of 2.0 μm or less. The reducing agent dispersion obtained was filtrated with a polypropylene filter having a pore diameter of 10.0 μm to remove foreign substances such as dusts, then stored.

### Preparation of 20 wt % Dispersion of Hydrogen Bonding Type Compound

16 kg of water was added to 10 kg of the hydrogen bonding type compound described in Table 2 and 10 kg of 20 wt % aqueous solution of modified polyvinyl alcohol (Poval MP203 manufactured by Kuraray Co., Ltd.), then thoroughly mixed to make a slurry. The slurry was fed by means of a diaphragm pump into a horizontal type sand mill (UVM-2, manufactured by Imex Co., Ltd.) filled with zirconia beads having an average diameter of 0.5 mm, and dispersed for 3 hours 30 minutes. Then, 0.2 g of a sodium salt of benzoisothiazolinone and water were added to the above dispersion so as to make the concentration of the hydrogen bonding type compound 25 wt %, thereby the dispersion of the hydrogen bonding type compound was obtained. The particles of the additive included in the dispersion thus obtained had a median particle diameter of 0.42 μm and a maximum particle diameter of 1.6 μm or less. The dispersion obtained was filtrated with a polypropylene filter having a pore diameter of 10.0 μm to remove foreign substances such as dusts, then stored.

### Preparation of 10 wt % Dispersion of Mercapto Compound

8.3 kg of water was added to 5 kg of 1-phenyl-2-heptyl-5-mercapto-1,3,4-triazol and 5 kg of 20 wt % aqueous solution of modified polyvinyl alcohol (Poval MP203 manufactured by Kuraray Co., Ltd.), then thoroughly mixed to make a slurry. The slurry was fed by means of a diaphragm pump into a horizontal type sand mill (UVM-2, manufactured by Imex Co., Ltd.) filled with zirconia beads having an average diameter of 0.5 mm, and dispersed for 6 hours. Then, water was added to the above dispersion so as to make the concentration of the mercapto compound 10 wt %, thereby the dispersion of the mercapto compound was obtained. The particles of the mercapto compound included in the mercapto compound dispersion thus obtained had a median particle diameter of 0.40 μm and a maximum particle diameter of 2.0 μm or less. The mercapto compound dispersion obtained was filtrated with a polypropylene filter having a pore diameter of 10.0 μm to remove foreign substances such as dusts, then stored. Immediately before use, the mercapto compound dispersion was again filtrated with a polypropylene filter having a pore diameter of 10.0 μm.

### Preparation of 20 wt % Organic Polyhalogen Compound Dispersion-1

10 kg of water was added to 5 kg of tribromomethylnaphthylsulfone, 2.5 kg of 20 wt % aqueous solution of modified polyvinyl alcohol (Poval MP203 manufactured by Kuraray Co., Ltd.) and 213 g of 20 wt % aqueous solution of sodium triisopropylnaphthalenesulfonate, then thoroughly mixed to make a slurry. The slurry was fed by means of a diaphragm pump into a horizontal type sand mill (UVM-2, manufactured by Imex Co., Ltd.) filled with zirconia beads having an average diameter of 0.5 mm, and dispersed for 5 hours. Then, 0.2 g of a sodium salt of benzoisothiazolinone and water were added to the above dispersion so as to make the concentration of the organic polyhalogen compound 20 wt %, thereby the dispersion of the organic polyhalogen compound was obtained. The particles of the organic polyhalogen compound included in the organic polyhalogen compound dispersion thus obtained had a median particle diameter of 0.36 μm and a maximum particle diameter of 2.0 μm or less. The organic polyhalogen compound dispersion obtained was filtrated with a polypropylene filter having a pore diameter of 3.0 μm to remove foreign substances such as dusts, then stored.

### Preparation of 25 wt % Organic Polyhalogen Compound Dispersion-2

The preparation of 25 wt % Organic Polyhalogen Compound Dispersion-2 was executed in the same manner as that in the preparation of 20 wt % Organic Polyhalogen Compound Dispersion-1, except that 5 kg of tribromomethyl-(4-(2,4,6-trimethylphenylsulfonyl)phenyl)sulfone was used in place of 5 kg of tribromomethylnaphthylsulfone. After dispersing, the dispersion was diluted so as to make the concentration of the organic polyhalogen compound 25 wt % in the obtained organic polyhalogen compound dispersion, then filtrated. The organic polyhalogen compound particles included in the organic polyhalogen compound dispersion thus obtained had a median particle diameter of 0.38 μm and a maximum particle diameter of 2.0 μm or less. The organic polyhalogen compound dispersion obtained was filtrated with a polypropylene filter having a pore diameter of 3.0 μm to remove foreign substances such as dusts, then stored.

### Preparation of 26 wt % Organic Polyhalogen Compound Dispersion-3

The preparation of 26 wt % Organic Polyhalogen Compound Dispersion-3 was executed in the same manner as that in the preparation of 20 wt % Organic Polyhalogen Compound Dispersion-1, except that 5 kg of tribromomethylphenylsulfone was used in place of 5 kg of tribromomethylnaphthylsulfone and the amount of 20 wt % MP203 aqueous solution was changed to 5 kg. After dispersing, the dispersion was diluted so as to make the concentration of the organic polyhalogen compound 26 wt % in the obtained organic polyhalogen compound dispersion, then filtrated. The organic polyhalogen compound particles included in the organic polyhalogen compound dispersion thus obtained had a median particle diameter of 0.41 μm and a maximum particle diameter of 2.0 μm or less. The organic polyhalogen compound dispersion obtained was filtrated with a polypropylene filter having a pore diameter of 3.0 μm to remove foreign substances such as dusts, then stored. After storing, the dispersion was kept at 10° C. or less before use.

### Preparation of 5 wt % Solution of Phthalazine Compound

8 kg of modified polyvinyl alcohol, MP203, manufactured by Kuraray Co., Ltd. was dissolved in 174.57 kg of water. Then, 3.15 kg of 20 wt % aqueous solution of triisopropylnaphthalene sulfonic acid and 14.28 kg of 70 wt % aqueous solution of 6-isopropylphthalazine were added to the above to prepare the 5 wt % solution of 6-isopropylphthalazine.

### Preparation of 20 wt % Dispersion of Pigment

250 g of water was added to 64 g of C.I.Pigment Blue 60 and 6.4 g of Demol N manufactured by Kao Corporation, then thoroughly mixed to make a slurry. 800 g of zirconia beads having an average diameter of 0.5 mm was prepared and charged in the vessel together with the slurry. After dispersing for 25 hours with a dispersing machine (¼ G sand-grinder mill manufactured by Imex Co., Ltd.), the pigment dispersion was obtained. The pigment particles included in the pigment dispersion thus obtained had an average particle diameter of 0.21 μm.

### Preparation of 40 wt % SBR Latex

The SBR latex described below was diluted by distilled water to ten times volume, purified in a diluted state with a module for ultrafiltration (UF) purification (FS03-FC-FUY03A1, manufactured by Daisen Membrane System Co., Ltd.) up to the ionic conductivity of 1.5 mS/cm, then added with Sundet-BL manufactured by Sanyo Chemical K. K. so as to get its concentration of 0.22 wt %. Further, the pH was adjusted to 8.4 by using NaOH and NH₄OH to get the ratio in which Na⁺ ion:NH₄⁺ ion=1:2.3 (molar ratio). The latex concentration at that time was 40 wt %.

(SBR Latex: a latex of -St(71)-Bu(26)-AA(3))

Average particle size: 0.1 μm, concentration: 45 wt %, equilibrium moisture content at 25° C. and 60% RH: 0.6 wt %, ionic conductivity: 4.2 mS/cm (The ionic conductivity was measured with a conductometer, CM-30S, manufactured by Toa Denpa Kogyo Co., Ltd. And the starting solution of latex (40 wt %) was measured at 25° C.), and pH: 8.2.

### Preparation of Image-Forming Layer Coating Solution

1.1 g of the 20 wt % dispersion of the pigment obtained as described in the above, 103 g of the fatty acid silver salt dispersion, 5 g of a 20 wt % aqueous solution of polyvinyl alcohol (PVA-205, manufactured by Kuraray Co., Ltd.), 25.0 g of the 25 wt % reducing agent dispersion, the amount described in the Table 2 of the 20 wt % hydrogen bonding type compound dispersion, the total weight of 14.0 g of Organic Polyhalogen Compound Dispersion-1, Dispersion-2 and Dispersion-3 in the ratio of 5:1:3 (by weight), 5.8 g of the 10 wt % mercapto compound dispersion, 106 g of the 40 wt % SBR latex (Tg: 24° C.) purified by ultrafiltration (UF) and pH-adjusted, 18 ml of the 5 wt % phthalazine compound solution, and the amount described in the Table 2 of a solution in which a compound represented by the formula (D) such as the kinds described in the Table 2 had been dissolved in a 5% methanol/water (1/1) solution together with an equivalent molar amount of ammonia water, were added in the above order. Immediately before coating, 10 g of Silver Halide Mixed Emulsion A was added to the above mixture and thoroughly mixed to make a coating solution for the image-forming layer (an emulsion layer, a photosensitive layer). The coating solution was fed as it was to a coating die in a coating amount of 70 ml/m² and coated. The mol % values described in the Table 2 are shown as a relative mol % to the used amount of the reducing agent in Sample No. 001.

The viscosity of the coating solution for the image-forming layer was 85 (mPa·s) at 40° C. (No. 1 rotor, 60 rpm) measured with Model B viscometer (manufactured by Tokyo Keiki Co., Ltd.).

The viscosity of the coating solution measured with RFS Fluid Spectrometer (manufactured by Rheometrics Far East Co.) at 25° C. was 1500, 220, 70, 40, 20 (mPa·s) at a shearing velocity of 0.1, 1, 10, 100, 1000 (1/sec), respectively.

### Preparation of Interlayer Coating Solution for Image-Forming Surface

2 ml of a 5 wt % aqueous solution of Aerosol OT (manufactured by American Cyanamide Co.) and 10.5 ml of a 20 wt % aqueous solution of diammonium phthalate were added to 772 g of a 10 wt % aqueous solution of polyvinyl alcohol (PVA-205, manufactured by Kuraray Co., Ltd.), 5.3 g of the 20 wt % pigment dispersion and 226 g of a 27.5 wt % solution of a latex of methyl methacrylate/styrene/butyl acrylate/hydroxyethyl methacrylate/acrylic acid (copolymerization ratio by weight: 64/9/20/5/2) copolymer. Water was added to the above mixture to make the total weight of 880 g. The pH was adjusted with NaOH up to 7.5 to obtain the interlayer coating solution. The coating solution was fed to a coating die in a coating amount of 10 ml/m².

The viscosity of the coating solution was 21 (mPa·s) at 40° C. (No. 1 rotor, 60 rpm) measured with Model B viscometer.

### Preparation of First Protective Layer Coating Solution for Image-Forming Surface

64 g of inert gelatin was dissolved in water, and 80 g of a 27.5 wt % solution of a latex of methyl methacrylate/styrene/butyl acrylate/hydroxyethyl methacrylate/acrylic acid copolymer (copolymerization ratio by weight: 64/9/20/5/2), 23 ml of a 10 wt % methanol solution of phthalic acid, 23 ml of a 10 wt % aqueous solution of 4-methyl phthalic acid, 28 ml of sulfuric acid at the concentration of 0.5 mol/l, 5 ml of a 5 wt % aqueous solution of Aerosol OT (manufactured by American Cyanamide Co.), 0.5 g of phnoxyethanol and 0.1 g of benzoisothiazolinone were added thereto. Then, water was added to make the total weight of 750 g to obtain the coating solution. Immediately before coating, 26 ml of 4 wt % chrome alum was mixed by using a static mixer, then the coating solution was fed to a coating die in a coating amount of 18.6 ml/m².

The viscosity of the coating solution was 17 (mPa·s) at 40° C. (No. 1 rotor, 60 rpm) measured with Model B viscometer.

### Preparation of Second Protective Layer Coating Solution for Image-Forming Surface

80 g of inert gelatin was dissolved in water, and 102 g of a 27.5 wt % solution of a latex of methyl methacrylate/styrene/butyl acrylate/hydroxyethyl methacrylate/acrylic acid copolymer (the copolymerization ratio by weight: 64/9/20/5/2), 3.2 ml of a 5 wt % solution of a potassium salt of N-perfluorooctylsulfonyl-N-propyl alanine, 32 ml of a 2 wt % aqueous solution of polyethyleneglycol mono (N-perfluorooctylsulfonyl-N-propyl-2-aminoethyl) ether (the average degree of polymeization of polyethylene oxide=15), 23 ml of a 5 wt % solution of Aerosol OT (manufactured by American Cyanamide Co.), 4 g of fine particles (average particle size: 0.7 μm) of polymethyl methacrylate, 21 g of polymethyl methacrylate fine particles (average particle size: 4.5 μm), 1.6 g of 4-methyl phthalic acid, 4.8 g of phthalic acid, 44 ml of sulfuric acid at the concentration of 0.5 mol/l and 10 mg of benzoisothiazolinone were added thereto. Then, water was added to make the total weight of 650 g. Immediately before coating, 445 ml of an aqueous solution containing 4 wt % of chrome alum and 0.67 wt % of phthalic acid was mixed by using a static mixer to make the surface protective layer coating solution. The coating solution was fed to a coating die in a coating amount of 8.3 ml/m².

The viscosity of the coating solution was 9 (mPa·s) at 40° C. (No. 1 rotor, 60 rpm) measured with Model B viscometer.

### Preparation of Photothermographic Materials 001 to 020

On the back side surface of the undercoated support, the anti-halation layer coating solution and the back surface protective layer coating solution were simultaneously coated and dried in such a manner that the coating amount of the solid content of the solid fine particle dye of the anti-halation layer coating solution became 0.04 g/m² and the gelatin coating amount of the back surface protective layer coating solution became 1.7 g/m², thereby the back layer was prepared.

On the opposite surface against the back surface, the image-forming layer (the coating silver amount of the silver halides: 0.14 g/m²), the interlayer, the first protective layer and the second protective layer were simultaneously multi-layer coated by means of the slide bead coating method in this order started from the undercoated surface, thereby a photothermographic material sample was prepared. The conditions of coating and drying are shown in the following.

The coating speed was 160 m/min. The distance between the tip of coating die and the support was set in the range from 0.10 mm to 0.30 mm. The pressure in the pressure reducing chamber was set lower than the atmospheric pressure by 196 Pa to 882 Pa. The support was electrically discharged with ionized air before coating.

After the coated solution was chilled in the consecutive chilling zone with air at a dry bulb temperature of 10° C. to 20° C., the coated support was transported in non-contact web handling, and dried with drying air at a dry bulb temperature of 23° C. to 45° C. and at a wet bulb temperature of 15° C. to 21° C. by means of a helical floating type drying zone.

After drying, the film surface was conditioned at 25° C. and a relative humidity of 40% to 60%, then heated up to a temperature from 70° C. to 90° C. After being heated up, the film surface was cooled down to 25° C.

The matting degree of the prepared photothermographic material was 550 seconds on the surface of the image-forming layer and 130 seconds on the back surface respectively measured in the Bekk second. The pH of the film surface on the side of the image-forming layer was measured as 6.0.

[chemical structure]

### Evaluation

### Evaluation of Photographic Properties

Each sample of the prepared photothermographic materials was exposed and heat-developed (approximately at 120° C.) with Fuji Medical Dry Laser Imager, FM-DP L (installed with a 660 nm semiconductor laser having the maximum output of 60 mW (IIIB)). The obtained image was evaluated by means of a densitometer.

After these samples were exposed with a laser and heat-developed by the above-mentioned method, the relative sensitivity (ΔS), the minimum density (Dmin) and the maximum density (Dmax) of each sample were measured. Furthermore, each sample had been kept at 60° C. and at a relative humidity of 50% for three days, then the fog density (ΔDmin) increased during the period was measured. These values are also described in the Table 2 shown below.

TABLE 2

| | | | | | Hydrogen | | | | | | |
|---|---|---|---|---|---|---|---|---|---|---|---|
| | Reducing | | | | Bonding Type | | | | | | |
| | Agent in | | Compound in | | Compound in | | | | | Image | |
| | Formula (I) | | Formula (D) | | Formula (II) | | Sensi- | | | Stor- | |
| Sample | Com- | Amount | Com- | Amount | Com- | Amount | tivity | Image Density | | ability | |
| No. | pound | (mol %) | pound | (mol %) | pound | (mol %) | ΔS | Dmin | Dmax | ΔDmin | Note |
| 001 | I-6 | 100 | — | — | — | — | ±0 | 0.16 | 3.88 | 0.30 | Com |
| 002 | I-6 | 100 | D-1 | 5 | — | — | 0.20 | 0.22 | 4.02 | 0.41 | Com |
| 003 | I-6 | 100 | — | — | II-1 | 100 | −0.02 | 0.16 | 3.87 | 0.15 | Com |
| 004 | I-6 | 100 | D-1 | 5 | Il-1 | 100 | 0.19 | 0.17 | 3.98 | 0.17 | Inv |
| 005 | I-26 | 65 | — | — | — | — | 0.18 | 0.17 | 3.94 | 0.38 | Com |
| 006 | I-26 | 65 | D-1 | 4 | — | — | 0.38 | 0.28 | 4.00 | 0.45 | Com |
| 007 | I-26 | 65 | — | — | lI-1 | 65 | 0.15 | 0.16 | 3.98 | 0.14 | Com |
| 008 | I-26 | 65 | D-1 | 4 | II-1 | 65 | 0.36 | 0.17 | 4.03 | 0.16 | Inv |
| 009 | I-26 | 65 | D-1 | 4 | II-2 | 65 | 0.35 | 0.17 | 3.96 | 0.13 | Inv |
| 010 | I-26 | 65 | D-1 | 4 | II-3 | 65 | 0.34 | 0.17 | 3.98 | 0.11 | Inv |
| 011 | I-26 | 65 | D-1 | 4 | II-6 | 65 | 0.32 | 0.16 | 3.97 | 0.08 | Inv |
| 012 | I-26 | 65 | D-1 | 2 | II-6 | 45 | 0.31 | 0.16 | 3.96 | 0.10 | Inv |
| 013 | I-26 | 65 | D-1 | 3 | II-6 | 45 | 0.34 | 0.16 | 3.98 | 0.11 | Inv |
| 014 | I-26 | 65 | D-1 | 5 | II-6 | 45 | 0.40 | 0.17 | 4.00 | 0.12 | Inv |
| 015 | I-26 | 65 | D-1 | 7 | II-6 | 45 | 0.43 | 0.18 | 4.04 | 0.14 | Inv |
| 016 | I-26 | 65 | D-13 | 7 | II-6 | 45 | 0.35 | 0.17 | 4.01 | 0.13 | Inv |
| 017 | I-26 | 65 | D-119 | 5 | II-6 | 45 | 0.33 | 0.17 | 3.95 | 0.14 | Inv |
| 018 | I-26 | 65 | D-140 | 10 | II-6 | 45 | 0.34 | 0.17 | 3.99 | 0.13 | Inv |
| 019 | I-11 | 65 | D-1 | 4 | II-6 | 45 | 0.41 | 0.18 | 3.97 | 0.12 | Inv |
| 020 | I-12 | 65 | D-1 | 6 | II-6 | 45 | 0.36 | 0.17 | 3.98 | 0.11 | Inv |

Note: Com; Comparison, Inv; The present invention

It is clear from Table 2 that although a great increase of sensitivity is recognized in case of using a compound in the formula (D) with a reducing agent in the formula (I), fog (Dmin) and image storability (ΔDmin) turn worse at the same time. On the contrary, it is clear that a high sensitivity photothermographic material can be obtained without making fog and image storability worse when a hydrogen bonding type compound is used together.

### EXAMPLE 2

A 25 wt % reducing agent complex dispersion and 25 wt % Organic Polyhalogen Compound Dispersion-4 were prepared according to the following steps, and an image-forming layer coating solution was prepared with the above dispersions. Photothermographic material samples 101 to 120 were prepared in the same manner as that in Example 1 except that the above image-forming layer coating solution was used and the anti-halation layer coating solution described in Example 1 excluding Yellow Dye Compound 15 was used.

### Preparation of 25 wt % Dispersion of Reducing Agent Complex

16 kg of water was added to 10 kg of a reducing agent complex described in Table 3 and 10 kg of a 20 wt % aqueous solution of modified polyvinyl alcohol (Poval MP203, manufactured by Kuraray Co., Ltd.), and the mixture was thoroughly mixed to make a slurry. The slurry was fed by means of a diaphragm pump into a horizontal type sand mill (UVM-2, manufactured by Imex Co., Ltd.) filled with zirconia beads having an average diameter of 0.5 mm, and dispersed for 3 hours 30 minutes. Then, 0.2 g of a sodium salt of benzoisothiazolinone and water were added to the above dispersion so as to make the concentration of the reducing agent 25 wt %, thereby the dispersion of the reducing agent complex was obtained. The particles of the reducing agent complex included in the reducing agent complex dispersion thus obtained had a median particle diameter of 0.46 μm and a maximum particle diameter of 2.0 μm or less. The reducing agent complex dispersion obtained was filtrated with a polypropylene filter having a pore diameter of 10.0 μm to remove foreign substances such as dusts, then stored.

### Preparation of 25 wt % Organic Polyhalogen Compound Dispersion-4

Preparation of 25 wt % Organic Polyhalogen Compound Dispersion-4 was executed in the same manner as that in the preparation of 20 wt % Organic Polyhalogen Compound Dispersion-1, except that 5 kg of N-butyl-3-tribromomethanesulfonylbenzamide was used in place of 5 kg of tribromomethylnaphthylsulfone. After dispersing, the dispersion was diluted so as to make the concentration of the organic polyhalogen compound 25 wt % in the obtained organic polyhalogen compound dispersion, then filtrated. The organic polyhalogen compound particles included in the organic polyhalogen compound dispersion thus obtained had a median particle diameter of 0.41 μm and a maximum particle diameter of 2.0 μm or less. The organic polyhalogen compound dispersion obtained was filtrated with a polypropylene filter having a pore diameter of 3.0 μm to remove foreign substances such as dusts, then stored.

### Preparation of Image-Forming Layer Coating Solution

1.1 g of the 20 wt % aqueous dispersion of the pigment obtained as described in the above, 103 g of the fatty acid silver salt dispersion, 5 g of a 20 wt % aqueous solution of polyvinyl alcohol (PVA-205, manufactured by Kuraray Co., Ltd.), an amount described in Table 3 (e.g., 26.0 g in case of Sample No. 101) of the 25 wt % dispersion of a reducing agent complex, the total amount of 7.5 g of Organic Polyhalogen Compound Dispersion-3 and Dispersion-4 in the ratio of 1:3 (weight ratio), 9.5 g of the 10 wt % mercapto compound dispersion, 106 g of the 40 wt % SBR latex (a latex of -St(70.5)-Bu(26.5)-AA(3), Tg: 23° C.) purified by ultrafiltration (UF) and pH-adjusted, 18 ml of the 5 wt % phthalazine compound solution, and an amount described in the Table 3 of a compound represented by the formula (D) described in the Table 3 were added in this order. Immediately before coating, 10 g of Silver Halide Mixed Emulsion A was added to the above mixture and thoroughly mixed to make the image-forming layer coating solution. The coating solution was fed as it was to a coating die in a coating amount of 70 ml/m² and coated. The used amount of each compound described in Table 3 is shown as a relative mol % to the used amount of the reducing agent complex in Sample No. 101.

The same evaluations as those in Example 1 were performed regarding these samples. The results are shown in Table 3.

TABLE 3

| | Reducing | | Compound by | | | | | | |
|---|---|---|---|---|---|---|---|---|---|
| | Agent | | Formula (D) | | Sensi- | | | Image | |
| Sample | | Amount | | Amount | tivity | Image Density | | Storability | |
| No. | Kind | (mol %) | Compound | (mol %) | ΔS | Dmin | Dmax | ΔDmin | Note |
| 101 | C-1 | 100 | — | — | ±0 | 0.16 | 3.85 | 0.17 | Com |
| 102 | C-1 | 100 | D-1 | 2 | 0.09 | 0.16 | 3.88 | 0.17 | Inv |
| 103 | C-1 | 100 | D-1 | 3 | 0.15 | 0.16 | 3.90 | 0.18 | Inv |
| 104 | C-1 | 100 | D-1 | 4 | 0.19 | 0.16 | 3.93 | 0.18 | Inv |
| 105 | C-1 | 100 | D-1 | 6 | 0.22 | 0.17 | 3.97 | 0.19 | Inv |
| 106 | C-1 | 100 | D-1 | 10 | 0.25 | 0.18 | 4.05 | 0.21 | Inv |
| 107 | C-1 | 100 | D-12 | 10 | 0.14 | 0.17 | 3.97 | 0.19 | Inv |
| 108 | C-1 | 100 | D-102 | 10 | 0.17 | 0.17 | 3.96 | 0.19 | Inv |
| 109 | C-1 | 100 | D-120 | 6 | 0.19 | 0.17 | 4.01 | 0.18 | Inv |
| 110 | C-1 | 100 | D-125 | 6 | 0.18 | 0.17 | 3.99 | 0.18 | Inv |
| 111 | C-2 | 100 | — | — | −0.02 | 0.16 | 3.90 | 0.13 | Com |
| 112 | C-2 | 100 | D-1 | 5 | 0.21 | 0.17 | 4.00 | 0.15 | Inv |
| 113 | C-3 | 100 | — | — | −0.04 | 0.16 | 3.88 | 0.07 | Com |
| 114 | C-3 | 100 | D-1 | 5 | 0.20 | 0.16 | 3.97 | 0.08 | Inv |
| 115 | C-4 | 100 | — | — | −0.06 | 0.15 | 3.86 | 0.09 | Com |
| 116 | C-4 | 100 | D-1 | 5 | 0.18 | 0.16 | 3.94 | 0.10 | Inv |
| 117 | C-5 | 100 | — | — | 0.05 | 0.16 | 3.92 | 0.10 | Com |
| 118 | C-5 | 100 | D-1 | 5 | 0.28 | 0.16 | 3.94 | 0.11 | Inv |
| 119 | C-6 | 100 | — | — | 0.08 | 0.16 | 3.93 | 0.10 | Com |
| 120 | C-6 | 100 | D-1 | 5 | 0.30 | 0.16 | 3.96 | 0.11 | Inv |

| | |
|---|---|
| C-1 | 1:1 complex of I-26 and II-1 |
| C-2 | 1:1 complex of I-26 and II-2 |
| C-3 | 1:1 complex of I-26 and II-6 |
| C-4 | 1:1 complex of I-14 and II-2 |
| C-5 | 1:1 mixture of 1:1 complex of I-11 and II-3 added |
| | with 1:1 complex of I-26 and II-3 |
| C-6 | 60:40:50 mixture of I-11, I-26 and II-6 |

Note: Com; Comparison, Inv; The present invention

It is clear from Table 3 that even when a reducing agent is used in a complex form with a hydrogen bonding type compound, it is possible to get a high sensitivity without making image storability worse, by using a compound represented by the formula (D) together.

### EXAMPLE 3

Sample No. 117 to No. 120 in Example 2 were processed in the entirely same manner as that in Example 1, except that the heat development time was changed as shown in Table 4, then their relative sensitivity (ΔS) and their maximum density (Dmax) were measured. The results are shown in Table 4. The relative sensitivity values at that time are shown in Table 4 by taking the 24 seconds processing of Sample No. 117 as a standard for Sample No. 117 and No. 118, and the 24 seconds processing of Sample No. 119 as a standard for Sample No. 119 and No. 120.

TABLE 4

| | Development | | Maximum | |
|---|---|---|---|---|
| | Time | Sensitivity | Density | |
| Sample No. | (second) | ΔS | Dmax | Note |
| 117 | 24 | ±0 | 3.85 | Comparison |
| 117 | 16 | −0.06 | 3.64 | Comparison |
| 117 | 14 | −0.10 | 3.39 | Comparison |
| 117 | 12 | −0.15 | 3.08 | Comparison |
| 117 | 10 | −0.22 | 2.45 | Comparison |
| 118 | 24 | 0.25 | 4.05 | The |
| | | | | Invention |
| 118 | 16 | 0.16 | 4.07 | The |
| | | | | Invention |
| 118 | 14 | 0.11 | 4.04 | The |
| | | | | Invention |
| 118 | 12 | 0.05 | 3.94 | The |
| | | | | Invention |
| 118 | 10 | −0.01 | 3.88 | The |
| | | | | Invention |
| 119 | 24 | ±0 | 3.90 | Comparison |
| 119 | 16 | −0.07 | 3.71 | Comparison |
| 119 | 14 | −0.12 | 3.52 | Comparison |
| 119 | 12 | −0.17 | 3.14 | Comparison |
| 119 | 10 | −0.24 | 2.70 | Comparison |
| 120 | 24 | 0.18 | 3.94 | The |
| | | | | Invention |
| 120 | 16 | 0.11 | 3.99 | The |
| | | | | Invention |
| 120 | 14 | 0.07 | 4.03 | The |
| | | | | Invention |
| 120 | 12 | 0.03 | 3.93 | The |
| | | | | Invention |
| 120 | 10 | −0.02 | 3.85 | The |
| | | | | Invention |

It is clear from Table 4 that the photothermographic materials of the invention are able to show sufficiently high image density and relative sensitivity even when the development time is shortened.

By using materials in a combination according to the invention, it becomes possible to shorten a development time and to improve the processing capacity.

### EXAMPLE 4

Sample No. 117A to No. 120D were prepared in the entirely same manner as that in Example 2, except that Tg of the SBR latex used in each of Sample No. 117 to No. 120 in Example 2 was changed (by the Styrene/Butadiene ratio) as shown in Table 5. Their image storabilities were evaluated in the same manner as those in Example 2. The results are shown in Table 5.

TABLE 5

| | | Sensi- | Image | |
|---|---|---|---|---|
| Sample | SBR Latex | tivity | Storability | |
| No. | Tg (° C.) | ΔS | ΔDmin | Note |
| 117 | 23 | ±0 | 0.10 | Comparison |
| 117A | 17 | 0.02 | 0.18 | Comparison |
| 117B | 20 | 0.01 | 0.13 | Comparison |
| 117C | 30 | −0.04 | 0.09 | Comparison |
| 117D | 40 | −0.12 | 0.08 | Comparison |
| 118 | 23 | 0.23 | 0.10 | The Invention |
| 118A | 17 | 0.27 | 0.25 | Comparison |
| 118B | 20 | 0.25 | 0.13 | The Invention |
| 118C | 30 | 0.22 | 0.08 | The Invention |
| 118D | 40 | 0.21 | 0.06 | The Invention |
| 119 | 23 | 0.03 | 0.11 | Comparison |
| 119A | 17 | 0.06 | 0.17 | Comparison |
| 119B | 20 | 0.04 | 0.13 | Comparison |
| 119C | 30 | −0.02 | 0.09 | Comparison |
| 119D | 40 | −0.06 | 0.08 | Comparison |
| 120 | 23 | 0.25 | 0.11 | The Invention |
| 120A | 17 | 0.27 | 0.21 | Comparison |
| 120B | 20 | 0.26 | 0.13 | The Invention |
| 120C | 30 | 0.25 | 0.09 | The Invention |
| 120D | 40 | 0.23 | 0.07 | The Invention |

It is clear from Table 5 that both of high sensitivity and superior image storability are obtained when a combination with a latex having Tg of 20° C. or more is selected.

### EXAMPLE 5

### Preparation of Undercoated Support

(1) An undercoated support was prepared in the same manner as that in Example 1, except that Prescription 1 (for the undercoat layer on the image-forming layer side) is modified to Prescription described below in preparation of a coating solution for undercoat layer.

Prescription (for the undercoat layer on the image-forming layer side)

| | | |
|---|---|---|
| Pesresin A-520 (30 wt % solution, | 180 | g |
| manufactured by Takamatsu Yushi Co., Ltd.) | | |
| Byronal MD-1200 (34 wt % solution, | 45 | g |
| manufactured by Toyobo Co., Ltd.) | | |
| Polyethylene glycol monononylphenyl ether | 2 | g |
| (average number of ethylene oxide = 8.5, | | |
| 10 wt % solution) | | |
| Fine particles of polymer (MP-1000, | 0.9 | g |
| average particle size: 0.4 μm, | | |
| manufactured by Soken Kagaku Co., Ltd.) | | |
| Distilled water | 1000 | ml |

### Preparation of Back Surface Coating Solution

Each of back surface coating solutions was prepared in the same manner as that in Example 1, except that Yellow Dye Compound 15 was not used in (Preparation of Anti-Halation Layer Coating Solution).

### Preparation of Silver Halide Emulsion 1

Silver Halide Emulsion 1 was prepared in the same manner as that in Example 1.

### Preparation of Silver Halide Emulsion 2

Silver Halide Emulsion 2 was prepared in the same manner as that in Example 1.

### Preparation of Silver Halide Emulsion 3

Silver Halide Emulsion 3 was prepared in the same manner as that in Example 1.

### Preparation of Mixed Emulsion A for Coating Solution

Mixed Emulsion A for a coating solution was prepared in the same manner as that in Example 1.

### Preparation of Fatty Acid Silver Salt Dispersion

A fatty acid silver salt dispersion was prepared in the same manner as that in Example 1.

### Preparation of 25 wt % Dispersion of Reducing Agent Complex

16 kg of water was added to 10 kg of a 1:1 mixture of a 1:1 complex between Reducing Agent I-11 and Hydrogen Bonding Type Compound II-3 and a 1:1 complex between Reducing Agent I-26 and Hydrogen Bonding Type Compound II-3, then thoroughly mixed to make a slurry. The slurry was fed by means of a diaphragm pump into a horizontal type beads mill (UVM-2, manufactured by Imex Co., Ltd.) filled with zirconia beads having an average diameter of 0.5 mm, and dispersed for 3 hours 30 minutes. Then, 0.2 g of sodium salt of benzoisothiazolinone and water were added to the foregoing dispersion so as to make the concentration of the reducing agent 25 wt %, thereby the dispersion of the reducing agent complex was obtained. The particles of the reducing agent complex included in the reducing agent complex dispersion thus obtained had a median particle diameter of 0.46 μm and a maximum particle diameter of 2.0 μm or less. The reducing agent complex dispersion obtained was filtrated with a polypropylene filter having a pore diameter of 10.0 μm to remove foreign substances such as dusts, then stored.

### Preparation of 10 wt % Dispersion of Mercapto Compound

A 10 wt % dispersion of the mercapto compound is prepared in the same manner as that in Example 1.

### Preparation of 26 wt % Organic Polyhalogen Compound Dispersion-3′

10 kg of water was added to 5 kg of tribromomethylphenylsulfone, 5 kg of 20 wt % aqueous solution of modified polyvinyl alcohol (Poval MP203 manufactured by Kuraray Co., Ltd.) and 213 g of 20 wt % aqueous solution of sodium tri-isopropylnaphthalene sulfonate, then thoroughly mixed to make a slurry. The slurry was fed by means of a diaphragm pump into a horizontal type beads mill (UVM-2, manufactured by Imex Co., Ltd.) filled with zirconia beads having an average diameter of 0.5 mm, and dispersed for 5 hours. Then, 0.2 g of sodium salt of benzoisothiazolinone and water were added to the foregoing dispersion so as to make the concentration of the organic polyhalogen compound 26 wt %, thereby the dispersion of the organic polyhalogen compound was obtained. The particles of the organic polyhalogen compound included in the organic polyhalogen compound dispersion thus obtained had a median particle diameter of 0.41 μm and a maximum particle diameter of 2.0 μm or less. The organic polyhalogen compound dispersion obtained was filtrated with a polypropylene filter having a pore diameter of 3.0 μm to remove foreign substances such as dusts, then stored. Further, after storing, the dispersion was maintained at 10° C. or less before use.

### Preparation of 25 wt % Organic Polyhalogen Compound Dispersion-4

The preparation of 25 wt % Organic Polyhalogen Compound Dispersion-4 was executed in the same manner as that in the preparation of 26 wt % Organic Polyhalogen Compound Dispersion-3′, except that 5 kg of N-butyl-3-tribromomethane sulfonylbenzamide was used in place of 5 kg of tribromomethylphenylsulfone. After dispersing, the dispersion was diluted so as to make the concentration of the organic polyhalogen compound 25 wt % in the obtained organic polyhalogen compound dispersion, then filtrated. The organic polyhalogen compound particles included in the organic polyhalogen compound dispersion thus obtained had a median particle diameter of 0.41 μm and a maximum particle diameter of 2.0 μm or less. The organic polyhalogen compound dispersion obtained was filtrated with a polypropylene filter having a pore diameter of 3.0 μm to remove foreign substances such as dusts, then stored.

### Preparation of 5 wt % Solution of Phthalazine Compound

A 5 wt % solution of Phthalazine compound was prepared in the same manner as that in Example 1.

### Preparation of 20 wt % Dispersion of Pigment

A 20 wt % dispersion of the pigment was prepared in the same manner as that in Example 1.

### Preparation of 40 wt % Dispersion of SBR Latex

A 40 wt % dispersion of the SBR latex was prepared in the same manner as that in Example 1.

### Preparation of Image-Forming Layer Coating Solution

1.1 g of the 20 wt % dispersion of the pigment obtained as described in the above, 103 g of the fatty acid silver salt dispersion, 5 g of a 20 wt % aqueous solution of polyvinyl alcohol (PVA-205, manufactured by Kuraray Co., Ltd.), 26.0 g of the 25 wt % reducing agent complex dispersion, 7.5 g in the total weight of Organic Polyhalogen Compound Dispersion-3′ and Dispersion-4 in the ratio of 1:3 (by weight), 9.5 g of the 10 wt % mercapto compound dispersion, 106 g of the 40 wt % SBR latex (a latex of -St(70.5)-Bu(26.5)-AA(3), Tg: 23° C.) purified by ultrafiltration (UF) and pH-adjusted, and 18 ml of the 5 wt % phthalazine compound solution were added in this order. Immediately before coating, 10 g of Silver Halide Mixed Emulsion A was added to the mixture obtained in the above and thoroughly mixed to make the image-forming layer coating solution. The coating solution was fed as it was to a coating die in a coating amount of 70 ml/m² and coated.

The viscosity of the image-forming layer coating solution was 85 (mPa·s) measured by a Model B Viscometer (manufactured by Tokyo Keiki Co., Ltd.) at a temperature of 40° C. and with a No. 1 rotor (60 rpm). The viscosity of the coating solution measured with a RFS Fluid Spectrometer (manufactured by Rheometrics Far East Co.) at 25° C. was 1500, 220, 70, 40, 20 (mPa·s) at a shearing velocity of 0.1, 1, 10, 100, 1000 (1/sec), respectively.

### Preparation of Interlayer Coating Solution for Image-Forming Surface

An interlayer coating solution for the image-forming surface was prepared in the same manner as that in Example 1.

### Preparation of First Protective Layer Coating Solution for Image-Forming Surface

The first protective layer coating solution for the image-forming surface was prepared in the same manner as that in Example 1.

### Preparation of Second Protective Layer Coating Solution for Image-Forming Surface

The second protective layer coating solution for the image-forming surface was prepared in the same manner as that in Example 1.

### Preparation of Photothermographic Materials 201 to 202

On the back side surface of the undercoated support, the anti-halation layer coating solution and the back surface protective layer coating solution were simultaneously double coated in such a manner that the coating amount of the solid content of the solid fine particle dye of the anti-halation layer coating solution became 0.04 g/m² and the gelatin coating amount of the back surface protective layer coating solution became 1.7 g/m², and dried, thereby the back layer was prepared.

On the opposite surface against the back surface, the image-forming layer (the coating silver amount of the silver halides: 0.14 g/m²), the interlayer, the first protective layer and the second protective layer were simultaneously multi-layer coated by using the slide bead coating method in this order started from the undercoated surface, thereby Sample 201 of the photothermographic material was prepared. Further, Sample 202 of the photothermographic material was similarly prepared by using an image-forming layer coating solution to which Compound D-1 described in the above had been added in an amount of 1/20 mol of the reducing agent complex.

The conditions of coating and drying are shown in the following.

The coating speed was 160 m/min. The distance between the tip of coating die and the support was set in the range from 0.10 mm to 0.30 mm. The pressure in the reduced pressure chamber was set lower than the atmospheric pressure by a value from 196 Pa to 882 Pa. The support was electrically discharged with ionized air before coating.

After the coated solution was chilled in the consecutive chilling zone with air at a dry bulb temperature from 10° C. to 20° C., the coated support was transported in non-contact web handling, and dried with drying air at a dry bulb temperature from 23° C. to 45° C. and at a wet bulb temperature from 15° C. to 21° C. by means of a helical floating type drying zone.

After drying, the film surface was conditioned at 25° C. and a relative humidity from 40% to 60%, then heated up to a temperature from 70° C. to 90° C. After being heated up, the film surface was cooled down to 25° C.

The matting degree of the prepared photothermographic material was 550 seconds on the surface of the image-forming layer side and 130 seconds on the back surface respectively measured in the Bekk second. The pH of the film surface on the side of the image-forming layer was measured as 6.0.

### Evaluation

### Evaluation of Photographic Properties

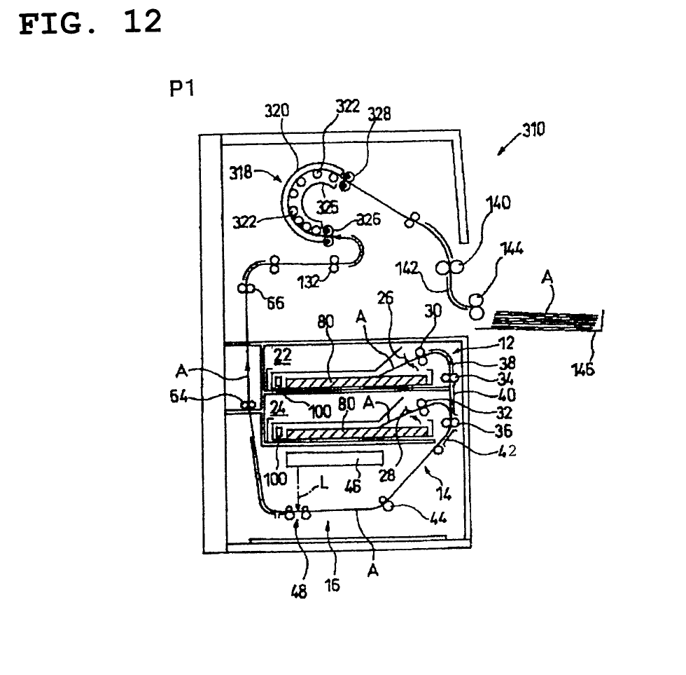

As automatic development machines, an automatic development apparatus P1 indicated in FIG. 12 and an automatic development apparatus P2 indicated in FIG. 13 were prepared. Each of them was equipped with a 660 nm semiconductor laser having the maximum output of 60 mW (IIIB). Each sample of photothermographic materials 201 and 202 prepared as described in the above was laser-exposed (constant conditions between automatic development machines), and then heat-developed (constant at about 120° C.). A heat development time was varied by changing a carrying velocity. Images thus obtained were evaluated by means of a densitometer.

Evaluations were performed by measuring a relative sensitivity (ΔS) compared with a sensitivity of the sample in Test No. 1 as a reference, a minimum density (Dmin) and a maximum density (Dmax). Regarding the image unevenness, a sample was uniformly exposed to obtain a density of 1.0. After development, the unevenness of density of the sample was sensually evaluated by using the scale described below.

◯ Almost no unevenness of density

Δ A Unevenness of density to be accepted in practice x Unevenness of density to be a problem in practice

These results are also listed in Table 6.

TABLE 6

| | | Automatic | | | | | |
|---|---|---|---|---|---|---|---|
| | | Heat- | | Relative | Maximum | | |
| Test | Sample | Development | Development | Sensitivity | Density | Unevenness | |
| No. | No. | Apparatus | Time (sec) | ΔS | Dmax | of Image | Note |
| 1 | 201 | P1 | 24 | ±0 | 3.85 | ◯ | Com |
| 2 | 201 | P1 | 16 | −0.06 | 3.64 | Δ | Com |
| 3 | 201 | P1 | 14 | −0.10 | 3.39 | Δ | Com |
| 4 | 201 | P1 | 12 | −0.15 | 3.08 | X | Com |
| 5 | 201 | P1 | 10 | −0.22 | 2.45 | X | Com |
| 6 | 202 | P1 | 24 | 0.25 | 4.05 | ◯ | Com |
| 7 | 202 | P1 | 16 | 0.16 | 4.07 | ◯ | Com |
| 8 | 202 | P1 | 14 | 0.11 | 4.04 | Δ | Com |
| 9 | 202 | P1 | 12 | 0.05 | 3.94 | Δ | Com |
| 10 | 202 | P1 | 10 | −0.01 | 3.88 | X | Com |
| 11 | 201 | P2 | 24 | 0.02 | 3.86 | ◯ | Com |
| 12 | 201 | P2 | 16 | −0.05 | 3.64 | ◯ | Com |
| 13 | 201 | P2 | 14 | −0.09 | 3.40 | ◯ | Com |
| 14 | 201 | P2 | 12 | −0.13 | 3.10 | Δ | Com |
| 15 | 201 | P2 | 10 | −0.21 | 2.55 | Δ | Com |
| 16 | 202 | P2 | 24 | 0.28 | 4.10 | ◯ | Inv |
| 17 | 202 | P2 | 16 | 0.19 | 4.10 | ◯ | Inv |
| 18 | 202 | P2 | 14 | 0.13 | 4.08 | ◯ | Inv |
| 19 | 202 | P2 | 12 | 0.08 | 4.02 | ◯ | Inv |
| 20 | 202 | P2 | 10 | 0.01 | 3.95 | ◯ | Inv |

Com: Comparison
Inv: The present invention

According to the process of the invention, when the photothermoghraphic material had been processed by use of the small and space saving automatic heat development apparatus P2, a sufficient sensitivity was realized even in a rapid treatment. Further, this case showed a more uniform result with less unevenness of density than that in the case where the photothermoghraphic material had been processed by use of the automatic heat development apparatus P1.

### EXAMPLE 6

Sample 201A to D and Sample 202A to D were prepared in the entirely same manner as that in Example 5, except that a Tg of an SBR latex used in the sample 201 and 202 was modified (adjusted by controlling the ratio between styrene and butadiene) as shown in Table 7. With these samples, evaluations of sensitivity and image storability were conducted. The automatic heat development apparatus P2 was used and the heat development time was set for 14 seconds. For evaluating image storability, each sample was stored for 3 days under the condition of a temperature of 60° C. and a relative humidity of 50%, and then the fog density (ΔDmin) increased during the storage period was measured. These results were shown in Table 7.

TABLE 7

| | | | Relative | | |
|---|---|---|---|---|---|
| | | SBR Latex | Sensitivity | Image storability | Unevenness of |
| Test No. | Sample No. | Tg (° C.) | ΔS | ΔDmin | Image |
| 21 | 201 | 23 | ±0 | 0.10 | ◯ |
| 22 | 201A | 17 | 0.02 | 0.18 | ◯ |
| 23 | 201B | 20 | 0.01 | 0.13 | ◯ |
| 24 | 201C | 30 | −0.04 | 0.09 | Δ |
| 25 | 201D | 40 | −0.12 | 0.08 | Δ |
| 26 | 202 | 23 | 0.23 | 0.10 | ◯ |
| 27 | 202A | 17 | 0.27 | 0.25 | ◯ |
| 28 | 202B | 20 | 0.25 | 0.13 | ◯ |
| 29 | 202C | 30 | 0.22 | 0.08 | ◯ |
| 30 | 202D | 40 | 0.21 | 0.06 | ◯ |

It is clear from Table 7 that high sensitivity and excellent image storability are indicated when a latex having Tg of 20° C. or more was used in combination.

### EXAMPLE 7

In case of Sample 202 in Example 5, the same test as that in Example 5 was performed, except that the small and space saving automatic heat development apparatus P3 shown in FIG. 14 was used as a heat development apparatus. Consequently, the similar results to the case of using the heat development apparatus P2 in Example 5 were obtained.

### EXAMPLE 8

Sample 203 of the photothermographic material was prepared in the same manner as that in Sample 202 in Example 5, except that the pigment in the image-forming layer was excluded. With Sample 203, the same operation as that in Example 5 was conducted to evaluate image unevenness, sensitivity and image storability. Accordingly, results equal to those with Sample 202 in Example 5 were obtained.

The photothermographic materials of the invention have both advantages of high activity in heat development and superior image storability, and also the features of high sensitivity and rapid developability.

Furthermore, owing to the heat development process of the invention, the photothermographic material which is highly active in heat development can be heat-developed rapidly and with a high sensitivity, and moreover an image without unevenness of photographic density but with good image storability can be obtained.

While the invention has been described in detail and with reference to specific embodiments thereof, it will be apparent to one skilled in the art that various changes and modifications can be made therein without departing from the spirit and scope thereof.

What is claimed is:

1. A photothermographic material comprising a support having provided on one surface side thereof an image-forming layer comprising at least one kind of photosensitive silver halide, a photo-insensitive organic silver salt, a reducing agent for a silver ion and a binder, wherein said image-forming layer comprises a compound represented by the following formula (D) and a hydrogen bonding type compound, and the glass transition temperature of said binder is 20° C. or higher,
Q¹—NHNH—Q² (D)
wherein Q¹ represents an aromatic group or a heterocyclic group bonding to —NHNH—Q² with a carbon atom, and Q² represents a carbamoyl group, an acyl group, an alkoxycarbonyl group, an aryloxycarbonyl group, a sulfonyl group or a sulfamoyl group.

2. The photothermographic material as claimed in claim 1, wherein said reducing agent is a compound represented by the following formula (I): 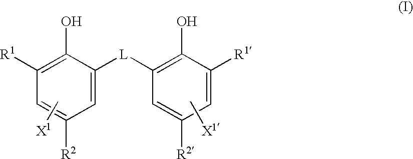
wherein R¹ and R^{1′} each independently represents an alkyl group, R² and R^{2′} each independently represents a hydrogen atom or a substituent replaceable on a benzene ring, X and X′ each independently represents a hydrogen atom or a substituent replaceable on a benzene ring, R¹ and X, R^{1′} and X′, R² and X, and R^{2′} and X′ may form a ring by bonding each other, L represents an —S— group or a —CHR³— group, and R³ represents a hydrogen atom or an alkyl group.

3. The photothermographic material as claimed in claim 1, wherein said hydrogen bonding type compound is a compound represented by the following formula (II): 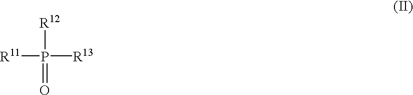
wherein R¹¹, R¹² and R¹³ each independently represents an alkyl group, an aryl group, an alkoxy group, an aryloxy group, an amino group or a heterocyclic group, which groups may be substituted or unsubstituted, and optional two among R¹¹, R¹² and R¹³ May form a ring by bonding each other.

4. The photothermographic material as claimed in claim 1, wherein Q² is a carbamoyl group in a compound represented by the formula (D).

5. The photothermographic material as claimed in claim 2, wherein R¹ and R^{1′} each independently represents a secondary or tertiary alkyl group, R² and R^{2′} each independently represents an alkyl group, R³ represents a hydrogen atom or an alkyl group, and X and X′ both are hydrogen atoms in a compound represented by the formula (I).

6. The photothermographic material as claimed in claim 2, wherein R¹ and R^{1′} each independently represents a tertiary alkyl group, R² and R^{2′} each independently represents an alkyl group, and R³ represents a hydrogen atom or an alkyl group in a compound represented by the formula (I).

7. The photothermographic material as claimed in claim 6, wherein R¹ and R^{1′} each independently represents a tertiary alkyl group, R² and R^{2′} each independently represents an alkyl group containing two or more carbon atoms, and R³ represents a hydrogen atom in a compound represented by the formula (I).

8. The photothermographic material as claimed in claim 1, wherein said image-forming layer is formed by comprising coating an image-forming layer coating solution comprising the binder in the form of an aqueous latex and drying thereof.

9. The photothermographic material as claimed in claim 1, wherein the glass transition temperature of said binder is from 23° C. to 60° C.

10. The photothermographic material as claimed in claim 1 for being heat-developed in a period from 5 seconds to 19 seconds.

11. A heat development process by means of a heat development apparatus comprising a heat development part for heat-developing a photothermographic material comprising a support having provided on one surface side thereof an image-forming layer comprising at least one kind of photosensitive silver halide, a photo-insensitive organic silver salt, a reducing agent for a silver ion and a binder, wherein said image-forming layer comprises a compound represented by the following formula (D) and a hydrogen bonding type compound, said heat development part comprises a heating means comprising plate heaters arranged in the form with a flat plane surface or a curved plane surface and a carrying means comprising a plurality of pressing rollers positioned in facing to and along the one surface of the plane-like plate heaters, and said photothermographic material is carried through between the pressing rollers and the plane-like plate heaters by means of the carrying means,
Q¹—NHNH—Q² (D)
wherein Q¹ represents an aromatic group or a heterocyclic group bonding to —NHNH—Q² with a carbon atom, and Q² represents a carbamoyl group, an acyl group, an alkoxycarbonyl group, an aryloxycarbonyl group, a sulfonyl group or a sulfamoyl group.

12. The heat development process for the photothermographic material as claimed in claim 11, wherein said reducing agent is a compound represented by the following formula (I): 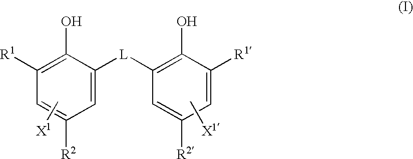
wherein R¹ and R^{1′} each independently represents an alkyl group, R² and R^{2′} each independently represents a hydrogen atom or a substituent replaceable on a benzene ring, X and X′ each independently represents a hydrogen atom or a substituent replaceable on a benzene ring, R¹ and X, R^{1′} and X′, R² and X, and R^{2′} and X′ may form a ring by bonding each other, L represents an —S— group or a —CHR³— group, and R³ represents a hydrogen atom or an alkyl group.

13. The heat development process for the photothermographic material as claimed in claim 11, wherein Q² is a carbamoyl group in the compound represented by the formula (D).

14. The heat development process for the photothermographic material as claimed in claim 12, wherein R¹ and R^{1′} each independently represents a secondary or tertiary alkyl group, R² and R^{2′} each independently represents an alkyl group, R³ represents a hydrogen atom or an alkyl group, and X and X′ both are hydrogen atoms in the compound represented by the formula (I).

15. The heat development process for the photothermographic material as claimed in claim 12, wherein R¹ and R^{1′} each independently represents a tertiary alkyl group, R² and R^{2′} each independently represents an alkyl group, and R³ represents a hydrogen atom or an alkyl group in the compound represented by the formula (I).

16. The heat development process for the photothermographic material as claimed in claim 15, wherein R¹ and R^{1′} each independently represents a tertiary alkyl group, R² and R^{2′} each independently represents an alkyl group containing two or more carbon atoms, and R³ represents a hydrogen atom in the compound represented by the formula (I).

17. The heat development process for the photothermographic material as claimed in claim 11, wherein said hydrogen bonding type compound is a compound represented by the following formula (II): 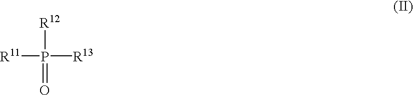
wherein R¹¹, R¹² and R¹³ each independently represents an alkyl group, an aryl group, an alkoxy group, an aryloxy group, an amino group or a heterocyclic group, which groups may be substituted or unsubstituted, and optional two among R¹¹, R¹² and R¹³ may form a ring by bonding each other.

18. The heat development process for the photothermographic material as claimed in claim 11, wherein the average glass transition temperature of said binder in the image-forming layer is 20° C. or higher.

19. The heat development process for the photothermographic material as claimed in claim 18, wherein the average glass transition temperature of said binder in the image-forming layer is from 23° C. to 60° C.

20. The heat development process for the photothermographic material as claimed in claim 11, wherein said image-forming layer is formed by comprising coating an image-forming layer coating solution comprising the binder in the form of an aqueous latex and drying thereof.

21. The heat development process for the photothermographic material as claimed in claim 11, wherein said photothermographic material is heat-developed in a period from 5 seconds to 20 seconds.
